(19) United States
(12) Patent Application Publication
(10) Pub. No.: US 2026/0339555 A1
(43) Pub. Date: Oct. 29, 2026

(54) DATA POINTER FIELD IN STORAGE COMMAND TO SPECIFY MEMORY ADDRESS

(71) Applicant: Micron Technology, Inc., Boise, ID (US)

(72) Inventor: Luca Bert, Bologna (BO) (IT)

(21) Appl. No.: 19/266,013

(22) Filed: Jul. 10, 2025

Related U.S. Application Data
(60) Provisional application No. 63/796,134, filed on Apr. 28, 2025.

(51) Int. Cl. G06F 3/06

(52) U.S. Cl. CPC G06F 3/0659; G06F 3/0613; G06F 3/0679

(57) ABSTRACT

Systems, methods, and apparatus related to commands for accessing storage spaces of memory systems (e.g., solid-state drive (SSD) having NAND flash memory). In one approach, a controller retrieves a command including a data pointer having a first portion specifying a memory address and a second portion separate from the first portion. The controller determines, based on whether the memory address provided in the first portion of the data pointer is valid, whether to use the first portion or the second portion to identify a memory location in a random access memory for data transfer during execution of the command to access a logical storage space implemented using non-volatile memory.

### RELATED APPLICATIONS

The present application claims priority to Prov. U.S. patent application Ser. No. 63/796,134 filed Apr. 28, 2025, the entire disclosure of which application is hereby incorporated herein by reference.

### TECHNICAL FIELD

At least some embodiments disclosed herein relate to memory systems in general, and more particularly, but not limited to command configuration for a memory system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a solid-state drive that receives normal and/or fast commands according to one embodiment.

FIG. 3 shows a data structure used for configuration of parameters in normal and fast commands according to one embodiment.

FIG. 4 shows a format of a read or write command received via a submission queue.

FIG. 5 shows a method for configuring commands to indicate selection of either a normal or fast execution path for processing each command according to one embodiment.

FIG. 6 shows two types (Type A and Type B) of read commands according to one embodiment.

FIG. 7 shows two types (Type A and Type B) of write commands according to one embodiment.

FIG. 8 shows a processing path for Type A read or write commands according to one embodiment.

FIG. 9 shows a processing path for Type B read or write commands according to one embodiment.

FIG. 10 shows a configuration of a set command used to set read/write parameters according to one embodiment.

FIG. 11 shows an extended Type A read command used to set read/write parameters according to one embodiment.

FIG. 12 shows a processing path for a read/write parameter setting command according to one embodiment.

FIG. 13 shows alternative configurations for a data pointer of a command according to one embodiment.

FIG. 14 shows a configuration for a read or write command that specifies multiple data offsets and data lengths according to one embodiment.

FIG. 15 shows a configuration for a read or write command that specifies pairs of data offsets and lengths with each pair specified in a respective single Dword of the command according to one embodiment.

FIG. 16 shows a configuration for a read or write command of a reduced size that specifies a command identifier and data pointer according to one embodiment.

FIG. 17 shows a configuration for a read or write command of a reduced size that specifies a buffer identifier and metadata pointer according to one embodiment.

FIG. 18 shows a configuration for a read or write command that specifies a data pointer of a reduced size, and further specifies multiple data offsets and data lengths according to one embodiment.

FIG. 19 shows a configuration for a read or write command of a reduced size that specifies a command identifier and metadata pointer according to one embodiment.

FIG. 20 shows a technique to specify a destination of data retrieved via execution of a read command that specifies an offset and a data length via sub block size, a sub block offset, and number of sub blocks according to one embodiment.

FIG. 21 shows a technique to specify a destination of data retrieved via execution of a read command that specifies a byte offset, a sub block size, and number of sub blocks according to one embodiment.

FIG. 22 shows a read command that specifies a byte offset as data offset and number of bytes as a data length for reading one or more sub blocks from a storage space during execution of the read command according to one embodiment.

FIG. 23 shows a technique for specifying a command identifier based on a unique global resource identifier according to one embodiment.

FIG. 24 shows multiple threads each submitting a command to a submission queue with each command having a different command identifier based on a unique global resource identifier of the thread according to one embodiment.

FIG. 25 shows a technique to use a steering tag mechanism to send data to a cache memory of a processing device in response to the memory sub-system sending data to a memory address according to one embodiment.

FIG. 26 shows a technique to enter a command into a submission queue according to one embodiment.

FIG. 27 shows a consistency check between parameters specified in a read command and pre-set parameters for a namespace identified in the command according to one embodiment.

FIG. 28 shows a read command having a data retention indicator field that can carry a predetermined value to indicate retention of read data in a local memory according to one embodiment.

FIG. 29 shows a write command used to write a sub block in a logical block of a storage space using data previously read from the logical block and retained in a local memory during execution of a prior read command according to one embodiment.

FIG. 30 shows a read/write command having a data retention indicator field that can be configured to specify a value to indicate release of data read from or written to a logical block and retained in local memory during execution of the read or write command according to one embodiment.

FIG. 31 shows a method for generating commands according to different command formats according to one embodiment.

FIG. 32 shows a method for executing a first read or write command using firmware processing and executing a second read or write command without using the firmware processing according to one embodiment.

FIG. 33 shows a method for retrieving and executing read commands having different opcodes according to one embodiment.

FIG. 34 shows a method for retrieving and executing write commands having different opcodes according to one embodiment.

FIG. 35 shows a method for using pre-set parameters to execute a read or write command where the pre-set parameters are identified by a namespace identifier specified in the command according to one embodiment.

FIG. 36 shows a method for determining a portion of a data pointer to use in identifying a memory location for data transfer according to one embodiment.

FIG. 37 shows a method for determining a memory address of a buffer memory using a buffer identifier specified in a command according to one embodiment.

FIG. 38 shows a method for executing a read command that includes a steering tag value according to one embodiment.

FIG. 39 shows a method for executing a write command that specifies a length of a range of data for writing to a storage space according to one embodiment.

FIG. 40 shows a method for executing a read command that specifies a data offset according to one embodiment.

FIG. 41 shows a method for executing a read command that specifies multiple non-contiguous data segments in a logical storage space according to one embodiment.

FIG. 42 shows a method for generating a command identifier for a command based on an identifier of a thread according to one embodiment.

FIG. 43 shows a method for entering commands to a submission queue using an atomic write according to one embodiment.

FIG. 44 shows a method for checking compatibility between stored parameters and parameters specified by a command being executed according to one embodiment.

FIG. 45 shows a method for retaining, in local memory, data read from or written to a logical block and updating metadata to indicate that the data is stored in the local memory according to one embodiment.

FIG. 46 is a block diagram of an example computer system in which embodiments of the present disclosure can operate.

### DETAILED DESCRIPTION

At least some aspects of the present disclosure are directed to techniques for configuring and sending commands from a host system to a memory sub-system. In some embodiments, the commands are sent from a host system to a memory sub-system via a submission queue (SQ) configured in compliance with a standard for non-volatile memory express (NVMe).

For example, a storage space in the memory sub-system is accessed by the host system using the commands sent via one or more submission queues. For example, the commands can specify read or write operations that access the storage space implemented using one or more non-volatile memory devices of the memory sub-system. The commands retrieved from the submission queues can be loaded to an internal command queue of the memory sub-system to execute the commands, including parsing the commands to identify the parameters and options or requirements related to the performing of the read or write operations in the storage space.

The commands sent from the host system can be configured in various ways. In some embodiments, each command is constructed according to a standard of NVMe to have predefined fields and a common total size (e.g., 64 bytes used for each command). In some embodiments, an indication is included in each command to indicate a type of operations to be performed by the memory sub-system during execution of the command.

As used herein, a field is a predefined one or more segments of bits in a command of a specific type. For example, the data structure of a command can be according to an NVMe standard for compliance with the NVMe standard. In one example, a field of an NVMe command corresponds to a set of bits provided in one or more Dword locations in the data representing the NVMe command. In one example, a field can be a range of bytes or bits at a defined location(s) in a command that is not fully in compliance with the NVMe standard.

In some embodiments, normal NVMe commands and fast commands each have a same total size (e.g., 64 bytes) according to an NVMe standard. For example, a command having 64 bytes can be seen as bit segments arranged as Dwords (double words) 0-15. For example, a first field can be configured to use Dword 10, a second field Dword 12, and a third field Dword 13-15. For example, a normal NVMe command can be commands that are fully in compliance with a current version of NVMe standard; and a fast command can be partially in compliance with the current version of NVMe standard (and may be adopted by a future version of NVMe standard). In some implementations, when an opcode of a first normal NVMe command is replaced with an opcode of a second fast command, the second fast command can be executed by the memory sub-system to perform substantially the same operation as the execution of the first normal NVMe command. One or more first fields in the first normal NVMe command and the second fast command configured to provide one or more same parameters for the substantially same operation can be processed during the execution of the first normal command and the second fast command. However, at least one second field, corresponding to the same bit segments having the same value in the first normal command and the second fast command is processed differently for the execution of the first normal command and the second fast command. For example, the execution of the first normal command can involve parsing the second field to extract the parameter provided in the second field and performing further processing to prepare for the performing of the substantially same operation identified by the opcode; in contrast, the execution of the second fast command can skip the parsing of the bit segment to perform the substantially same operation based on a pre-identified configuration. The second field in the first normal command can be modified to specify a different parameter to cause the memory sub-system to perform an operation that deviates from the pre-identified configuration. In contrast, since the second fast command has the opcode that causes the memory sub-system to skip parsing of the bit segment corresponding to the second field in the first normal command, the same value specified in the bit segment to cause the execution of the first normal command to deviate from the pre-identified configuration cannot cause the execution of the second command to deviate from the pre-identified configuration. Thus, the use of the second fast command can speed up the processing of operations in the pre-identified configuration; and the use of the first normal NVMe command can preserve the flexibility to perform operations in a variety of configurations. Since the bit segment corresponding to the second field in the first normal command is not parsed (and thus ignored) in the second fast command, the second field is essentially not configured to have meaning in the second fast command; and the bit segment corresponding to the second field is not used in the second fast command to pass parameters, data, or information from the host system to the memory sub-system.

In other embodiments, normal and fast NVMe commands configured to perform substantially the same operation can each have a different set of fields defined by a range of bit, byte, word, and/or double word locations in a respective command. The normal and fast commands can have some common fields (e.g., namespace identifier and starting LBA) defined at the same locations in each command.

In general, the definitions of fields of a command can vary depending on the value of the opcode specified in the command. For example, depending on the value represented by the segment of bits predefined to store an opcode, many of the Dwords in an NVMe command are partitioned differently into different sets of fields specific to the type of commands represented by the opcode (e.g., read, write, compare, copy, etc.).

In one embodiment, commands executed in a memory sub-system can be optionally normal commands or fast commands. An opcode in a command executed by the memory sub-system can be configured to indicate whether the command is a normal command or a fast command. The normal commands are executed in accordance with fields defined in an NVMe standards to read data from and write data to the storage space of the memory sub-system. To accommodate the variety of options that can be specified for read/write commands according to an NVMe standard, normal read/write commands are processed by the memory sub-system at least in part using firmware-based resources (e.g., firmware instructions executed by a controller).

In contrast, fast read/write commands can be configured to extend a current version of NVMe standard. The fast read/write commands can be limited to a subset of configurations/options that can be specified using the normal read/write commands. Thus, the memory sub-system can be configured to process the fast read/write command using hardware circuitry only and/or without using the firmware-based resources configured to process the normal read/write commands. The opcode in each fast command indicates to a controller of the memory sub-system that a reduced number of fields of the command will be processed. For example, certain of the fields in the data structure of a normal read/write command will be skipped or ignored by a controller when the opcode of the normal read/write command is replaced with the opcode configured to identify the fast read/write command. Optionally, those fields not skipped or ignored are processed using hardware circuitry to reduce or eliminate the use of firmware-based processing, thus accelerating processing of the fast commands as compared to the corresponding normal commands, which can have one or more fields evaluated using firmware-based resources.

In some embodiments, fast commands reduce (but do not completely eliminate) an extent of usage of the firmware-based resources as compared to normal commands. For example, a number of the fields of a fast command processed using firmware is less than a number of the fields of a normal command that are processed using firmware.

A conventional memory sub-system (e.g., a solid-state drive in compliance with a non-volatile memory express (NVMe) standard) can include a flash memory (e.g., NAND memory) that is to be in an erased state before being programmed to store data. For example, such as flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

A conventional host system is configured (e.g., according to an NVMe standard) to instruct the memory sub-system to store data at locations specified via logical block addresses (e.g., LBA addresses). Each logical block address identifies a block of storage space that can be implemented using the storage capacity of one or more pages of memory cells. For example, a typical size of the storage space represented by a logical block address in a solid-state drive (SSD) is 512 bytes (or larger, e.g., 4 KB). The memory sub-system (e.g., SSD) can have a flash translation layer configured to map the logical block addresses as known to the host system to physical addresses of memory cells in the memory sub-system. As a result, the host system does not have to be aware which data items are stored in which particular memory cells.

A conventional NVMe solid-state drive (SSD) can receive commands from a host system via a submission queue and provide completion records about execution of the commands in a completion queue (sometimes referred to as a queue pair (QP)). The host can write to a doorbell register in the SSD to cause the SSD to poll submission queues for commands.

In a typical NVMe implementation, processors (e.g., CPU, GPU, AI accelerators) communicate over a PCIe bus with an SSD via random access memory/main memory of the processor. For example, a pair of message queues in the memory can be used for a processor to send commands to the SSD in the submission queue, and for the SSD to send completion records to the processor in the completion queue.

Each submission queue is a circular queue having slots of the same size. Each slot in a submission queue holds one command for execution by the SSD. Each slot in the completion queue holds a completion record about the execution of a command.

When a processor enters a command in a submission queue configured in the main memory, all related activity occurs within the host system (e.g., the processor and its main memory/random access memory). The SSD is not aware that the processor has entered the command in the submission queue. Instead, the SSD may periodically read the submission queue determine if new commands have been entered. Alternatively, that SSD may have a doorbell register. The processor writes to the doorbell register to notify the SSD to check the submission queue.

In the NVMe standard, the SSD typically reads/writes data in blocks of 512 bytes or more (4 KB is recommended). The NVMe protocol implements certain features for communications between processors and the SSD using access to random access memory. An NVMe command can include various information about operations to be performed (e.g., read or write), a location in a storage space in the SSD for performing the operation, a location in the main memory to store the retrieved data for a read, or a location in the main memory to retrieve the data to be written into the SSD.

With the advent of artificial intelligence (AI), the set of various requirements for storage have become quite uncertain as many parts of the AI pipeline now require significantly different IO profiles from prior profiles used for the storage stack. For example, the entire preparation process for data processing can bring large amounts of data close to where the AI training nodes are located. This will increase SSD capacity. In a similar way, both AI training and inference nodes can use faster SSDs placed in close proximity to the GPU clusters (or even inside the clusters, in some cases). This creates a new set of requirements for SSDs. To meet the challenges, significant changes can be made in how the CPU/GPU communicates to the storage devices (e.g., SSD in this case). At least some embodiments disclosed herein provide major improvements to the NVMe protocol.

Various embodiments related to improvement to NVMe based commands are described below. In some embodiments, new commands can extend the NVMe based protocol in which fast SSDs implementing the new commands can be placed close to the GPU/CPU for improved performance. In some cases, the new commands are configured in a way that is substantially backward-compatible with a current version of NVMe protocol. This permits the improved interface protocol to be used together with the existing stack (e.g., software, firmware, device driver). However, in other cases, the improved interface protocol provides a new interface that is substantially not backward-compatible.

Within a class of applications (e.g., using CPU/GPU attached SSD to address both AI training and inference needs), there are three different areas needing improvement: parallelism, command delivery, and command processing.

Regarding parallelism, the threading level of a GPU can be massive and use a 1:1 matching between GPU threads and SSD queue pairs (QPs), as they are the means to convey thread data to the SSD. For example, current SSDs support up to 2K queues, but it is expected that within the next few years, a typical GPU will have tens of thousands of threads to match. Enqueueing/dequeuing at an N:1 ratio is resource expensive as each insert/remove requires the thread to arbitrate for a lock, acquire the lock, add/remove the entry, release the lock, and then repeat, thus wasting valuable resources and time. The foregoing situation creates the need for the SSD to support a larger number of QPs to match the GPU needs.

Regarding command delivery, the NVMe protocol uses a queuing system that is fast but was not designed for the above scale of operation. Even though the queuing system is flexible and widely adopted, there is a need for an improved queue delivery mechanism.

Regarding NVMe commands, at least some embodiments disclosed herein increases hardware (HW) processing to meet the demands of AI. Processing commands using hardware resources can improve performance, as firmware (FW) intervention can significantly slow processing. The currently used NVMe stack is not designed for such hardware processing as the varieties of options that are infrequently used in general and more specifically in the AI applications generally lead to some level of firmware intervention to manage complexity involved in the processing.

Implementations using NVMe commands according to a current version of NVMe standard have various limitations. When looking at performance, there are two commands that are most relevant: Read and Write.

In focusing on READ and WRITE commands in accordance with a current version of NVMe standard, there are two major limitations in their design. First, the original intent for the NVMe protocol was to provide a simpler interface that ranges from laptop to data center, compute to storage, mobile and automotive devices. As such, the structure must cover multiple, often incompatible, usage models.

The second limitation relates to backward compatibility. For example, in data centers, the NVMe protocol was intended to replace SAS and, to facilitate adoption, would then carry all capability of SAS, including capabilities no longer critical when NVMe was introduced. Further, the Storage SAN protocols are designed for sub-systems and not for devices, and also compatibility with key OEMs. At least some embodiments disclosed herein remove the backward compatibility to simplify the processing of read and write commands.

Existing NVMe Read commands (NVMe Write commands are similar except for minor differences) are structured as follows:
Command Dword 0:
   Opcode: 1 byte (0x02 for READ)
   Fused Operation: 2 bits
   Command Identifier: 2 bytes
Command Dword 1:
   Namespace Identifier: 4 bytes
Command Dword 4-5:
   Metadata Pointer: 8 bytes
Command Dword 6-9:
   Data Pointer: 16 bytes (split into two 8-byte fields)
Command Dword 10-11:
   Starting LBA (Logical Block Address): 8 bytes
Command Dword 12:
   Length: 2 bytes (number of logical blocks to read)
   Control: 2 bytes
Command Dword 12-15: Command-specific fields, often reserved or used for additional control parameters.

When desiring fast processing, many of the parameters in the command are not necessary. For example, the “fuse operation” parameters can be removed. In some cases, certain parameters can be optimized.

More significant problems relate to parameters in the fields of Command Dword 12-15. For example, some parameters are not useful for high-performance fast processing (e.g., “Limited Retry”, “Force Unit Access”). Other parameters are redundant. Yet other parameters can be improved by optimization. For example, “Storage Tag Check” and “Protection Information” are parameters that are attributes of the Namespace, and so can be set as static values at the time of namespace (NS) creation. These parameters do not need to be repeated in every command. They are present to provide compatibility with existing software management that was designed for SCSI/SAS-based hard drives.

The presence of such unnecessary parameters in commands presents a significant technical problem. Even if parameters are not relevant to a command operation, the mere existence of the parameters in the command requires that the parameters be evaluated and any corresponding action taken. In effect, this prevents the command from being effectively accelerated because of parameters that, in such high-performance cases, are not needed and need firmware intervention.

For example, the above problem exists for Command Dword 13-15 for Read commands. There are many control parameters provided here to allow flexibility and backward compatibility. However, these parameters cause a technical problem for processing using a high-performance path, both because these parameters are not needed and would make full hardware acceleration impractical.

In addition to the above, there are other technical challenges associated with NVMe devices. As SSDs have increased in speed, more recent systems use an SSD as secondary memory in AI applications. For example, many GPU cores/threads may have parallel requests to the SSD for such applications. It can be advantageous to use one queue pair (a pair of submission queue and completion queue) for each thread. However, AI applications in some cases can have a very large number of parallel threads (e.g., thousands or more). But, for example, a typical SSD is limited to handling only 1024 submission queues (e.g., because of the hardware/controller used in the SSD). As a result, the host needs to run software to combine commands from multiple threads into a single submission queue. This can cause inefficiencies due to synchronization required for handling the combination of commands from these threads.

In one example, an NVMe interface is used for communication between a GPU or other host on one side of a connection fabric (e.g., PCIe fabric) and an NVMe SSD on the other side of the connection fabric. This interface is used by the GPU or host to send NVMe commands to the SSD and to receive NVMe command completions.

For example, the NVMe interface passes NVMe commands and gets completions as described in NVMe spec 2.0. This interface uses NVMe Submission Queues, Completion Queues, and NVMe doorbells. This interface was designed for use cases in which the number of threads is fairly limited. However, as mentioned above, new use cases having large numbers of threads are emerging for which this interface is not efficient. Thus, there is a need for an improved NVMe interface to cope more efficiently with these new use cases.

In one example of a NVMe use case, threads running in a host operating system (OS) issue NVMe commands. These OS threads (e.g., 100-900 threads) are factored on host logical CPUs (sometimes referred to herein as LCPUs) with one queue pair (QP) associated to each logical CPU. This is done because OS threads are scheduled one at a time on an LCPU.

Even if there are thousands or more OS threads doing input/output operations (IOs) on a host server, only a few hundred (number of host LCPUs) actually access QPs at the same time. This limitation exists because at any given time, only one thread can run on a given LCPU.

Because the QP associated to the LCPU is updated by one thread at a time (the one currently running on the LCPU), there is no need for synchronization between threads regarding QP updates. However, the QP update is typically enclosed by synchronization code to handle the rare situation of one or more LCPUs being removed. This synchronization code doesn't generate significant overhead.

The synchronization is typically implemented via an atomic variable, one per QP. A test-and-set operation is done on that atomic variable. For example, the atomic variable AVi for QPi stays in the L1 cache of LCPUi associated to QPi. A thread running on LCPUj accesses only AVj and never AVi. Consequently, the atomic variable stays exclusive in the L1 cache, and modifying the atomic variable requires about one clock cycle.

An NVMe Completion Queue of a QP is polled by only one thread at a time, running on the LCPU associated to the QP. Hence, the most likely situation for the submission queue (SQ) is that there is no need of synchronization. For this use case, the NVMe interface typically operates satisfactorily.

However, as mentioned above, there are new emerging NVMe use cases in which a processor (e.g., a GPU) issues a large number of NVMe commands. For example, in these use cases hundreds of thousands of GPU threads can access the NVMe QPs simultaneously. This is significantly more than the number of threads for the few hundreds of LCPUs of the use case above.

The thread synchronization required above presents a technical problem that induces significant GPU overhead when queuing NVMe commands and getting their completion status. This overhead is incurred by the threads on the GPU when the threads synchronize the access to NVMe submission queues (SQs) and completion queues (CQs). Implementing this synchronization code robs processing cycles and/or resources from the GPU (e.g., a Streaming Multiprocessor (SM) of the GPU).

Now discussing this increased overhead need in more detail, on an NVIDIA GPU, for example, threads run on Streaming Multiprocessors. A GPU contains typically between one and two hundred SMs. Each SM can run several hundreds or thousands of threads in parallel.

Similarly to the NVMe use case above, it can be desirable to have only one thread at a time using a QP. In such case, there could be a need, for example, for several hundred thousand NVMe QPs. Each QP would have one or very few NVMe commands (and most of the time typically only one command) queued in the QP submission queue. The creation of these QPs would be time-consuming, and these QPs would waste a lot of SSD hardware resources.

Having a limited number of NVMe QPs available, one can consider how the use of the QPs might potentially be optimized in the above GPU use case. Noting that all threads running on a same Streaming Multiprocessor (SM) share the same L1 cache, an efficient use of NVMe QPs is to use one QP per SM. Any thread running on the SM can use the QP associated to the SM. Doing so guarantees that the serialization atomic variables (e.g., used to serialize access to the QP across threads running in parallel on the SM, one set of atomic variables per QP) and the QP itself stays in the SM L1 cache. No other thread running on another SM is going to access the QP.

When contention happens (e.g., several threads running on the same SM post in the SQ or read the CQ), the contention is handled in the SM L1 cache, and there is no need to access the GPU main memory. This reduces SM thread stalls (e.g., cache miss is avoided) by handling the contention in L1 cache, and also reduces the usage of memory bandwidth.

However, the above approach still has significant limitations. Specifically, the threads running on a same SM must wait in turn to access the QP, one after the other. The threads wait by looping doing atomic operations on the QP atomic variables, to know when it is a thread's turn to access the QP. This creates undesirable SM overhead.

In some approaches, a part of the queueing can be done in the same SQ in parallel (e.g., writing NVMe commands in parallel in different entries of the SQ). But these approaches themselves also require the use of atomic variables. Some parts of the queuing cannot be done in parallel. For example, the SQ doorbell update and ensuring that SQ content is consistent with the doorbell value must still be serialized. For completion queues (CQs), memory atomic operations are used again to synchronize several SM threads reading the CQ associated to the SM.

Thus, even if attempts were made to improve queuing by assigning QP(s) per SM (e.g., atomic memory variables used for synchronization stay in L1, and contention is reduced to intra SM) and writing is done in parallel in SQ entries, there is still undesirable overhead having the SM use atomic memory operations (e.g., in particular at high frequencies).

At least some techniques provided in the present disclosure address the above and other deficiencies and challenges by providing a memory sub-system that can selectively process commands using either a normal execution path (e.g., for read/write commands in compliance with a current version of NVMe standard that provides extensive options and/or backward compatibility) or an accelerated execution path (e.g., for new, extended read/write commands that are in compliance with a current version of NVMe standard in some aspects for compatibility but not other aspects to reduce options and/or backward compatibility to old technologies that are not likely being used). For example, the normal execution path is supported by using firmware-based resources to handle various parameters included in commands. The accelerated execution path reduces or eliminates usage of the firmware-based resources. Commands processed using the normal execution path are sometimes referred to as being processed in a normal mode. Commands processed using the accelerated execution path are sometimes referred to as being processed in a fast mode. For example, processing of a type of operation (e.g., reading a block of data from, or writing the data to, the storage space of the memory sub-system at a logical block addressing (LBA) address) in the fast mode is faster than processing of the same operation in the normal mode.

In one embodiment, both normal and fast commands use a compatible data layout for data stored in the storage space of a memory sub-system. For example, data written to a block of the storage space with a normal write command can be read from the same block using a fast read command. Data written to a block of the storage space with a fast write command can be read from the same block using a normal read command. This provides backward compatibility.

In some embodiments, when commands are configured to include a first opcode that is designed to indicate to a memory sub-system (e.g., solid-state drive) that a command is to be processed using the accelerated execution path, the path skips or ignores processing of certain bit segments that would be recognized as fields in an alternative command generated by replacing the first opcode with a second opcode that is designed to indicate to the memory sub-system to use the normal execution path. Thus, the processing of the commands having the first opcode can be fully implemented in hardware of a memory sub-system according to one embodiment.

In some embodiments, a memory sub-system (e.g., NVMe solid-state drive) has execution paths selectable by a host system to bypass firmware-based processing. The memory sub-system is configured with a hardware accelerator to process basic parameters of standard NVMe read/write commands, and firmware programmed to further process optional/additional control parameters of each respective command.

Optionally, an indication can be provided to the memory sub-system to disable the processing of certain fields of a command as if such parameters in the field(s) were known to the memory sub-system and/or not present via the command. For example, a command can cause the memory sub-system to enter a fast mode of ignoring predetermined fields for optional/additional control parameters (e.g., fuse operation parameters in Command Dword 0, and some fields in Command Dword 12-15). When operated in such a fast mode, the processing of a command specified in accordance with a current standard of NVMe is accelerated using hardware to reduce or eliminate firmware-based processing of some options that are allowed in accordance with the current standard of NVMe.

When the memory sub-system is in a normal mode of operation, the memory sub-system can further execute firmware to examine the fields for optional additional control parameters and, if such parameters are provided, process them according to the NVMe protocol or standard.

In one embodiment, the fast mode can be triggered via a command for a period of time until another command causes the memory sub-system to enter the normal mode. For example, the fast mode can be identified via the opcode provided in the Command Dword 0, or another field provided in the command, such as an optional field configured in another Command Dword; and the memory sub-system is to process the command in the fast mode.

In one embodiment, a memory sub-system has a host interface configured to receive first commands (e.g., normal NVMe commands) and second commands (e.g., fast NVMe commands). Each command has a first field and a second field. The memory sub-system has a controller that processes the first commands using a first mode (e.g., normal mode) in which the first and second fields are processed, and the second commands using a second mode (e.g., fast mode) in which the first field is processed and the second field is ignored.

For example, the first field is processed in the first and second modes using hardware circuitry. The second field is processed in the first mode at least in part using firmware. The firmware is not used for any processing in the second mode.

Each of the first and second commands includes an opcode (e.g., indicating a normal NVMe read execution path or a fast/accelerated read execution path). The controller selects either the first or second mode for handling a received command based on the opcode.

For example, processing of the commands is hardware accelerated. The delivered commands are simplified so that an ASIC is able to complete them without firmware intervention. This approach maximizes speed. Although firmware is needed for error and exception handling, this approach completely removes firmware processing from the accelerated data path for execution that does not result in errors.

Optionally, the new commands can be configured to facilitate sub-block transfers. For example, artificial intelligence implementations use a range of various features. In one example, AI inference requires transfers that are significantly small and not aligned to the SSD LBA structure. For example, a GPU may need 128 bytes (cache size) that sits in an LBA address x at an offset of 256 bytes. If a controller reads the entire LBA block (4 KB) into the host memory, it can consume a significant amount of host memory, only for the host to extract the 128 B from the byte range of 256 to 256+127, and move the extracted data to GPU memory. This is time consuming and limits performance. In contrast, a new command disclosed herein can be configured to cause the memory sub-system (e.g., a solid-state drive) to transfer just the required 128 B to the required address, regardless of where this data is located inside the LBA block.

For example, the new commands can be implemented in a manner that is backward-compatible to a certain degree with existing NVMe interfaces. While this is not strictly necessary, the ability of the new commands to be used with existing storage stacks is an advantage in some situations. In other situations, the new command interface can be used stand-alone in a different way that is not necessarily compatible with existing NVMe. In such other situations, the new commands can be compacted in a way to further maximize performance.

In one example, a processor (e.g., GPU) generates commands retrieved by an SSD over a PCIe bus. For example, the processor can be a GPU Streaming Multiprocessor (e.g., NVIDIA GPU), a host core, or other similar physical processing unit running code that issues NVMe commands.

In one embodiment, a memory sub-system stores data in non-volatile memory cells. A controller of an SSD receives work requests from a host system. For example, each work request includes an access command. In response to receiving each work request, the controller executes the corresponding access command in the received work request to perform an operation on the non-volatile memory cells.

In one embodiment, an SSD includes at least one non-volatile memory device and one or more controllers. The SSD stores data for a host system on which a plurality of threads execute for training a neural network(s).

In one embodiment, a memory sub-system (e.g., an NVMe device) is configured to provide access to a host system. The host system can read/write the NVMe device using an NVMe block command set based on addressing in a block namespace, where the full LBA block of data is transmitted across the PCIe bus for read or write.

In one example, a read and write can be performed using an NVMe memory namespace command set. An NVMe device can be configured to perform a read operation to retrieve the data from a set of memory cells allocated as the storage resources of an LBA block.

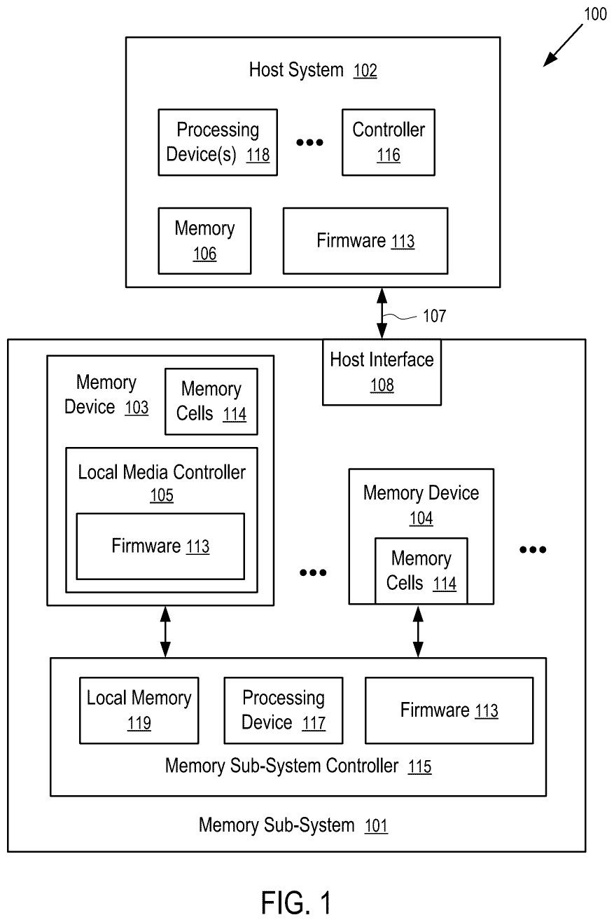

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include firmware 113 (e.g., using a submission queue) configured to receive commands (e.g., access commands) from one or more host systems 102. In various embodiments, the firmware 113 is used to exchange input/output (IO) commands and completions between a host system (e.g., a GPU) and a memory sub-system (e.g., an NVMe SSD).

In some embodiments, the controller 115 in the memory sub-system 101 includes at least a portion of the firmware 113. In other embodiments, or in combination, the controller 116 and/or the processing device 118 in the host system 102 includes at least a portion of the firmware 113. For example, the controller 115, the controller 116, and/or the processing device 118 can include logic circuitry implementing the firmware 113. For example, the controller 115, or the processing device 118 (processor) of the host system 102, can be configured to execute instructions stored in memory for performing the operations of the firmware 113 described herein. In some embodiments, the firmware 113 is implemented in an integrated circuit chip disposed in the memory sub-system 101. In other embodiments, the firmware 113 can be part of firmware of the memory sub-system 101, an operating system of the host system 102, a device driver, or an application, or any combination therein.

For example, the firmware 113 implemented in the controller 115 and/or 105 of the memory sub-system 101 can configure processing of commands in various ways. In some embodiments, an indication is included in each read or write command to indicate a type of processing (e.g., normal or fast mode) of the command to be performed by the memory sub-system 101. Normal commands are processed by the memory sub-system at least in part using firmware-based resources. Fast commands are processed by the memory sub-system 101 using hardware circuitry only. Host system 102 sends commands to the memory sub-system 101 over a PCIe fabric. Controller 115 executes the commands (e.g., NVMe commands) to access memory device 103.

In one example, the controller 115 can run the firmware 113 of the memory sub-system 101 to retrieve commands from the host system 102 over a PCIe fabric. Controller 115 executes the commands (e.g., NVMe commands) to access memory device 103. Controller 115 indicates completion of the commands to host system 102 by sending signals over the PCIe fabric.

In one example, managers in the host system 102 and in the memory sub-system 101 are configured to establish namespaces. For example, the namespace can be an NVMe block namespace. The smallest unit of storage space accessible in the namespace is a block represented by a respective address defined in the namespace to represent the block. For example, the storage size of a block can be 512 bytes or more (e.g., 4096 bytes). A set of physical storage resources (e.g., memory cells 114) are allocated to implement the physical storage space represented by the namespace.

In one example, memory sub-system 101 is configured to access a region of storage locations. Host system 102 can use a protocol (e.g., a NVMe block command set) to send an access request to an SSD. The access request is directed to an address in a namespace; and the memory sub-system 101 can provide a corresponding response using the protocol.

For example, the access request sent to the SSD can be a read command. The memory sub-system 101 can execute the read command and determine the storage resource allocated to implement a logical block having the address defined in the namespace. The memory sub-system 101 then retrieves a data block from the storage resource, and sends the data block across the computer bus 107 to the memory 106 of the host system 102, as instructed by the access request according to the protocol.

For example, the access request sent to the SSD can be a write command. The memory sub-system 101 can use an address map to determine a storage resource block allocated to implement a logical block having the address defined in the namespace. After retrieving the data block from the memory 106 of the host system 102, as instructed by the access request according to the protocol, the memory sub-system 101 can program the storage resource block to store the data block obtained from the memory 106 of the host system 102.

Further details of the operations of the firmware 113 in the host system 102 and in the memory sub-system 101 are discussed below.

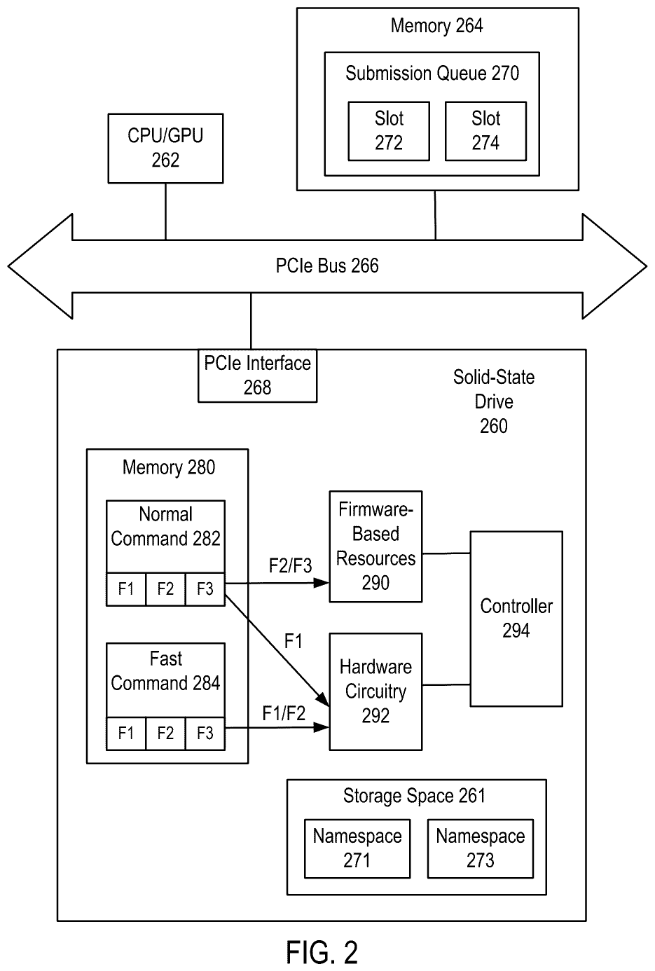

FIG. 2 shows a solid-state drive 260, configured to implement a memory sub-system 101 of FIG. 1, that receives normal and/or fast commands 282, 284 according to one embodiment. CPU/GPU 262 communicates with memory 264 and solid-state drive 260 using PCIe bus 266. Memory 264 has a submission queue 270 for holding commands (e.g., NVMe read or write commands 282 and fast commands 284) to be retrieved by the solid-state drive 260. CPU/GPU 262 generates the commands and places each command into one of slots 272, 274 of submission queue 270 (e.g., configured according to a standard of NVMe).

CPU/GPU 262 and memory 264 are an example of host system 102. Solid-state drive 260 is an example of memory sub-system 101.

Solid-state drive 260 retrieves the commands from the submission queue 270 via PCIe interface 268. The retrieved commands are buffered in the local memory 280 of the solid-state drive 260. In one example, memory 280 is a command queue of solid-state drive 260. In one example, memory 280 is buffer memory or local random access memory for temporary storing of commands waiting to be processed/executed.

Each command 282, 284 has a common size in bytes. Each command can include fields F1, F2, F3 (and other fields) at the same bit segments of the commands. For example, the data structure of the normal command 282 corresponds to a command structure defined in a current version of the NVMe standard; and each field F1, F2, or F3 in the normal command 282 corresponds to a predefined location (e.g., bit segments) in the normal command to provide a parameter in a way defined in the NVMe standard. The fields F1, F2, and F3 in the fast command can be the corresponding bit segments in the normal command 282. The meaning of the parameters provided in some of the fields F1, F2, and F3 in the fast command can be different from what is specified in the NVMe standard; the meaning of the parameters provided in some of the fields F1, F2, and F3 in the fast command can be the same as what is specified in the NVMe standard; and some of the fields F1, F2, and F3 in the fast command can have no meaning and are thus ignored (e.g., skipped in processing). In one example, field F1 corresponds to a set of one or more Dwords, field F2 corresponds to another set of one or more Dwords, and field F3 corresponds to yet another set of one or more Dwords.

Each command 282, 284 includes an indication of a type of processing to be performed by controller 294 when executing the command. The indication indicates how each field of the command is to be processed (e.g., as a fast command or a normal command).

Normal commands 282 are processed using a normal execution path. This path includes use of firmware-based resources 290 and hardware circuitry 292.

Field F1 in the normal command 282 and the fast command 284 is processed using only hardware circuitry 292. For example, field F1 is a data pointer or starting LBA address.

Field F2 in the normal command 282 is processed using firmware-based resources 290. For example, field F2 is Dword 13 of an NVMe read command containing parameters/options (e.g., for Dataset Management and/or other parameters). Field F2 in the fast read command 284 can have no meaning, or be repurposed to provide one or more different parameters different from the parameters provided in Field F2 in the normal command 282.

Field F3 in the normal command 282 is processed using firmware-based resources 290. For example, field F3 is Dword 14-15 of an NVMe read command containing command-specific parameters. Field F3 in the fast read command 284 can have no meaning, or be repurposed to provide one or more different parameters different from the parameters provided in Field F3 in the normal command 282.

Fast commands 284 are processed using an accelerated execution path. This path includes use of hardware circuitry 292 without any use of firmware-based resources 290.

In one example, SSD 260 has a DMA engine (not shown) to retrieve data/commands from the memory 264 and write data/completion records to the memory 264.

The data in a slot in a submission queue 270 (e.g., as configured according to the NVMe standard) is seen by the solid-state drive 260 as a command. The controller/processor 294 of the SSD checks various segments/fields of the data/command to determine what operations/tasks the CPU/GPU 262 wants the SSD to perform by entering the command/data in the slot 272, 274.

In accordance with a current version of NVMe standard, each NVMe command has a total size of 64 bytes, or 16 Dwords (double words), that can be referenced as Dword 0 to Dword 15. When Dword 0 has the opcode value for a normal read as defined in a current NVMe standard, the command is interpreted as a normal read command; when the Dword 0 has the opcode value for a normal write as defined in a current NVMe standard, the command is interpreted as a normal write command.

For a normal command, Dword 0 also has a two-bit field to specify a “Fused Operation”. If the value of the field is “00”, there is no fused operation. If the value of the field is “01”, the command is a first command for fused operation. If the value of the field is “10”, the command is a second command for fused operation.

For a fast command, as indicated by an opcode value for a fast read (or write) that is different from the opcode as defined in the current NVMe standard for read (or write), the SSD 260 does not examine or check the value in the segment location of data that corresponds to the field “Fused Operation” of a normal NVMe command. The SSD 260 executes the fast command with the assumption that there is no fused operation, as if “00” were specified in the corresponding location for specifying “Fused Operation” in a normal command. Thus, the fast command is limited to operate in the pre-identified configuration of “no fused operation”, even when “01” or “10” is specified in the field. In one embodiment, the opcode field is used to indicate that a command is a fast command. In other embodiments, a fast command can be indicated to SSD 260 using another indication provided in another field (e.g., a vendor-specific field or a reserved field) of the command. For example, the meaning of a value of “11” specified in the fused operation field is reserved in the current NVMe standard. It can be extended to indicate that the command is a fast command, which allows the fast command to use the same opcode for a normal read in a fast command. In such an implementation, the SSD can have a hardware circuit to check whether the fused operation field has a value of “11” to determine whether the command is a fast command to be processed using an accelerated execution path.

In one example, SSD 260 supports both a normal read/write command/mode having one or more fields that are parsed and processed according to a standard of NVMe; and a fast read/write command/mode in which these fields are simply ignored by the SSD. In some embodiments, instead of being ignored, these one or more fields are interpreted in a different way in the fast mode.

In some embodiments, a fast read or write command is processed with the assumption that the fields of the command provide a set of predefined/fixed values, regardless of the actual content in the fields. When a field in a standard NVMe is eliminated/not processed for a fast command, the information normally sent from the host system to the SSD in a normal command using this field is not transmitted or processed. For example, a namespace creation command is used by a host system to send namespace metadata/attributes to be used in subsequent read/write commands. For example, if a default namespace is established, then the namespace field can be eliminated; the fast command is processed as if the command has the default namespace identified in the namespace field. For example, if the namespace field is eliminated, the hardware of the SSD can be preconfigured to use the default namespace; and a routine to extract the namespace from the fast command and setting up the use of the namespace can be skipped (because the processing work was previously done).

SSD 260 includes storage space 261. For example, the storage space can be implemented via NAND flash memory. A fast or normal read/write command is executed in the SSD 260 to read data from, or write data into, storage space 261.

The capacity of the storage space 261 can be partitioned into one or more namespaces 271, 273. Physical storage resources (e.g., NAND flash memory) are allocated to implement logical storage blocks in namespaces 271, 273. A namespace 271 or 273 can have a plurality of logical storage blocks, each having a same size and represented by a logical block addressing (LBA) address configured in the respective namespace 271 or 273. For example, to specify a location in the storage space 261, a fast or normal read/write command can specify a namespace identifier in a “namespace identifier” field configured in the respective command (e.g., Dword 1 or bytes 7:4 of the command), and an LBA address in a “Starting LBA (SLBA)” field in the respective command (e.g., in Dwords 10-11 or bytes 47:40 of the command), where the LBA address is defined specifically in the namespace represented by the namespace identifier.

In one embodiment, normal and fast commands 282, 284 use a compatible data layout for data stored in storage space 261. For example, data written to a block of the storage space (e.g., in namespace 271) with a normal write command 282 can be read from the same block using a fast read command 284. Data written to a block of the storage space 261 with a fast write command 284 can be read from the same block using a normal read command 282.

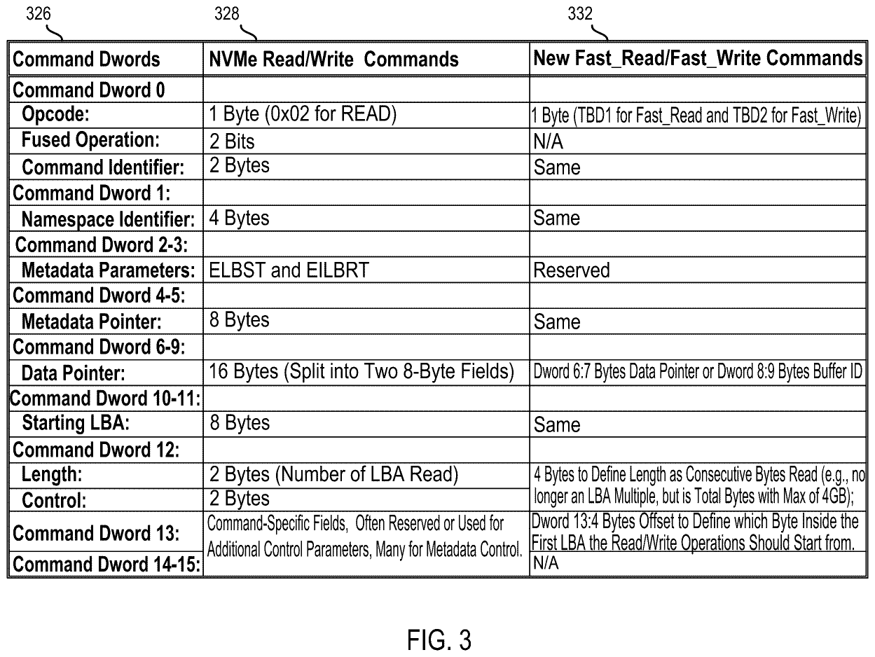

FIG. 3 shows structures of normal commands and fast commands according to one embodiment. As illustrated in FIG. 3, each read or write command, which can be a normal command 328 or a fast command 332, has a same total size of 16 Dwords (64 bytes, or 512 bits) in accordance with a current standard of NVMe. The 512 bits of a command can be broken into Dwords 0 to 15 for convenience in referencing, as illustrated in column 326.

Columns 326 and 328 show how various segments of bits in a normal command in compliance with a current NVMe standard are used to carry parameters of a read or write command. Column 332 shows an example of a fast command that has a reduced and/or modified set of parameters that are configured in some bit segments in a way similar to how the parameters of the normal command are carried.

For example, the parameters of “Opcode”, “Fused Operation”, and “Command Identifier” (or Command ID) of a normal read/write command are configured in Dword 0. The Opcode field occupies a bit segment of 1 byte in Dword 0; the Fused Operation field occupies another bit segment of 2 bits in Dword 0; and the Command Identifier field occupies a further bit segment of 2 bytes in Dword 0. Some bits in Dword 0 are reserved in the current NVMe standard and thus not used to carry parameters of meaning as defined in the standard. The Dword 0 of a normal command can further include a field to indicate whether PRP (Physical Region Page) or SGL (Scatter Gather Lists) is used for data transfer. For example, an opcode value of 0x02 can be used in the Opcode field to identify the command as a read command according to the NVMe standard; and an opcode value of 0x01 can be used in the Opcode field to identify the command as a write command according to the NVMe standard. In some embodiments, a fast command is configured to use the same bit segment to carry an opcode. For example, a value different from 0x02 and not currently in use to represent another type of command in the NVMe standard can be used to indicate that the command is a fast read command; and a further value different from 0x01 and not currently in use to represent another type of command in the NVMe standard can be used to indicate that the command is a fast write command. Alternatively, a bit in a Dword currently reserved in the NVMe standard (e.g., one of bits 13:10 in Dword 0) can be used to carry an indication of whether the command is a fast command or a normal command. For example, when the bit has a value of zero (0), the command is to be recognized as a normal command; and when the bit has a value of one (1), the command is to be recognized as a fast command. Alternatively, a reserved value in a field currently used in the NVMe standard can be repurposed to indicate that the command is a fast command. For example, consider the value of 0x03 in the field for specifying whether PRP or SGL (e.g., bits 15:14 in Dword 0) is used for data transfer. This value can be used to indicate that the command is a fast command that does not use PRP or SGL for data transfer. In such a manner, the bit segments of normal read/write commands to carry a parameter as defined in the NVMe standard can be modified to accommodate the transmission of parameters for fast read/write commands with reduced or minimized conflicts with definitions in current NVMe standards.

For example, normal commands 282 in FIG. 2 can have a command format as illustrated via columns 326 and 328. Fast commands 284 in FIG. 2 can have a command format as columns 326 and 328 further modified as via column 332. In one example, controller 294 and/or hardware circuitry 292 examine and process parameters identified in FIG. 3. The number of fields processed for a fast command 284 can vary depending on embodiments.

A comparison of the command structures of a normal command 282 and a fast command 284 as defined in the embodiment of FIG. 3 is now described below. Examples of fast commands 284 are sometimes indicated as FAST_READ and FAST_WRITE commands. The FAST_READ and FAST_WRITE commands can be used to provide an accelerated high-performance data operation. These fast commands can coexist with existing read and write commands (sometimes referred to as READ and WRITE) for processing in a memory sub-system 101 of FIG. 1 and/or a solid-state drive 260 of FIG. 2. A host system can send any mix of normal and fast commands to such a memory sub-system 101 or solid-state drive 260 for execution. The host system can select this mix depending on whether accelerated performance is desired or data management is to be performed. The fast commands can be used inside the same namespace as normal commands. The fast commands are coherent in the namespace in the same fashion as for existing read and write commands. For example, the fast commands can be compatible with and additive to NVMe standards. Optionally, a memory sub-system 101 of FIG. 1 can choose to implement fast read/write commands without implementing normal read/write commands; in such implementations, it is not necessary to configure a command in a way to explicitly indicate whether the command is a fast command or not. For example, the opcode values 0x02 and 0x01 can be reused as opcodes for fast read/write commands without using a further bit or field to indicate that the command has the format as modified from an NVMe format according to column 332. For example, the fast read/write command format can be adopted in a future version of NVMe standard as read/write command after the use of the command format as illustrated via columns 326 and 328 is discontinued in the future NVMe standard.

Each of the fast commands uses a 64-byte data structure to maintain NVMe compatibility.

Various fields are now described below. This includes modifications to fields, potential performance impact, and disposition of a field value for processing.

Command Dword 0 (i.e., the first four bytes of a command) contains the same opcode field (e.g., bits 7:0) for both a normal command and a fast command for improved compatibility. New opcode values can be defined for fast commands. Command Dword 0 also contains the Command identifier (ID) that is used for identifying commands in a queue. This parameter field can be kept in the fast read/write commands as currently specified in the NVMe standard for normal read/write commands to support NVMe compatibility.

However, fused operations are not supported for fast read/write commands. The fuse command is used for getting locks (e.g., read data and if zero, write 1, so get a lock) in an atomic fashion. The fuse command is not used for fast commands as the targets are data and not locks. If a lock is necessary, the lock can be acquired with a fused read and write as currently done in NVMe. This will not affect fast commands. Thus, the “Fused Operation” bits (e.g., bits 9:8 in command Dword 0 configured for defining fused operation in a normal command) can be ignored in a fast command and are indicated as N/A in column 332. The memory sub-system 101 of FIG. 1 and/or solid-state drive 260 of FIG. 2 can execute the fast command according to the pre-selected configuration of “00” being specified in the “Fused Operation” bits (e.g., bits 9:8 in command Dword 0) regardless of the actual content in the “Fused Operation” bits in the fast read/write command. Alternatively, as discussed above, since the value of “0x03” is currently reserved for the “Fused Operation” bits in the NVMe standard, the value of “0x03” can be used in the “Fused Operation” bits to indicate that the command is a fast command, even though the opcode field of the command has the opcode “0x02” or “0x01” for read or write according to NVMe standard.

Regarding Command Dword 1, the Namespace Identifier (NS) will be configured in a fast command in the same way as in a normal command. Dwords 2-3carry some metadata information (e.g., ELBST and EILBRT in bits 47:00 of Dwords 2-3). This can be removed from fast commands of one embodiment.

Regarding Command Dword 4-5 (Metadata Pointer), in some embodiments the fast commands do not use metadata and this field can be ignored. In other embodiments, the fast commands include this field. For example, metadata may have value in certain implementations, or possible future usage. The metadata is handled in a way that maintains backward compatibility. For this purpose, the metadata pointer is the same for both normal commands and fast commands. However, information on how the metadata is to be handled, which is kept in Dword 12 and other fields, is restructured for fast commands.

In normal NVMe read and write commands, byte 12 of Dword 12 in the 64 byte Dword data structure carries PRINFO and STC information that instructs an SSD how to handle the metadata. This is done on a command-by-command basis so that a system, for backward compatibility, can use this information as desired. However, in more modern systems, metadata is an attribute that is constant throughout the entire namespace and allowing each command to behave differently is a source of unnecessary complexity.

In one embodiment, for fast commands all command-specific fields are removed from Dword 13, and the ELBST and EILBRT parameters are removed from Dword 3. Instead, this information is used as namespace attributes that apply to more than one command. In one embodiment, all fields are removed from Dword 13-15.

In one embodiment, to use the removed information as namespace attributes, the namespace creation command is modified. Alternatively, a separate command is used to add namespace attributes. The namespace creation command and/or the separate command to add namespace attributes are used to communicate to the SSD the metadata type to associate with each namespace. With this approach, each FAST_READ and FAST_WRITE only uses the data pointer without using any other variable option. The SSD will know what type of metadata are used for the targeted namespace and will use the metadata accordingly. This simplifies the command extraction and data movement, while allowing any desired metadata models to be used. It also has the advantage of preventing unnecessary mixing of different metadata in the same namespace.

The above simplification over the normal command to have a format for a fast command provides an advantage because metadata management can involve many possible combinations of settings that need to be analyzed and disposed of. Doing this dynamically command-per-command is expensive and resource intensive. In contrast, moving this processing to a namespace attribute set up approach allows the proper setting for that namespace to be created at the beginning prior to using commands, and the proper setting is then continuously reused on each subsequent command. This avoids having to recompute the proper settings for each command.

In one embodiment, the following activities are performed: configuration of metadata type at namespace creation, changing metadata type, deleting metadata type, and/or reporting metadata type. These activities can be implemented using additional commands, modifications to equivalent NVMe commands, and/or newly-created commands.

For example, with the above organization, when a command with an IO request is received, it will be dispatched to an ASIC (application specific integrated circuit) that has already been prepared to handle metadata as indicated by the namespace attributes. The ASIC can perform all necessary checks or generation, and report errors using existing NVMe error codes.

Regarding Dword 10-11 (Starting LBA), this field relates to the first LBA address (starting LBA) that will be accessed in response to receiving a command. This field will be configured in a fast command in the same in way as in a normal command for improved compatibility.

Regarding Dword 6-9 (Data Pointer), some changes in use of the fields are made for fast commands as described below. First, it is noted that for NVMe commands, Dword 6-7 contains a data pointer if a system wants to read/write a single LBA. In the case that a system wants to read/write multiple LBAs, the system additionally adds Dword 8-9 as a pointer to a PRP list of the other LBAs to read/write.

Regarding Dword 12 (Data Length and Control) as used in NVMe commands, a Number of Logical Blocks (NLB) field configured in Dword 12 of a normal command (e.g., bits 15:0) is used in NVMe standard to specify the number of LBAs to read/write in the execution of the normal command. Using an integer value in the field can specify the data length for read/write as a multiple of LBA block size. However, there is not a way to specify a fraction of one LBA block in the NLB field to address a sub-block.

Changes for data length are made for the new fast commands. In one embodiment, at least a portion of Dword 12 (or the entire Dword 12) of a fast command is configured to carry the parameter of data length, but this length is expressed in bytes rather than a number of LBAs. For example, this size value will be, in most common applications, 4K times larger than for current NVMe. As such, 12 additional bits, in addition to the 16 bits of NLB field configured in Dword 12 of a normal command, can be allocated from the fast command (e.g., Dword 12) to specify the data length in bytes. Optionally, the full 4 bytes of Dword 12 of the fast command can be configured to specify the data length for read/write. In some cases, the data length can be expressed using another unit of data other than a byte, such as a data length expressed as a number of units each having a size of, for example, 32 B, 64 B or 128 B.

Another change that impacts data length is that a read/write operation will start at an LBA address. For example, if a system desires to read a sub-block of, say, 128 bytes, this value is specified in this length field. However, in some cases, the sub-block needed is not at the beginning of the LBA. Instead, the sub-block is located somewhere inside the LBA. For example, a system can request to read 128 bytes, starting from byte 1024 of LBA 0x1234.

Regarding Dword 13, a new parameter referred to as “offset” is added to fast commands to specify where the data transfer begins inside the first LBA to read or write (e.g., the value of 1024 in the above example). To implement this, Dword 13 is repurposed. In one embodiment, all existing NVMe parameter fields configured in Dword 13 of a normal command are either removed or reconfigured to provide via NameSpace attributes so that Dword 13 of a fast command is free and available for carrying the offset. For example, a request to read 128 bytes, starting from byte 1024 of LBA 0x1234 will be expressed by using Dword 10-11 for LBA (0x1234), Dword 12 for length (128 bytes), and Dword 13 for offset (1024). Optionally, the offset field of the fast command can be configured in other locations that are not used to carry other parameters.

Using the above approach in various embodiments, a host system can direct an SSD to read and write any length of data (e.g., even one byte if necessary and up to 4GB). The SSD 260 of FIG. 2 can process FAST_READS differently from FAST_WRITES in the case the offset is not equal to zero and/or length does not correspond to a multiple number of LBA addresses as the commands will do address transfers that are not an integer multiple of LBA blocks.

In the case of read commands, SSD will need to round up the number of LBAs to one more (e.g., #LBA=(length>>12)+1) and then transfer exactly the number of bytes specified in the “length” parameter starting at the “offset” parameter. For example, hardware circuitry of an SSD rounds up the number of LBAs by adding one to the result of dividing the length by 4,096. The SSD then transfers the number of bytes indicated by the value of “length,” starting from the value specified for “offset.” In one embodiment, the read operation is done by using internal memory as a temporary buffer. In one embodiment, the SSD directly sets a DMA operation for the appropriate length of data to be transferred and the remainder of the data is not transferred (e.g., remaining data is sent to null).

In the case of write commands, the operation is more complex as writing under the above conditions requires modifying at least one LBA. In this case, the SSD writes the integer number of LBAs (if any) that corresponds to the data specified for being written. Then, for the LBA for which there is a partial write to perform, the SSD will perform a Read-Modify-Write (e.g., read the LBA block that requires partial modification, modify those bytes as indicated by the length and offset parameters of the command, and write the whole LBA back). For example, a hardware accelerator of the SSD writes the full LBAs. For an LBA that requires a partial write, the SSD performs a Read-Modify-Write operation using the hardware accelerator. This involves reading the LBA for which a portion of data needs modification, updating the specified bytes based on the given length and offset, and then writing the entire data for the LBA back to physical memory (e.g., NAND flash).

Using the above approach, any size of data can be read and written. For example, this provides a useful tool for an inference system that often needs to read sparse data (e.g., data having a few significant elements dispersed in a vast array of irrelevant data). Instead of needing to move all of this data (most of the data is irrelevant), this approach permits transferring only the needed data. This results in faster and cleaner processing. This also has the benefit of reducing or avoiding memory amplification. Memory amplification can occur when significantly more memory is used (e.g., for irrelevant data) rather than just using the needed memory for specific sparse data.

In one example, an SSD reads the entire set of data stored at an LBA address. If the host requests only a portion of the data at the LBA address (sub-block), the SSD reads the entire set of data, and then provides the requested portion to the host. The remaining portion of data is discarded and need not be transferred to the host system. The entire block of data stored at the LBA address is stored as one ECC codeword. To decode the data, the SSD reads the entire codeword.

Regarding the NVMe Data Pointer, the data pointer field of fast commands is modified as compared to normal commands, as described below. The above changes in the length field are used with the modifications to the data pointer. In one embodiment, the data pointer can be modified in two ways (that can coexist with one another), which are described below.

PRP and SGL can be useful features for current and simpler systems, but are complex to manage and largely an unnecessary burden for high-end systems. For example, a system is often addressing memory (e.g., DRAM) that can have sizes measured in terabytes (TB), but the system is required to use memory in chunks of 4 KB pages. Managing linked lists of 4 KB pages to build buffers is becoming increasingly difficult as memory sizes grow. This is particularly so because searching for appropriate blocks grows in complexity with memory size.

In some embodiments, new fast commands take advantage of Linux Folios. Linux has evolved and starting from kernel 6.13 released in late 2024, Linux supports a new feature called “Folios”. For example, Folios relate to sequential 4 KB pages that are used to compose a larger sequential entity called a Folio. One motivation for using Folios is that an operating system (OS) can more readily handle larger pages (e.g., Folios in this case). An advantage is that hardware acceleration can still be based on, for example, 4 KB pages (e.g., ARM processors can support 64 KB pages). Folios benefit from creating large buffers (e.g., up to 64 KB or larger) of sequential memory addresses.

In light of the above advantages, instead of using PRP and SGL, in some embodiments a system uses Folios (e.g., contiguous Folios) up to their limit size. Commands accessing data of a size larger than a Folio limit size (e.g., now 64 KB, but 256 KB and 1 MB expected in the future) can split commands into Folio-sized commands. For example, splitting commands does not necessarily negatively impact performance even though the perception may be that a single large command is more efficient to handle than two smaller commands. But this is not always the case. If a single command has to use PRP and SGL, this creates significant management overhead. Also, if a command needs large resources to be available, the resources may not become available at the same time as needed by the command. Thus, smaller commands may sometimes provide efficiency.

For example, smaller commands can begin execution when their own set of resources are available and do not need to wait for all resources to become available. For example, a 128 KB operation for a first command requires 128 KB of memory. The probability is that an SSD may only identify a smaller amount of free memory, for example 96 KB, when the SSD it receives the command. So, the SSD can either wait for the other 32 KB of memory to become available (such as would be needed by a single large command), or issue a 64 KB command while waiting for the 32 KB to become available and then issue the second command.

In one embodiment, the data pointer for fast commands is modified as compared to normal commands in two ways (that can coexist with one another). These ways are referred to below as Method 1 and Method 2.

In Method 1, fast commands use a physical address. In one example, the address is a system physical address. In one example, the address is a virtual machine physical address. For example, every time an SSD needs to do a DMA transfer of data, one or more addresses need to be translated from a virtual machine address to a system physical address. This requires processing time including going through an IO MMU for translation. In addition, if the DMA transfer is Peer-to-Peer (P2P), this also unnecessarily consumes bandwidth of the Root Complex. Doing the translation before the data transfer occurs (e.g., as discussed below) allows parallelization of operation and time savings when the transfer is actually done.

In Method 1, similarly to current NVMe, an address is inserted in Dword 6:7 and executes as done for current NVMe commands. Because PRP and SGL are not used, Dword 8-9 is unused. This approach provides backward compatibility with existing NVMe standards. A difference from existing NVMe commands is that only a single address is used in the fast commands.

In Method 2, fast commands use a Buffer ID. In one embodiment, when a host system desires to use a buffer identifier (e.g., Buffer ID), the host system generates a command by writing 0x0 in Dword 6-7. This is an illegal system address, so the SSD knows that the address in Dword 6-7 is implicitly not valid (hence determining the SSD is not to process the command using Method 1). Instead, the SSD knows to use the identifier (ID) of the buffer specified in Dword 8-9. As a result, the SSD executes the command by using the address that has been loaded in the table at the address identified by the identifier (ID).

Some embodiments disclosed herein include the use of fixed buffers for data transfer. Runtime management of Folios, by freeing them up and configuring them for each IO, is an expensive and tedious operation. Also, buffers are often (but not always) used as temporary storage (e.g., a page cache) to store data to be moved to a final destination (e.g., storage or another memory address). Creating new buffers for every IO for this purpose is both expensive and unnecessary, so many systems simply configure all the buffers needed at boot time and then reuse them as needed. This approach is already largely used today by many OS/Apps. In one example, the same approach can be extended with a fixed buffer pointing to the entire GPU HBM memory range. Given that HBM memory addresses are static, the buffers that point to these addresses can also be static.

Method 2 can be used to extend this static mapping to SSD operation, thus saving time for buffer management chores. In one embodiment, a system creates buffers as done for contiguous Folios and preloads addresses of the buffers in internal memory of the SSD. For example, if each address is up to 8 bytes in size, even for say 100,000 addresses, this uses no more than 1 MB of SSD memory. For example, this SSD memory does not need to be fast memory or non-volatile memory. Any DRAM space will suffice.

In one embodiment, to address the buffers, the buffers are put in a table with a Buffer ID that indicates the address for that respective buffer. In one embodiment, the length of each buffer is fixed (the IO size is variable, as long as it fits in the buffer). In one embodiment, the length of each buffer is variable. The host system ensures that the buffer is sufficiently large for any command issued by the host system that uses the buffer.

One advantage of the above method results from high-end systems having addresses that are virtualized. For example, the address sent to an SSD may not be a real physical address, but instead need to be translated by an IO memory management unit (MMU) (e.g., using ATS services) before being used. If the target address is for a peer device (e.g., a NIC for a DMA on a remote node), all of these translations may generate extra traffic that burdens the PCIe interface.

Instead, if addresses for the buffers are preloaded, the SSD can use ATS to preemptively perform all necessary virtual-physical translation, cache the address, and perform any other validity check. Thus, when an IO using that buffer ID is invoked, the DMA processing is simpler and does not require further translation or validation. Moreover, this preparation can be done offline at system setup and generally will not change (unless some addresses are invalidated). Generally, such invalidate commands are infrequent, so their impact on performance is minimal. In contrast, the negative impact of continuous translation for Method 1 is significant.

Both Method 1 and Method 2 can be used to accomplish similar results with different tradeoffs (e.g., Method 1 is more flexible, while Method 2 is more performant). Method 1 and Method 2 can also coexist with the existing address approach of existing NVMe Read and Write commands. Hence, usually it is high-performance IO (most likely the majority of commands in such systems) that will use these new methods.

In some embodiments, steering tags are used for transferring data. In one embodiment, the steering tags are used with either Method 1 or Method 2 above. For example, the PCIe Steering Tag is used to direct data to the correct target memory. The steering tag is used to make cache coherency and data delivery more efficient. The PCIe SIG has defined a mechanism, called a Steering Tag, that is used. The PCIe SIG has not codified its usage. So, the steering tag provides available bits that can be used (with no prior definition of their use).

In one embodiment, values are defined for delivery to GPU HBM and other relevant memory locations. For example, if there is a need to move data to a memory target on a coherent domain, the data are generally transferred to main memory and then to target memory to keep the coherency model working. The Steering Tag can be used to indicate to a memory sub-system to deliver the data to the final destination (e.g., GPU memory). This bypasses the intermediate main memory step and invalidates all other entries accordingly. This saves time, bandwidth, and resources.

For example, in a cache coherency protocol, when a cache entity becomes the owner of data, the cache entity sends a message to memory and all peer devices telling them the cache entity now owns the data so the memory and peer devices should invalidate their own copy (if any) of the data.

In one example of existing NVMe data transfer, sending data from an SSD to a cache on GPU3 uses the following steps:
Data are sent by SSD to target memory address
Memory gets hold of the data (data is written in system memory (e.g., DRAM), which becomes the current owner of the data)
All caches, including GPU3, invalidate the data they may have at that address
GPU3 fetches the new data from memory
All caches are updated to reflect new ownership
Processing on data can start

With use of the Steering Tag used as described herein, the processing flow is performed as follows:
Data are sent to GPU3
All caches, including memory, are updated
Processing on data can start

The flow using the Steering Tag is more efficient, and the data are moved only once (e.g., SSD to GPU3) rather than twice (e.g., SSD to memory and then memory to GPU3). The above flow using the Steering Tag is compatible with PCIe specifications.

In one embodiment, a new usage model is defined for the Steering Tag mechanism. This model uses the Reserved configuration bits of the PCIe TLP packet. These three configuration bits are used in the PCIe TLP packet (basically the PCIe transfer packet), and are reserved for the Steering Tag.

In one embodiment regarding Dword 13:15, all data options are removed and not used in fast commands. In one embodiment, if data used in these fields for normal commands is a part of metadata, the data is moved to identify namespace attributes at the time of namespace creation (e.g., as discussed above).

Although the fields for Dword 13:15 are not used for fast commands, these fields are retained to match the command byte count of 64 as is done in all NVMe commands sent by a host system.

In one embodiment, completion processing is improved by use of the data Steering Tag of the response buffer (making delivery more efficient), as described above. For example, there are two types of data a Read/Write command accesses: data buffers and a command/completion queue. The data may be on different processing cores, so the Steering Tags for data in buffers may be different than the Steering Tags for data in queues. For example, data can be in GPU memory and in queues on CPU cores. Data for transfer to either location can use this Steering Tag approach.

In some embodiments, a host system uses fast commands that are not compatible with the NVMe standard. This approach can provide a non-NVMe command set. The approaches described above for fast commands do not rely on NVMe for any specific reason. For example, a new interface can use a different delivery mechanism. Fields used for NVMe could be replaced with corresponding new values in new fast commands.

For example, if a new method uses LUN instead of namespace (NS), the method can substitute values in this field. If direct mapping to storage is used, then NS=0. If the method is using LBAs of different size, this will be transparent to the SSD. If the method is not using LBAs, but instead uses direct page access, the LBA is replaced in a fast command with the page number, size length, and offset.

In one embodiment, a global address-based command ID is used. Given that the number of core threads keeps growing at an accelerated rate, it is difficult for an SSD to match the number of core threads with the number of Queue Pairs (QPs). As a result, GPU threads need to share a common SSD QP, which is undesirable. Fast commands as discussed herein can be used to address this issue, which is a common challenge in NVMe and many other interfaces.

The challenge above results from commands having a “Command ID” identifier (e.g., a unique number that is used to identify the command and associate it in the Completion Queue). In NVMe systems, the command ID is a progressive number that simply rolls over when a limit is reached.

More specifically, to enqueue a command, a thread needs to get a command ID. The thread needs to ensure no other core that is sharing the same queue uses the same command ID. The thread does this by locking the Command ID count, getting the next Command ID, and then releasing the lock. This is detrimental to performance if done across multiple cores (and also possibly done in multiple nodes).

In some embodiments, instead of using a progressive lock as described above, a command uses the Global Address of the memory buffer that the command (e.g., fast read or write command) is currently using (e.g., the memory address). The Global Address is a unique number as no two threads can perform read/write operations using the same buffer. The Global Address needs to be global (e.g., by using the node identifier). For example, if the threads run on different nodes, the threads may have a same lock buffer address, which is made unique if the node ID identifier is added. This avoids any inter-core communication for acquiring and releasing locks.

In one embodiment, fast commands use buffer identifier (e.g., Buffer ID) addressing as described herein. In this case, the fast command uses the Buffer ID as the Command ID (because the Buffer ID is already unique). This approach can be simpler, faster, and/or more compact. The Buffer ID will only be released when the command is complete, so there is no risk of aliasing or duplications.

In one embodiment, atomic enqueuing is used. When a command is moved to the command queue (e.g., submission queue), there is a need to ensure that no two threads are writing to the same command queue. Otherwise, the result may be an improper piecemeal combination of the two commands. In existing NVMe systems, this problem is avoided similarly as above (e.g., lock the queue, write a command to the queue, then release the queue). This approach can cause similar limitations as above.

Due to use of the Global address-based Command ID in a command as discussed above, there is no other dependency of the command from other commands. The submission queue is left unlocked so other commands can operate on it. A thread prepares a command in a scratchpad area (e.g., temporary cache or other memory of a host system). Once the command is prepared and ready, the thread moves the command to the submission queue using an atomic write (e.g., an existing x86 write operation that guarantees that data are moved into the queue in a single shot). This avoids any other thread being able to write to the submission queue while the command is moved.

In one embodiment, a command can be used to identify values of parameters shared by a set of commands for fast processing. The command can be used to provide some or all metadata parameters as attributes of a namespace to be accessed by the set of commands for fast processing.

In some cases, a host system may issue a normal read/write command with metadata parameters specified in the command, but the metadata parameters can be incompatible with the attributes specified for the namespace being accessed by the normal read/write command. Such a read/write command is processed using firmware. A controller of the solid-state drive 260 executing such a normal read/write command can check the metadata parameters in the command, and verify whether the metadata parameters of the command are compatible with the attributes currently set for the namespace being accessed by the command. If not compatible, the controller can reject the read/write command.

In one embodiment, a host configures a read or write command to pin the data read from or written to the storage space of the SSD 260 in a cache memory (e.g., a portion of the memory 280 of the SSD 260). For example, the data is a block of data retrieved from the storage space of the SSD 260 in response to a read command from the host to retrieve a sub-block of a block at an LBA address, which can be subsequently updated by the host during AI processing. Once the data of the entire block is pinned in the cache memory, a subsequent command operating on the LBA address can reuse the cached data without having to read it from the LBA address again.

For example, a read command can be configured with an option field (e.g., in a reserved or unused bit segment of the command). A predefined value can be specified in the field to indicate that data read from an LBA address be pinned. Subsequent commands operating on the LBA address can use the pinned data in the cache memory (e.g., a portion of the memory 280). For example, a subsequent write command to a sub-block does not have to read the data again from the storage media at the LBA address. Instead, the write command can modify the data in the cache memory and then write the modified data to the storage space at the LBA address.

Various types of commands can be configured to pin data. For example, a read/write fast command can be configured with a field at predefined bit segments of the fast command to provide a parameter that when having a predefined value causes the SSD to pin data being read from or written to the storage space of the SSD 260. For example, a normal read command can use a reserved field to indicate the request to pin. For example, a new command can use an opcode that represents read and pin. A pin option can be indicated by a newly configured option field (e.g., as an attribute of a namespace). Optionally, a command can be used to cause a “pin to cache” mode of the SSD to persist over more than one read/write command (e.g., multiple subsequent read/write commands will have data pinned to the memory of the SSD 260); and another command can be used to turn off the “pin to cache” mode.

In some cases, a write command can be configured to pin the data being written to the storage space of the SSD 260 to the memory 280 of the SSD 260. Optionally, a write command can have an option instruct the SSD 260 to write only to the pinned/cached version of data (e.g., this can delay writing the data to NAND storage media).

In one embodiment, a memory sub-system (e.g., SSD 260) supports sub-block reads and writes. In one example, the size of the sub-block is as low as a single byte (1 B). In one example, the size of the sub-block is 8 B-128 B.

When doing a write, a “Read Modify Write” operation is needed for a block at the target LBA address. The entire data in the block is to be written as a whole. For example, if a write command modifies 128 B out of total 4 KB of the block, the entire 4 KB is read/retrieved from the storage space, the requested 128 B modified, and the entire new 4 KB of data written back to the storage space at the target LBA address. The implication is that a single sub-block read is a single operation on the backend (e.g., a read at the SSD), while a single sub-block write is typically two operations (e.g., a read and a write at the SSD), which causes reduced performance when the read can be avoided in some situations.

In one example, sub-block writes are updates of reference parameters. The old value of the parameter is read, operated on, and updated with new value. For example, a read modify write is required for a sub-block size of 128 B or other size read. The read modify write is done at the LBA address level when the host system writes the new value back to the memory sub-system.

In one embodiment, a parameter is included in a fast command that causes read data to be pinned to a cache of an SSD. The pinned data is retained in the cache for use by the SSD when processing one or more subsequent commands. For example, a host GPU uses this feature of “pinning to cache” when the GPU is to update the reference parameters extracted from the sub-block. The fast read command used to get the reference parameters to be updated tells the SSD to keep the read data in its cache memory (e.g., as far and as long as there is cache memory available). Then, when the GPU uses a fast write command to store the updated reference parameters back to the sub-block, the SSD already has the read data in its cache. This eliminates a read step from the read modify write operation discussed above.

In one example of an existing approach without using the feature of “pin to cache”, to update a reference parameter:
GPU reads the 128 B or other size data from an LBA at an SSD
GPU updates the read data
GPU sends new 128 B data to SSD for writing to the LBA
SSD reads back old data at the LBA
SSD modifies the old data with the new data
SSD writes modified data back to the LBA

In one example of a new approach using the feature of “pin to cache”, to update a reference parameter:
GPU reads the 128 B or appropriate size data at an LBA. The read command causes an SSD to pin read data to cache (so the SSD is directed to keep a copy).
GPU updates the read data
GPU sends new 128 B data to SSD for writing
There is no need to read back old data at that LBA as data is already in cache.
SSD modifies the old data pinned in the cache with the new data from the GPU
SSD writes modified data back to the LBA

The above pinning of data to cache removes a read operation, so that the number of operations is reduced from three to two (only modify and write).

In one example, an SSD retrieves commands from a submission queue of a host system. Each command specifies an LBA address from which data is retrieved. The retrieved data is transferred to a memory address of host system memory that is specified in the command.

In one example, each command is configured according to a non-volatile memory express (NVMe) standard. Each NVMe command indicates one or more functions to be performed by the SSD (e.g., to read from a storage space of the SSD, to write to the storage space, etc.). The processor identifies read/write locations in the commands using logical block addressing (LBA) addresses. The SSD has a flash translation layer to map/translate the LBA addresses to physical addresses in flash memory of the SSD.

For example, each NVMe command further includes information about the location in the storage space for the operation, a location in main memory to store the retrieved data for a read, and/or a location in main memory to retrieve the data to be written into the SSD. A PCIe bus/physical connection used for accessing memory. The SSD accesses the main memory over the PCIe bus.

In one embodiment, a memory sub-system is an NVMe SSD. The NVMe SSD implements the NVMe interface using QPs as defined in the NVMe specification 2.0.

In one embodiment, a host system and memory sub-system communicate over a connection fabric. In one example, the connection fabric is a PCIe fabric and includes a root complex. For example, the root complex can be implemented by hardware of the host system, or can be implemented on a separate chip.

The connection fabric enables the host system and memory sub-system to access main memory of the host system. In one example, a controller performs direct memory access (DMA) operations on the main memory in response to commands received from the host system.

In one embodiment, a host system sends commands using transaction layer packets (e.g., TLPs according to a PCIe protocol). Each TLP can include a command (e.g., normal and/or fast command). In one example, the command is included as part of a work request encapsulated by the TLP. For example, the normal and/or fast commands are retrieved by an SSD via a submission queue. Corresponding completion records are received by a completion queue.

In one embodiment, a controller of the SSD copies commands to an internal command queue in response to receiving a transaction layer packet. In one embodiment, the command(s) of the TLP are stored in the command queue without any dependency on other transaction layer packets received from the host system. In one embodiment, multiple work requests can be delivered to the memory sub-system using a single transaction layer packet.

In one example, the connection fabric includes a PCIe bus acting as a bridge connecting a host system and an SSD. When the host system writes to memory in the SSD over the PCIe bus, PCIe TLPs are used. When the SSD reads or writes memory on the host side (e.g., to retrieve commands for a submission queue, or to enter a completion record in a completion queue), the SSD also uses PCIe TLPs.

In one example, a host system includes one or more cores. Each core executes one or more threads during training of one or more neural networks. During the training of the neural networks, various weights used in the training can be stored in a non-volatile memory device of an SSD in response to commands generated by one or more threads. Weights can also be read from the non-volatile memory device in response to commands generated by one or more threads.

In one example, an access request can be implemented according to the an access command having a predetermined command size (e.g., 64 bytes according to a version of NVMe standard). The access command can have a plurality of predefined fields, such as opcode, namespace identifier, LBA address, metadata pointer, data pointer, etc. For example, the predefined fields can be in compliance with a version of NVMe standard (e.g., base specification version 2.0). The opcode can be configured to specify whether the command is to be executed to read data or to write data.

In one embodiment, the opcode can be configured to specify whether the command is to be executed as a normal or a fast command (e.g., to read data or to write data.

In one embodiment, the namespace identifier can be configured to specify a namespace for the interpretation of the LBA address. The LBA address identifies, in the namespace, a logical block having the predefined logical block size (e.g., 512 bytes, or larger). The metadata pointer can be configured to provide an address of a physical buffer of metadata. The data pointer can be configured to provide an entry used for data transfer, such as an entry to facilitate data transfer via physical region page (PRP).

In one embodiment, a memory sub-system retrieves commands (e.g., normal and/or fast commands) from a submission queue of a host system. The submission queue and completion queue are a queue pair (QP). A controller periodically checks to see if a command is present in submission queue (or a doorbell register is used). If so, the controller reads the command from the submission queue, executes the command, and generates a completion record that is sent to the completion queue.

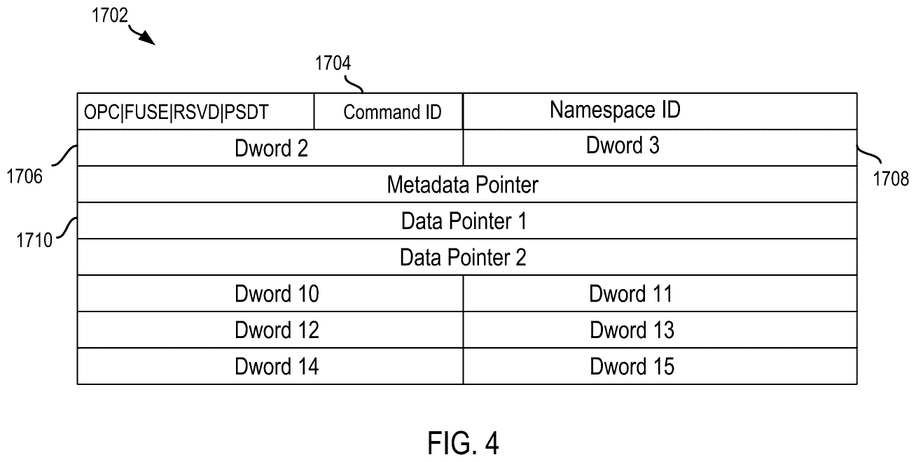

FIG. 4 shows a format of a read or write command 1702 (e.g., normal commands 282) received via a submission queue (e.g., in accordance with a current standard for non-volatile memory express (NVMe). The command 1702 includes various predefined fields to instruct a memory sub-system (e.g., 101 or SSD 260) to read data from, or write data to, a storage space 261 at a location identified via parameters embedded in the command 1702.

The command 1702 has a fixed size of 512 bits (64 bytes, or 16 double words). For convenience in referencing, the 512 bits of the command 1702 are partitioned into 16 segments of bits such that each of the 16 segments has 32 bits (or 4 bytes) and can be referred to as a Command Dword (double word) (or simply Dword). The 16 segments can be numbered as Command Dword 0 to Command Dword 15.

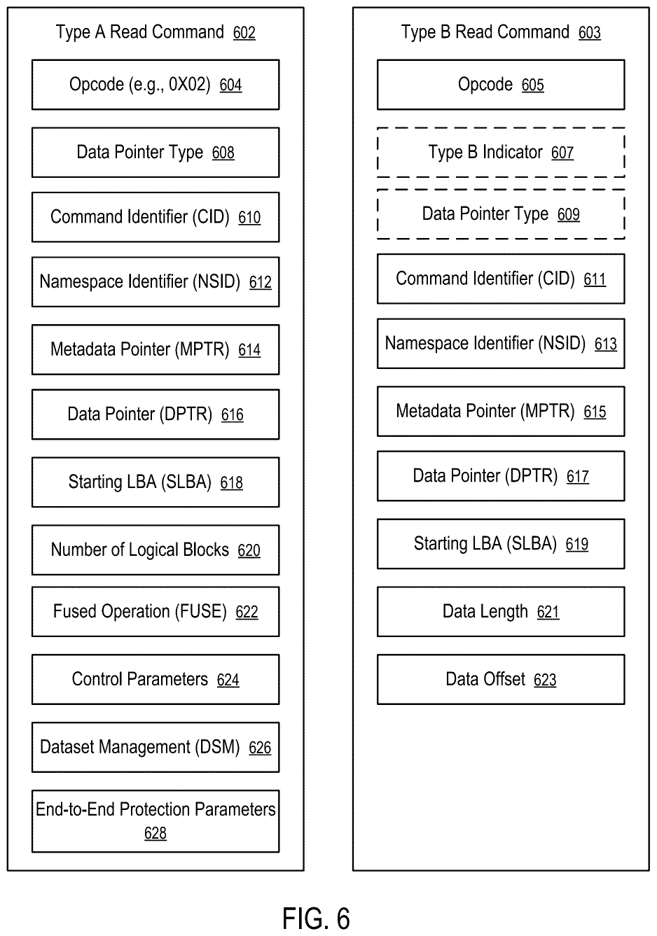

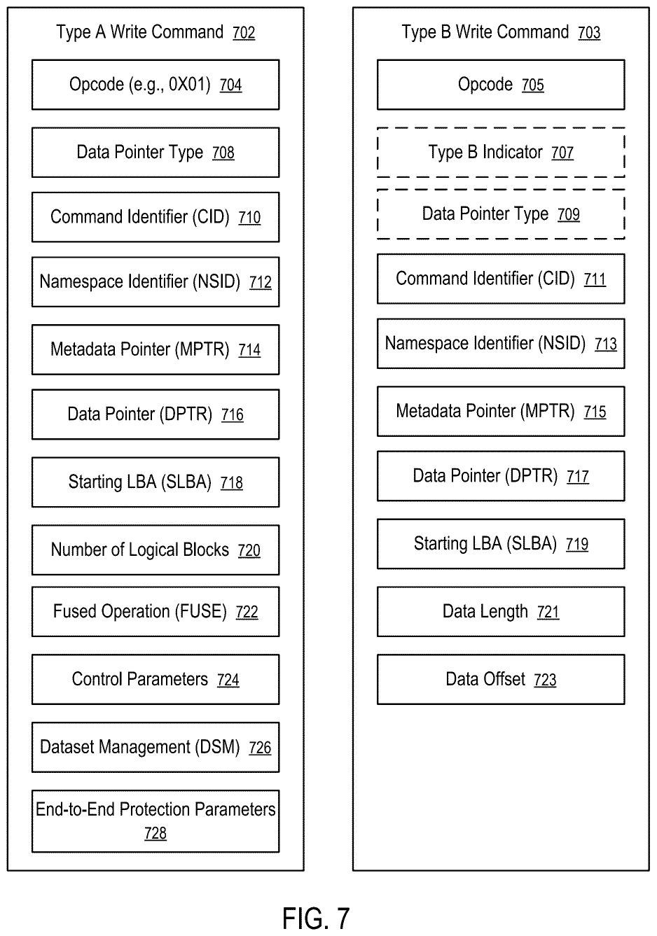

For example, the command 1702 includes a field 1704 configured in bits 31:16 of Dword 0 to carry a Command Identifier (CID or Command ID) of the command. The command 1702 includes a field configured in bits 15:14 of Dword 0 to carry a parameter PSDT (PRP or SGL for Data Transfer) configured to indicate whether Physical Region Pages (PRPs) or Scatter Gather Lists (SGLs) are used for any data transfer associated with the command. The command 1702 includes a field configured in bits 9:8 of Dword 0 to carry a parameter Fused Operation (FUSE) configured to specify whether the command is part of a fused operation and if so, which command it is in the sequence. The command 1702 includes a field configured in bits 7:0 of Dword 0 to carry a parameter Opcode (OPC) configured to identify a predefined type of operation of the command. For example, when the command has an opcode value of 0x01, the command 1702 is a write command; and when the command has an opcode value of 0x02, the command 1702 is a read command. For example, the bits 13:10 of Dword 0 are reserved in a current standard of NVMe and thus considered a reserved field (RSVD); and the entire set of 32 bits (4 bytes) of Command Dword 1 is used to identify a Namespace Identifier (NSID or Namespace ID) of a namespace to which the command is to be applied to. When the command 1702 is a read or write command, Dwords 2 and 3 (1706, 1708) are used to host parameters of Expected Logical Block Storage Tag (ELBST) and Expected Initial Logical Block Reference Tag (EILBRT) related to end-to-end protection. The command 1702 includes a metadata pointer field configured in Dwords 4 and 5 and a data pointer field 1710 configured in Dwords 6-9, along with other various fields (e.g., as further discussed in connection with FIG. 6 and FIG. 7).

In one example, the end-to-end protection parameters embedded in Dwords 2 and 3 of a normal command 282 are not extracted from a fast command 284. Thus, Dwords 2 and 3 of a fast command 284 can be ignored, or repurposed to provide other parameters of interest in the execution of the fast command 284. Dwords 10 and 11 are combined to host a “Starting LBA” field for a normal read/write command 282 and for a fast command 284. Dword 12 is configured to provide control parameters (e.g., Limited Retry (LR), Force Unit Access (FUA), Protection Information Field (PRINFO), Storage Tag Check (STC)) and “Number of Logical Blocks (NLB)” in a normal read/write command 282 can be repurposed to “data length” in a fast command 284.

In one example, the definitions of the fields in a normal command 282 are in accordance with a current standard of NVMe (e.g., NVM Express NVM Command Set Specification, Revision 1.1 of Aug. 5, 2024; and NVM Express Base Specification, Revision 2.1 of Aug. 5, 2024, the contents of which are hereby incorporated herein by reference).

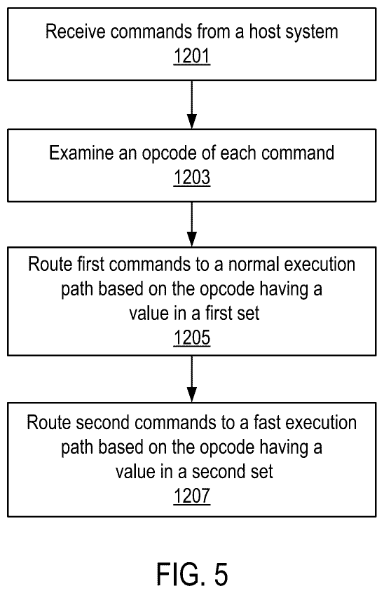

FIG. 5 shows a method for configuring read or write commands to indicate selection of either a normal or fast execution path for processing each command according to one embodiment. The method of FIG. 5 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 5 is performed at least in part by the processing device 118 of the host system 102, the controller 115 of the memory sub-system 101, and/or the local media controller 105 of the memory sub-system 101 in FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 5 can be implemented using the firmware 113 of FIG. 1 to perform the operations illustrated in FIGS. 2-4.

At block 1201 in FIG. 5, commands are received from a host system. The commands include first and second read/write commands of different types (e.g., normal and fast). In one example, the first commands are normal commands 282. In one example, the second commands are fast commands 284.

At block 1203, an opcode of each command is examined. In one example, the opcode is located in Dword 0 of an NVMe command. In one example, the opcode indicates the command is a fast command 332.

At block 1205, the first commands are routed to a normal execution path based on the opcode having a value in a first set. In one example, normal commands 282 are routed to a processing path that includes firmware-based resources 290 and hardware circuitry 292. In one example, the first set includes one or more values that indicate a type of normal processing to be used for a command.

At block 1207, the second commands are routed to a fast execution path based on the opcode having a value in a second set. In one example, fast commands 284 are routed to a processing path that includes hardware circuitry 292, but does not include firmware-based resources 290. In one example, the second set includes one or more values that indicate a type of accelerated processing to be used for command. For example, an SSD can have multiple different fast execution paths. The particular path to be used is indicated by the value in the second set.

In some aspects, the techniques described herein relate to a memory sub-system (e.g., solid-state drive 260) including: a host interface configured to receive first commands (e.g., normal NVMe commands 282) and second commands (e.g., fast NVMe commands 284), each command having a first field and a second field; and at least one controller (e.g., 115, 294) configured to process the first commands using a first mode (e.g., normal mode) in which the first and second fields are processed, and the second commands using a second mode (e.g., fast mode) in which the first field is processed and the second field is ignored.

In some aspects, the techniques described herein relate to a memory sub-system, wherein each of the first and second commands includes an opcode (e.g., indicating a normal NVMe read execution path or a fast read execution path), and the controller is further configured to select either the first or second mode for handling a received command based on the opcode. For example, if the opcode is for a read command, the command is processed in a read command processing mode; and if the opcode is for a write command (or another command), the command is processed in a write command (or other command) processing mode.

In some aspects, the techniques described herein relate to a memory sub-system, wherein the first field (e.g., Dword 6-7) includes a data pointer and the second field (e.g., Dword 13-15) includes at least one control parameter (e.g., metadata control parameters).

In some aspects, the techniques described herein relate to a memory sub-system, wherein the first field (e.g., Dword 10-11) includes a starting LBA address, and the second field includes fused operation bits.

In one example, if the standard opcode for normal NVMe read is specified in a command, the memory sub-system evaluates a field of “fused operation bits” in a particular segment location of Dwords of the command. When the new opcode for a fast read is specified in a command, the bits at this same segment location have no meaning by definition (and thus are not processed by the memory sub-system). In other embodiments, the meaning of data located in certain field(s) (e.g., predefined Dword, byte, and/or bit locations) of a normal command are redefined for the same field(s) in fast commands.

In some aspects, the techniques described herein relate to a memory sub-system, wherein the first field is processed in the first and second modes using hardware circuitry (e.g., 292).

In some aspects, the techniques described herein relate to a memory sub-system, wherein the second field is processed in the first mode at least in part using firmware (e.g., firmware-based resources 290).

In some aspects, the techniques described herein relate to a memory sub-system, wherein the first field (e.g., Dword 6-9) is configured for the first commands to include a data pointer, and configured for the second commands to include either a data pointer (e.g., in Dword 6-7) or a buffer identifier (e.g., buffer ID in Dword 8-9).

In some aspects, the techniques described herein relate to a memory sub-system, wherein the first field (e.g., Dword 12) when used in the first commands includes a number of LBA addresses to read, and when used in the second commands includes a length of consecutive bytes to read.

In some aspects, the techniques described herein relate to a memory sub-system, wherein the first field (e.g., Dword 13) when used in the first commands includes one or more command-specific parameters, and when used in the second commands includes an offset from a first LBA address to access as part of a read or write operation.

In some aspects, the techniques described herein relate to a memory sub-system, wherein each of the first and second commands includes an indication of a command type (e.g., a value in a vendor-specific field or a reserved field of a received command that indicates to use either a normal read/write execution path, or a fast read/write execution path), and the controller is further configured to select either the first or second mode based on the indication.

For example, the command type (e.g., read, write, fast read, fast write) is defined by the value in the opcode field of an NVMe 64-byte command structure. The opcode field is in the same location for both normal and fast commands. A same field (as defined by a size and location in the Dwords of a command) can have no meaning in one type of command as defined by an opcode field, and be necessary or essential for another type of command as defined by the opcode field. In some cases, the same fields can be partitioned/defined differently within the Dwords for normal and fast commands.

In some aspects, the techniques described herein relate to a memory sub-system including: a host interface configured to receive read or write commands, wherein each command has a predefined size (e.g., 64 bytes); and at least one controller configured to operate in a first mode (e.g., normal mode) in which a first portion of the received commands are processed using firmware, and in a second mode (e.g., fast mode) in which a second portion of the received commands are processed without using firmware.

In some aspects, the techniques described herein relate to a memory sub-system, wherein each command has a same size (e.g., 64 bytes arranged as 16 Dwords that are 4 bytes wide).

In some aspects, the techniques described herein relate to a memory sub-system, wherein each command includes an indication (e.g., an opcode or a value in a different field of the command) used by the controller to select the first or second mode for processing the command.

In some aspects, the techniques described herein relate to a memory sub-system, wherein each command includes fields, and the fields to be processed by the controller are selected based on the indication.

In some aspects, the techniques described herein relate to a memory sub-system, wherein each command includes a first field, and the controller interprets the first field in a different way for each of the first and second modes.

In some aspects, the techniques described herein relate to a memory sub-system, wherein the first field (e.g., Dword 13) when processed in the first mode is interpreted to include one or more command-specific parameters, and when processed in the second mode is interpreted to include an offset from an LBA address.

In some aspects, the techniques described herein relate to a memory sub-system, wherein the controller is further configured to select either the first mode or second mode for operation based a predefined parameter in a command received from a host system.

In some aspects, the techniques described herein relate to a memory sub-system, wherein the controller is further configured to: examine a field of a first command; and send, based on examining the field, the first command to either a queue for firmware processing, or a hardware acceleration path.

In some aspects, the techniques described herein relate to a memory sub-system, wherein the commands are configured to be compatible with a protocol for non-volatile memory access (e.g., NVMe standard).

In some aspects, the techniques described herein relate to a memory sub-system, further including at least one non-volatile memory device, wherein the controller (e.g., 250) is further configured to: receive, from a submission queue of a host system, a first command configured with a predefined field, wherein the predefined field includes a command identifier.

In some aspects, the techniques described herein relate to a memory sub-system, wherein the controller is further configured to receive, via the host interface, a first command configured to determine whether the second mode is supported.

In some aspects, the techniques described herein relate to a memory sub-system, wherein the controller is further configured to send, in reply to the first command, a response indicating that the second mode is supported.

In some aspects, the techniques described herein relate to a memory sub-system, wherein the controller is further configured to change operation from the first mode to the second mode in response to receiving a second command from a host system.

In some aspects, the techniques described herein relate to a memory sub-system including: memory configured to receive commands each having first and second fields; and at least one controller configured to operate in a first mode (e.g., normal mode) in which the first and second fields are processed, and in a second mode (e.g., fast mode) in which the first fields are processed and the second fields are ignored.

In some aspects, the techniques described herein relate to a memory sub-system, wherein the controller is further configured to: when operating in the first mode, execute firmware to examine the second fields for parameters; and if at least one parameter is provided, process the parameter according to a standard (e.g., NVMe standard) for communications between memory sub-systems and host systems.

In some aspects, the techniques described herein relate to a memory sub-system, wherein the controller is further configured to select either the first mode or second mode for operation based on examining a field in a command received from a host system.

In some aspects, the techniques described herein relate to a memory sub-system, wherein the commands request a read or write operation, and the second fields include parameters that are not necessary for completing the read or write operation (e.g., command parameters in the NVMe standard such as fused operation parameters in Command Dword 0, and/or parameters in Command Dword 13-15).

In some aspects, the techniques described herein relate to a memory sub-system, wherein the first fields include an LBA address (e.g., starting LBA) and a data pointer, and the second fields include optional control parameters.

In some aspects, the techniques described herein relate to a memory sub-system, wherein the second fields include fused operation parameters.

In some aspects, the techniques described herein relate to a memory sub-system, wherein each command is configured according to a standard for communications between memory sub-systems and host systems.

In some aspects, the techniques described herein relate to a memory sub-system, wherein the standard is a standard for non-volatile memory express (NVMe).

In some aspects, the techniques described herein relate to a memory sub-system including: firmware-based resources configured to process commands; and at least one controller configured to, in response to receiving an indication from a host system, reduce usage of the firmware-based resources in processing the commands.

In some aspects, the techniques described herein relate to a memory sub-system, wherein the usage of the firmware-based resources is eliminated.

In some aspects, the techniques described herein relate to a memory sub-system, wherein the reducing usage includes ignoring at least one field of the commands.

In some aspects, the techniques described herein relate to a memory sub-system, wherein the indication is included in a command.

In some aspects, the techniques described herein relate to a memory sub-system, wherein the command is a read or write command.

In some aspects, the techniques described herein relate to a memory sub-system, wherein: the command is a first command; the usage of the firmware-based resources is reduced from a first extent of usage to a second extent of usage; and the controller is further configured to, in response to receiving a second command, return the usage of the firmware-based resources to the first extent.

In some aspects, the techniques described herein relate to a memory sub-system, wherein the indication is an opcode in a command.

In some aspects, the techniques described herein relate to a memory sub-system, wherein the indication is at least one field in a command received from the host system.

In some aspects, the techniques described herein relate to a memory sub-system, wherein the indication is provided by a set feature command.

Various embodiments related to NVMe-compatible fast read commands that turn off processing of options for normal NVMe read commands are now discussed below.

In one embodiment, an opcode is used in a fast command to cause a memory sub-system to perform the operations of a normal NVMe read command, except a controller of the memory sub-system ignores a predefined set of fields (e.g., fuse operation parameters in Command Dword 0, and at least some fields in Command Dword 13-15). The fast read command is processed with the assumption by the controller that the fields provide a set of predefined/fixed values, regardless of the actual content in the fields.

In one example, the memory sub-system is memory sub-system 101 or solid-state drive 260.

In one embodiment, the fast read command can have the same content as a standard NVMe read command, except that the standard opcode for a normal read command is replaced with a new opcode that indicates to the controller that the command is a fast command. The new opcode can be used by the host system to instruct the memory sub-system to ignore the predefined set of fields/parameters provided in the standard NVMe read command having the content.

In one embodiment, when the predefined set of fields in an NVMe read command are ignored, the memory sub-system can skip running a set of routines (e.g., firmware-implemented routines) in processing the read command for improved performance.

The size of a block represented by a Logical Block Addressing (LBA) address can be defined via an NVMe command (referred to as “Formatted LBA Size” in NVMe). For example, the block size can be 512 bytes, or 4 KB, or another number. The normal NVMe read command specifies the number of contiguous LBA addresses to be read, which is the multiple of the Formatted LBA Size.

In one embodiment, a fast read command does not specify a data length (e.g., the size of the data to be read from the storage space or written to the storage space) as a number of logical blocks each having the Formatted LBA Size. Instead, the fast command defines a length as a number of consecutive units of data to be read. In one example, the unit of data can be a byte, word, double word, or cacheline (e.g., 128 bytes). In one embodiment, the fast command includes a field predefined at a bit segment in the fast command; and a value specified in the field identifies the unit. In some implementations, the size of the unit is computed from the value (e.g., as 2 to the power of the value). In one example, the length can extend over multiple logical blocks. Also, the range of data represented by the length is not necessarily aligned with a logical block boundary; and an offset from the logical block boundary corresponding to a starting LBA address specified in the command can be specified in a field configured in a predefined bit segment of the command.

In one embodiment, some of the bit locations of Dword 12 can be used to define the unit of data for the length. For example, if a unit field has a value of n, the unit of data is defined as 2\hat{ }n bytes.

In an alternative embodiment, values for the unit of data can be coded to represent commonly used sizes, such as 0 for LBA block size, 1 for byte, 2 for 8-byte, 3 for 128-byte.

In one embodiment, values for the unit of data are specified in another Dword, such as the “Fused Operation” field of Dword 0.

FIG. 6 shows two types (Type A and Type B) of read commands according to one embodiment. For example, the read commands can be retrieved by a controller 115 of a memory sub-system 101 from a submission queue 270 for execution within the memory sub-system 101.

Type A read command 602 carries various parameters in compliance with a current NVMe standard. The parameters define the scope, requirements, resources, etc. of operations to be performed during execution of the command. This command execution includes firmware processing for at least some of the parameters. In one example, read command 602 is a normal command 282.

Type B read command 603 carries various parameters used in command processing by the non-volatile memory sub-system. In some cases, the processing of these commands does not require, or reduces the extent of, firmware processing (e.g., due to elimination of fields used in Type A read command 602). In other cases, the processing of one or more parameters of these commands may use firmware processing. The number of parameters and/or options defined by read command 603 are reduced relative to the number of parameters and/or options defined in read command 602 (e.g., read command 603 does not include dataset management field 626 or end-to-end protection parameters field 628). In some cases, certain parameters and/or options are not included in read command 603 to provide accelerated processing. In one example, read command 603 is a fast command 284.

In one example, read command 602 and read command 603 can be configured, with embedding appropriate parameters in various fields of the commands 602 and 603, to cause a controller 115 of the memory sub-system 101 to perform an identical operation of reading a block of data from non-volatile memory implementing the storage space 261 and loading the block of data to a same memory location in the memory 264 of the host system 102. Although the backend operation is the same in each case, read command 603 has fewer fields than read command 602, or read command 603 skips one or more fields that are processed for read command 602.

Various parameters of Type A read command 602 are now described below. These parameters are indicated by values provided in various defined fields of read command 602.

Opcode field 604 specifies the opcode of the command to be executed. For example, an opcode value of 0x02 can be used in the opcode field to identify the command as a read command according to the NVMe standard. The opcode value is configured in bits 07:00 of command Dword 0.

For example, an opcode in opcode field 604 has 8 bits. Bits 7:2 indicate Function, and bits 1:0 indicate Data Transfer. For example, a value of 10b for bits 1:0 indicates a data transfer for a read. The Function portion of the opcode for read is 0. Thus, the combined opcode (the entire opcode value) is 02h in hexadecimal.

Data pointer type field 608 is configured to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0.

If the PSDT option is set to 01b or 10b (indicates use of SGL), a controller can use Scatter-Gather Lists (SGL) in two ways. For data buffers, SGL enables data transfers by specifying multiple non-contiguous memory locations. For command submission (indirect SGL), SGL entries are stored separately from the command, which avoids command size limitations. When indirect SGL is used, the command only specifies a memory address; and the controller has to fetch further data regarding the SGL from the memory address. In some cases, SGL can be used to specify the accessing of a sub block.

Command identifier field 610 specifies a unique identifier for the read command 602 when combined with the submission queue identifier. This field is configured in bits 31:16 of command Dword 0.

Namespace identifier field 612 specifies the namespace that read command 602 applies to. This field is configured in bytes 07:04 of command Dword 1.

Metadata pointer field 614 is configured to carry a memory address of metadata provided in a way according to the option specified in the data pointer type field for the execution of the read command 602. This field is configured in bytes 23:16 of command Dword 4-5.

Data pointer field 616 specifies the data used in the read command 602. This field is configured in bytes 39:24 of command Dword 6-9.

Starting LBA field 618 indicates the 64-bit address of the first logical block to be read as part of the read operation for read command 602. This field is configured in bits 63:00 of command Dword 10-11.

Number of logical blocks field 620 indicates the number of logical blocks to be read when executing read command 602. This field is configured in bits 15:00 of command Dword 12.

Fused operation field 622 specifies whether read command 602 is part of a fused operation and if so, which command it is in the sequence. This field is configured in bits 09:08 of command Dword 0.

Control parameters field 624 corresponds to the parameters for “Limited Retry (LR)”, “Force Unit Access (FUA)”, “Protection Information Field (PRINFO)”, and “Storage Tag Check (STC)” defined in command Dword 12. “Limited Retry (LR)” indicates whether the controller should apply limited retry efforts when executing the command and is configured in bit 31.

“Force Unit Access (FUA)” is a flag configured in bit 30 that, if set, forces the controller to fetch data from non-volatile media (e.g., rather than from any volatile cache). If the flag is set to 1, then data and metadata associated with logical blocks specified by read command 602 is committed to non-volatile media, and the data and metadata read from non-volatile media are returned.

“Protection Information Field (PRINFO)” is configured in bits 29:26 and specifies the protection information action and check field. “Storage Tag Check (STC)” is configured in bit 24 and specifies the Storage Tag field is to be checked as part of end-to-end data protection processing.

Dataset management field 626 indicates attributes for the LBA addresses being read when executing read command 602. The dataset management field 626 is configured in bits 07:00 of command Dword 13. For example, bit 6 “Sequential Request” can be set to inform the controller that this read is part of a sequential stream of reads. Other attributes include indications for access frequency and latency tolerance for the LBA range being read. These attributes can provide guidance to the controller for configuring how it fetches data.

End-to-end protection parameters field 628 corresponds to the parameters defined in Dwords 2, 3, 14, and 15. Bits 47:00 of command Dwords 2-3 and bits 31:00 of command Dword 14 specify the variable sized Expected Logical Block Storage Tag (ELBST) and Expected Initial Logical Block Reference Tag (EILBRT) fields. If the namespace identified in the read command is not formatted to use end-to-end protection information, then these fields are ignored.

The Expected Logical Block Application Tag Mask (ELBATM) field is configured in bits 31:16 of command Dword 15. This field specifies the Application Tag Mask expected value. The Expected Logical Block Application Tag (ELBAT) field is configured in bits 15:00 of command Dword 15. This field specifies the Application Tag expected value. If the namespace identified in the read command is not formatted to use end-to-end protection information, then these fields are ignored.

In one example, NVMe supports an end-to-end data protection feature that can be used to guard against data corruption between the host and the storage space 261 (e.g., NAND flash) of SSD 260. If a namespace is formatted with metadata, these bytes can store a Guard field (CRC), Application Tag, and Reference Tag. The read command's PRINFO and STC fields (configured in command Dword 12) allow the host to specify what integrity checks to perform. The controller can automatically verify the guard CRC on a read and if it detects a mismatch, the controller generates a Guard Check error.

The application tag and reference tag can be used to ensure the data is from the expected location or context (e.g., the reference tag can include the logical block address which the controller compares against the actual LBA, detecting misdirected writes/reads). If the host sets the Storage Tag Check (STC) bit, the controller will also verify the application tag on read. End-to-end protection, when enabled, can improve reliability by detecting corruption that might occur in the read path (e.g., in the PCIe link, or DRAM memory, or within the controller). In one example, read commands and data transfers are protected by PCIe's Link-layer CRC and memory ECC (if the host's memory or the SSD's buffers have ECC).

Various parameters of Type B read command 603 are now described below. These parameters are indicated by values provided in various defined fields of read command 603.

Opcode field 605 specifies the opcode of the command to be executed. The opcode value can be configured in bits 07:00 of command Dword 0 (same location as for read command 602) for compatibility with the NVMe standard, or can be configured in another bit segment or location of the command. For example, the value of the opcode can indicate that the command is a fast command 284.

In one embodiment, a new opcode is defined for Type B read command 603. For example, the opcode can be a vendor specific opcode for I/O commands (in the range of 80h to FFh). For example, a value of 0x82 can be used to provide a fast vendor specific read command that is in compliance with the NVMe standard for vendor specific extensions.

Optionally, read command 603 is configured to further include a Type B indicator 607 configured to indicate to the controller whether the command 603 containing the Type B indicator 607 is to be processed to have the fields as defined for Type B read command 603. For example, Type B indicator 607 can be a single-bit field configured in a bit segment that is reserved in a read command according to a current NVMe standard. When a first value (e.g., “1”), is specified in Type B indicator 607, the controller 115 of the memory sub-system 101 can recognize the command 203 as a “Type B” read command having the fields as configured in a way different from the “Type A” read command 602, even when the same opcode “0x02” is used in the command 603. When a “Type B indicator 607” is used to differentiate a “Type A” read command 602 and a “Type B” read command 603, the use of the “Type A” command 602 is to be modified to also include the field of “Type B indicator 607” at the same single-bit field that is reserved in a current NVMe standard; and when a second value (e.g., “0”) is specified in the field, the memory sub-system 101 can recognize that the command is a “Type A” command 602 having fields as defined differently from the “Type B command 603”. Alternatively, whether a read command is a “Type A” read command 602 or a “Type B” read command 603 is based on the use of different opcodes in the opcode fields. In one embodiment, Type B indicator 607 is configured to indicate that the command 603 containing it is a “Type B command 603” based on a specific value provided in a field that is also defined in the “Type A command 602” where the meaning of the specific value in the field is reserved according to a current NVMe standard so that the controller interprets the presence of the specific value in the field is an indication that the retrieved command 603 is to be interpreted in a way as illustrated for the Type B read command 603, different from the field definitions of Type A read command 602. In some implementations, a memory sub-system 101 is configured to support the “Type B” read command 603 without supporting the Type A read command 602 that is in compliance with a current NVMe standard. In such implementations, it can be unnecessary to have a “Type B indicator 607”, and the same opcode 0x02 currently used for “Type A” read command 602 can be reused as the opcode for “Type B” read command 603.

In one embodiment, the value of the opcode provided in opcode field 605 can be the same (e.g., 0x02) as used in opcode field 604, and a command is indicated as being a Type B read command 603 (e.g., a fast command 284) in another way such as including a flag in another bit segment (e.g., in Dword 14 or 15) of the command.

In one embodiment, the value of the opcode provided in opcode field 605 can be the same (e.g., 0x02) as used in opcode field 604, and a command is indicated as being a Type B read command 603 (e.g., a fast command 284) in another way based on a mode of operation of a controller or a non-volatile memory system. In this case, Type B indicator 607 is not required in read command 603 itself. For example, read command 603 is executed as a fast command 284 based on the current mode of operation.

In one embodiment, read command 603 can include a data pointer type field 609 (e.g., configured at a same bit segment as data pointer type field 608 in the Type A read command 602). In one embodiment, field 609 is configured in the same way as data pointer type field 608 to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0. In another embodiment, field 609 can carry a value that is reserved in a current standard of NVMe; and when the value is specified in the command 603, the memory sub-system 101 is to interpret the command 603 according to the field definitions for Type B. In a further embodiment, the Data pointer type field 609 is not defined in a “Type B” read command 603.

In one embodiment, read command 603 uses a buffer identifier as an address for data transfer. When a host system desires to use the buffer identifier, the host system writes a value of 0x0 in command Dwords 6-7 when generating read command 603. This is an illegal system address, so the SSD knows that the address in command Dwords 6-7 is implicitly not valid. As a result, the SSD knows to use the identifier of the buffer specified in command Dwords 8-9. The SSD executes the command by using the address that has been loaded in a table at the address identified by the identifier. In one example, the value of the opcode provided in opcode field 605 can be the same (e.g., 0x02) as used in opcode field 604, and a command is indicated as being a Type B read command 603 based on the data pointer type being indicated as a buffer identifier.

In one embodiment, the data pointer type 609 in the read command 603 can have a value to indicate the use of a buffer identifier as in the field of “data pointer” 617 as discussed above; and the read command 603 can further support the use of other values associated with PRP (Physical Region Page) or SGL (Scatter Gather Lists) as currently defined for Type A read command 602 according to a current standard of NVMe. In this way, read command 603 can use a PRP or SGL option similarly as is available for read command 602. Data pointer type 609 is configured in the same bit segments as data pointer type 608. Alternatively, the PRP option and/or SGL option can be disabled for the Type B read command 603 to simplify and/or eliminate the data pointer type field 609. When a field of Type A read command 602 is “eliminated” from Type B read command 603, the bit segment used for the field in Type A read command 602 is not used in Type B read command 603 (e.g., having no defined meaning for Type B read command 603) or repurposed to be used for a new field not found in the Type A read command 602.

Command identifier field 611 is used for identifying commands in a queue. Command identifier field 611 is configured in command Dword 0 in the same way as command identifier field 610 of Type A read command 602. Configuring the command identifier field 611 as currently specified in the NVMe standard for Type A read command 602 can support NVMe compatibility.

Namespace identifier field 613 specifies the namespace that read command 603 applies to. Namespace identifier field 613 is configured in the same way as namespace identifier field 612 to support NVMe compatibility.

Metadata pointer field 615 is configured to carry a memory address of metadata. In one embodiment, if data pointer type field 609 is configured in the same way as data pointer type field 608, the memory address is provided in metadata pointer field 615 in a way according to the option specified in the data pointer type field 609 for the execution of the read command 603. If data pointer type field 609 is not configured in the same way as data pointer type field 608, metadata pointer field 615 can be configured in bytes 23:16 of command Dwords 4-5 as currently specified in the NVMe standard for Type A read command 602 to support NVMe compatibility in some cases.

Data pointer field 617 specifies the location of data used to store the result of executing the read command 603. Data pointer field 617 can be configured to provide a pointer to the location in the form of a memory address or a buffer identifier that has a predefined memory address.

In one embodiment, data pointer field 617 provides a memory address as a data pointer value. This value is carried in command Dwords 6-7. In one example, the memory address is a host system physical address. In one example, the address is a virtual machine physical address.

The memory address is carried in command Dwords 6:7 as done for current NVMe commands Type A read command 602. Because the PRP and SGL options are not used by Type B read command 603, command Dwords 8-9 are unused. This approach provides backward compatibility with existing NVMe standards. Unlike Type A read command 602, only a single address is used in Type B read command 603.

In one embodiment, data pointer field 617 provides a buffer identifier in command Dwords 8-9. A host system indicates the use of the buffer identifier by writing an invalid memory address in command Dwords 6-7. For example, the host system generates read command 603 by writing 0x0 in Dwords 6-7. This is an illegal system address, so an SSD knows that the address is implicitly not valid and determines that the command is to be processed as a Type B read command 603. As a result, the SSD uses the identifier (ID) of the buffer specified in command Dwords 8-9 to determine the memory address for data transfer (e.g., using a buffer lookup table).

Starting LBA field 619 indicates the 64-bit address of the first logical block to be read as part of the read operation for read command 603. This field can be configured in bits 63:00 of command Dword 10-11 in the same way as for starting LBA field 618 to support compatibility with the NVMe standard.

Data length field 621 specifies a data length (e.g., the size of the data to be read from the storage space or written to the storage space). Read command 603 defines the data length as a number of consecutive units of data to be read. In one example, the unit of data can be a byte, word, double word, or cacheline (e.g., 128 bytes).

In one example, the data length can extend over multiple logical blocks. Also, the range of data represented by the data length is not necessarily aligned with a logical block boundary; and a data offset from the logical block boundary corresponding to a starting LBA address specified in starting LBA field 619.

In one embodiment, read command 603 includes a unit field (not shown) predefined at a bit segment in read command 603; and a value specified in the unit field identifies the unit size. In some implementations, the size of the unit is computed from the value (e.g., as 2 to the power of the value).

Data offset field 623 specifies where the data transfer begins inside the first LBA to read or write. The first LBA is identified by the value in starting LBA field 619.

To implement this in one example, Dword 13 of Type A read command 602 can be repurposed. In one embodiment, all parameter fields configured in Dword 13 of Type A read command 602 are either removed or reconfigured as pre-set parameters to provide via namespace attributes so that Dword 13 of Type B read command 603 is available for carrying the data offset. For example, a request to read 128 bytes, starting from byte 1024 of LBA 0x1234 can be expressed by using Dword 10-11 for LBA (0x1234), Dword 12 for length (128 bytes), and Dword 13 for offset (1024). Optionally, the data offset field 623 can be configured in other locations of read command 603 that are not used to carry other parameters.

In one embodiment, one or more fields included in read command 602 are not used in read command 603. Instead, default values can be pre-selected for each of these fields to reduce or eliminate the need for real-time processing of these parameters as each command is retrieved. For example, some parameters can be associated to a namespace and stored by a controller as namespace attributes. In this way, default values stored as namespace attributes can be applied to each read command 603 that identifies the namespace.

In other cases, some of these parameters can be implemented as a default configuration for read commands 603 regardless of any namespace identification in the command.

For example, control parameters field 624, data set management field 626, and end-to-end protection parameters field 628 are not included in read command 603. Instead, values for these parameters are stored as pre-set parameters prior to retrieving read command 603. These parameters are used by controller when executing read command 603. For example, the use of these pre-set parameters avoids using, or reduces usage of, firmware-based resources 290 when executing fast command 284.

In one embodiment, fused operation field 622 is not included in read command 603. In some cases, a default value can be implemented to use fused operation with Type B read command 603. In some cases, the default value can be implemented as a namespace attribute.

FIG. 7 shows two types (Type A and Type B) of write commands according to one embodiment. For example, the write commands can be retrieved by a controller 115 of a memory sub-system 101 from a submission queue 270 for execution within the memory sub-system 101.

Type A write command 702 carries various parameters in compliance with a current NVMe standard. The parameters define the scope, requirements, resources, etc. of operations to be performed during execution of the command. This command execution includes firmware processing for at least some of the parameters. In one example, write command 702 is a normal command 282.

Type B write command 703 carries various parameters used in command processing by the non-volatile memory sub-system. In some cases, the processing of these commands does not require, or reduces the extent of, firmware processing (e.g., due to elimination of fields used in Type A write command 702). In other cases, the processing of one or more parameters of these commands may use firmware processing. The number of parameters and/or options defined by write command 703 are reduced relative to the number of parameters and/or options defined in write command 702 (e.g., write command 703 does not include dataset management field 726 or end-to-end protection parameters field 728). In some cases, certain parameters and/or options are not included in write command 703 to provide accelerated processing. In one example, write command 703 is a fast command 284.

In one example, write command 702 and write command 703 can be configured, with embedding appropriate parameters in various fields of the commands 702 and 703, to cause a controller 115 of the memory sub-system 101 to perform an identical operation of reading a block of data from a same memory location in the memory 264 of the host system 102 and writing the block of data to non-volatile memory implementing the storage space 261. Although the backend operation is the same in each case, write command 703 has fewer fields than write command 702, or write command 703 skips one or more fields that are processed for write command 702.

Various parameters of Type A write command 702 are now described below. These parameters are indicated by values provided in various defined fields of write command 702. Various parameters of Type B write command 703 are also described below to illustrate similarities and differences of the fields configured to carry the parameters as compared to Type A write command 702. These parameters are indicated by values provided in various defined fields of write command 703.

Opcode field 704 of Type A write command 702 specifies the opcode of the command to be executed. For example, an opcode value of 0x01 can be used in the opcode field to identify the command as a write command according to the NVMe standard. The opcode value is configured in bits 07:00 of command Dword 0.

For example, an opcode in opcode field 704 has 8 bits. Bits 7:2 indicate Function, and bits 1:0 indicate Data Transfer. For example, a value of 01b for bits 1:0 indicates a data transfer for a write. The Function portion of the opcode for write is 0. Thus, the combined opcode (the entire opcode value) is 01h in hexadecimal.

Opcode field 705 of Type B write command 703 also specifies the opcode of the command to be executed. The opcode value can be configured in bits 07:00 of command Dword 0 (same location as for write command 702) for compatibility with the NVMe standard, or can be configured in another bit segment or location of the command. For example, the value of the opcode can indicate that the command is a fast command 284.

In one embodiment, a new opcode is defined for Type B write command 703. For example, the opcode can be a vendor specific opcode for I/O commands (in the range of 80h to FFh). For example, a value of 0x81 can be used to provide a fast vendor specific write command that is in compliance with the NVMe standard for vendor specific extensions.

Optionally, write command 703 is configured to further include a Type B indicator 707 configured to indicate to the controller whether the command 703 containing the Type B indicator 707 is to be processed to have the fields as defined for Type B write command 703. For example, Type B indicator 707 can be a single-bit field configured in a bit segment that is reserved in a write command according to a current NVMe standard. When a first value (e.g., “1”), is specified in Type B indicator 707, the controller 115 of the memory sub-system 101 can recognize the command 203 as a “Type B” write command having the fields as configured in a way different from the “Type A” write command 702, even when the same opcode “0x01” is used in the command 703. When a “Type B indicator 707” is used to differentiate a “Type A” write command 702 and a “Type B” write command 703, the use of the “Type A” command 702 is to be modified to also include the field of “Type B indicator 707” at the same single-bit field that is reserved in a current NVMe standard; and when a second value (e.g., “0”) is specified in the field, the memory sub-system 101 can recognize that the command is a “Type A” command 702 having fields as defined differently from the “Type B command 703”.

Alternatively, whether a write command is a “Type A” write command 702 or a “Type B” write command 703 is based on the use of different opcodes in the opcode fields. In one embodiment, Type B indicator 707 is configured to indicate that the command 703 containing it is a “Type B command 703” based on a specific value provided in a field that is also defined in the “Type A command 702” where the meaning of the specific value in the field is reserved according to a current NVMe standard so that the controller interprets the presence of the specific value in the field is an indication that the retrieved command 703 is to be interpreted in a way as illustrated for the Type B write command 703, different from the field definitions of Type A write command 702.

In some implementations, a memory sub-system 101 is configured to support the “Type B” write command 703 without supporting the Type A write command 702 that is in compliance with a current NVMe standard. In such implementations, it can be unnecessary to have a “Type B indicator 707”, and the same opcode 0x01 currently used for “Type A” write command 702 can be reused as the opcode for “Type B” write command 703.

In one embodiment, the value of the opcode provided in opcode field 705 can be the same (e.g., 0x01) as used in opcode field 704, and a command is indicated as being a Type B write command 703 (e.g., a fast command 284) in another way such as including a flag in another bit segment (e.g., in Dword 14 or 15) of the command.

In one embodiment, the value of the opcode provided in opcode field 705 can be the same (e.g., 0x01) as used in opcode field 704, and a command is indicated as being a Type B write command 703 (e.g., a fast command 284) in another way based on a mode of operation of a controller or a non-volatile memory system. In this case, Type B indicator 707 is not required in write command 703 itself. For example, write command 703 is executed as a fast command 284 based on the current mode of operation.

Data pointer type field 708 of write command 702 is configured to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0. If the PSDT option is set to 01b or 10b (indicates use of SGL), a controller can use Scatter-Gather Lists (SGL) in two ways similarly as discussed above for read command 602.

In one embodiment, write command 703 can include a data pointer type field 709 (e.g., configured at a same bit segment as data pointer type field 708 in the Type A write command 702). In one embodiment, field 709 is configured in the same way as data pointer type field 708 to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0. In another embodiment, field 709 can carry a value that is reserved in a current standard of NVMe; and when the value is specified in the command 703, the memory sub-system 101 is to interpret the command 703 according to the field definitions for Type B. In a further embodiment, the Data pointer type field 709 is not defined in a “Type B” write command 703.

In one embodiment, write command 703 uses a buffer identifier as an address for data transfer. When a host system desires to use the buffer identifier, the host system writes a value of 0x0 in command Dwords 6-7 when generating write command 703. This is an illegal system address, so the SSD knows that the address in command Dwords 6-7 is implicitly not valid. As a result, the SSD knows to use the identifier of the buffer specified in command Dwords 8-9. The SSD executes the command by using the address that has been loaded in a table at the address identified by the identifier. In one example, the value of the opcode provided in opcode field 705 can be the same (e.g., 0x01) as used in opcode field 704, and a command is indicated as being a Type B write command 703 based on the data pointer type being indicated as a buffer identifier.

In one embodiment, the data pointer type field 709 in the write command 703 can have a value to indicate the use of a buffer identifier as in the field of “data pointer” 717 as discussed above; and the write command 703 can further support the use of other values associated with PRP (Physical Region Page) or SGL (Scatter Gather Lists) as currently defined for Type A write command 702 according to a current standard of NVMe. In this way, write command 703 can use a PRP or SGL option similarly as is available for write command 702. Data pointer type 709 is configured in the same bit segments as data pointer type 708.

Alternatively, the PRP option and/or SGL option can be disabled for the Type B write command 703 to simplify and/or eliminate the data pointer type field 709. When a field of Type A write command 702 is “eliminated” from Type B write command 703, the bit segment used for the field in Type A write command 702 is not used in Type B write command 703 (e.g., having no defined meaning for Type B write command 703) or repurposed to be used for a new field not found in the Type A write command 702.

Command identifier field 710 specifies a unique identifier for the write command 702 when combined with the submission queue identifier. This field is configured in bits 31:16 of command Dword 0.

Command identifier field 711 of write command 703 is used for identifying commands in a queue. Command identifier field 711 is configured in command Dword 0 in the same way as command identifier field 710 of Type A write command 702. Configuring the command identifier field 711 as currently specified in the NVMe standard for Type A write command 702 can support NVMe compatibility.

Namespace identifier field 712 specifies the namespace that write command 702 applies to. This field is configured in bytes 07:04 of command Dword 1.

Namespace identifier field 713 specifies the namespace that write command 703 applies to. Namespace identifier field 713 is configured in the same way as namespace identifier field 712 to support NVMe compatibility.

Metadata pointer field 714 is configured to carry a memory address of metadata provided in a way according to the option specified in the data pointer type field for the execution of the write command 702. This field is configured in bytes 23:16 of command Dword 4-5.

Metadata pointer field 715 is configured to carry a memory address of metadata. In one embodiment, if data pointer type field 709 is configured in the same way as data pointer type field 708, the memory address is provided in metadata pointer field 715 in a way according to the option specified in the data pointer type field 709 for the execution of the write command 703. If data pointer type field 709 is not configured in the same way as data pointer type field 708, metadata pointer field 715 can be configured in bytes 23:16 of command Dwords 4-5 as currently specified in the NVMe standard for Type A write command 702 to support NVMe compatibility in some cases.

Data pointer field 716 specifies the data used in the write command 702. This field is configured in bytes 39:24 of command Dword 6-9.

Data pointer field 717 specifies the location of data to be written (e.g., location of a data buffer in memory 264 where data is transferred from) when executing the write command 703. Data pointer field 717 can be configured to provide a pointer to the location in the form of a memory address or a buffer identifier that has a predefined memory address.

In one embodiment, data pointer field 717 provides a memory address as a data pointer value. This value is carried in command Dwords 6-7. In one example, the memory address is a host system physical address. In one example, the address is a virtual machine physical address.

The memory address is carried in command Dwords 6:7 as done for current NVMe commands Type A write command 702. Because the PRP and SGL options are not used by Type B write command 703, command Dwords 8-9 are unused. This approach provides backward compatibility with existing NVMe standards. Unlike Type A write command 702, only a single address is used in Type B write command 703.

In one embodiment, data pointer field 717 provides a buffer identifier in command Dwords 8-9. A host system indicates the use of the buffer identifier by writing an invalid memory address in command Dwords 6-7. For example, the host system generates write command 703 by writing 0x0 in Dwords 6-7. This is an illegal system address, so an SSD knows that the address is implicitly not valid and determines that the command is to be processed as a Type B write command 703. As a result, the SSD uses the identifier (ID) of the buffer specified in command Dwords 8-9 to determine the memory address for data transfer (e.g., using a buffer lookup table).

Starting LBA field 718 indicates the 64-bit address of the first logical block to be written as part of the write operation for write command 702. This field is configured in bits 63:00 of command Dword 10-11.

Starting LBA field 719 indicates the 64-bit address of the first logical block to be written as part of the write operation for write command 703. This field can be configured in bits 63:00 of command Dwords 10-11 in the same way as for starting LBA field 718 to support compatibility with the NVMe standard.

Number of logical blocks field 720 indicates the number of logical blocks to be written when executing write command 702. This field is configured in bits 15:00 of command Dword 12.

Data length field 721 specifies a data length (e.g., the size of the data to be written to the storage space). Write command 703 defines the data length as a number of consecutive units of data to be written. In one example, the unit of data can be a byte, word, double word, or cacheline (e.g., 128 bytes).

In one example, the data length can extend over multiple logical blocks. Also, the range of data represented by the data length is not necessarily aligned with a logical block boundary; and a data offset from the logical block boundary corresponding to a starting LBA address specified in starting LBA field 719.

In one embodiment, write command 703 includes a unit field (not shown) predefined at a bit segment in write command 703; and a value specified in the unit field identifies the unit size. In some implementations, the size of the unit is computed from the value (e.g., as 2 to the power of the value).

Data offset field 723 specifies where the data transfer begins inside the first LBA to read or write. The first LBA is identified by the value in starting LBA field 719.

To implement this in one example, Dword 13 of Type A write command 702 can be repurposed. In one embodiment, all parameter fields configured in Dword 13 of Type A write command 702 are either removed or reconfigured as pre-set parameters to provide via namespace attributes so that Dword 13 of Type B write command 703 is available for carrying the data offset. For example, a request to write 128 bytes, starting from byte 1024 of LBA 0x1234 can be expressed by using Dword 10-11 for LBA (0x1234), Dword 12 for length (128 bytes), and Dword 13 for offset (1024). Optionally, the data offset field 723 can be configured in other locations of write command 703 that are not used to carry other parameters.

Fused operation field 722 specifies whether write command 702 is part of a fused operation and if so, which command it is in the sequence. This field is configured in bits 09:08 of command Dword 0.

In one embodiment, fused operation field 722 is not included in write command 703. For example, the bits 09:08 of command Dword 0 used to implement the fused operation field 722 in the write command 702 can be reserved, not used, or repurposed to host a different field for another parameter for write command 703. The write command 703 can be executed with the pre-defined default value of no fused operation, regardless of what is specified in the bits 09:08 of command Dword 0 of write command 703.

Control parameters field 724 corresponds to the parameters for “Limited Retry (LR)”, “Force Unit Access (FUA)”, “Protection Information Field (PRINFO)”, “Storage Tag Check (STC)”, “Directive Type (DTYPE)”, and “Directive Specific (DSPEC)” defined in command Dwords 12-13 for a write command in a current NVMe standard.

“Limited Retry (LR)” indicates whether the controller should apply limited retry efforts when executing the command and is configured in bit 31.

“Force Unit Access (FUA)” is a flag configured in bit 30. If the flag is set to 1, then data and metadata associated with logical blocks specified by write command 702 is written to non-volatile media before indicating command completion.

“Protection Information Field (PRINFO)” is configured in bits 29:26 and specifies the protection information action and check field. “Storage Tag Check (STC)” is configured in bit 24 and specifies the Storage Tag field is to be checked as part of end-to-end data protection processing.

“Directive Type (DTYPE)” is configured in bits 23:20 and specifies the Directive Type associated with the Directive Specific field of command Dword 13. “Directive Specific (DSPEC)” is configured in bits 31:16 of command Dword 13 and specifies the Directive Specific value associated with the Directive Type field of command Dword 12.

Dataset management field 726 indicates attributes for the LBA addresses being written when executing write command 702. The dataset management field 726 is configured in bits 07:00 of command Dword 13. For example, bit 6 “Sequential Request” can be set to inform the controller that this write is part of a sequential write that includes multiple write commands. Other attributes include indications for access frequency and latency tolerance for the LBA range being written. These attributes can provide guidance to the controller for configuring how it writes data.

End-to-end protection parameters field 728 corresponds to the parameters defined in Dwords 2, 3, 14, and 15. Bits 47:00 of command Dwords 2-3 and bits 31:00 of command Dword 14 specify the variable sized Logical Block Storage Tag (LBST) and Initial Logical Block Reference Tag (ILBRT) fields. If the namespace identified in the write command is not formatted to use end-to-end protection information, then these fields are ignored.

The Logical Block Application Tag Mask (LBATM) field is configured in bits 31:16 of command Dword 15. This field specifies the Application Tag Mask value. The Logical Block Application Tag (LBAT) field is configured in bits 15:00 of command Dword 15. This field specifies the Application Tag value. If the namespace identified in the write command is not formatted to use end-to-end protection information, then these fields are ignored.

In one example, NVMe supports an end-to-end data protection feature that can be used to guard against data corruption between the host and the storage space 261 (e.g., NAND flash) of SSD 260 as discussed above. The write command's PRINFO and STC fields (configured in command Dword 12) allow the host to specify what integrity checks to perform. End-to-end protection, when enabled, can improve reliability by detecting corruption that might occur in the write path.

In one embodiment, one or more of the Control parameters field 724 (e.g., LR, FUA, PRINFO, STC, DTYPE, and DSPEC), Dataset management field 726, and End-to-end protection parameters field 728 included in write command 702 are omitted and thus not included or used in write command 703. The corresponding bits of the Type B write command 703, which host such omitted fields of Type A write command 702 can be reserved, not used, or repurposed to host a different field for another parameter (e.g., Data offset field 723) of the Type B write command 703. Instead, default values can be pre-selected for each of these fields to reduce or eliminate the need for real-time processing of these parameters as each command is retrieved. For example, some parameters can be associated to a namespace and stored by a controller as namespace attributes. In this way, default values stored as namespace attributes can be applied to each write command 703 that identifies the namespace using the Namespace identifier field 713.

In other cases, some of these parameters can be implemented as a default configuration for write commands 703 regardless of any namespace identification and the command.

For example, control parameters field 724, data set management field 726, and end-to-end protection parameters field 728 are not included in write command 703. Instead, values for these parameters are stored as pre-set parameters prior to retrieving write command 703. These parameters are used by controller when executing write command 703. For example, the use of these pre-set parameters avoids using, or reduces usage of, firmware-based resources 290 when executing fast command 284.

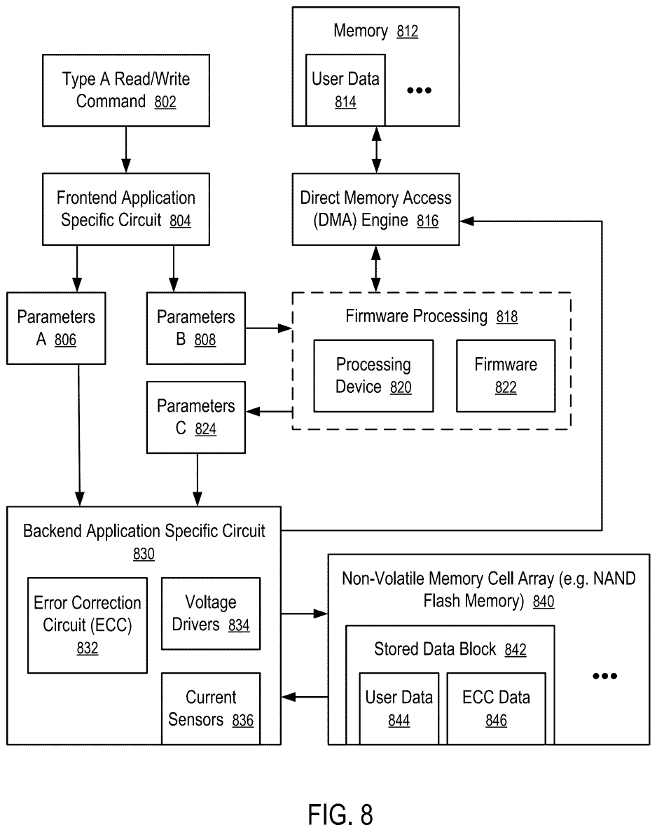

FIG. 8 shows a processing path for Type A read or write commands 802 according to one embodiment. For example, the commands can be Type A read command 602 and Type A write command 702. For example, the read or write commands can be retrieved from submission queue 270 by controller 294. In one example, the read or write commands are normal commands 282.

Various parameters of each retrieved command 802 are extracted and/or processed by frontend application specific circuit 804.

In one example, frontend application specific circuit 804 is configured in hardware circuitry 292 of solid-state drive 260. Circuit 804 parses values of the parameters and performs various processing depending on the specific parameter. In one example, the parameters are defined in accordance with a current version of the NVMe standard. Results from the processing are provided as Parameters A 806 and Parameters B 808.

Parameters B 808 are further processed using firmware processing 818. This processing includes execution of firmware 822 by processing device 820. In one example, processing is performed to evaluate parameters in accordance with a current version of the NVMe standard. Results from the firmware processing 818 are provided as Parameters C 824. In one example, firmware processing 818 uses firmware-based resources 290.

In some cases, the processing of some parameters can cause the firmware processing 818 to perform operations to access memory 812, e.g., using a direct memory access (DMA) engine 816, to fetch further data (e.g., metadata, SGL entries, PRP entries) from memory 812 according to pointers or addresses provided in the command 802.

Parameters A 806 and Parameters C 824 are provided as inputs to backend application specific circuit 830. In one example, backend application-specific circuit 830 is configured as a local controller on a NAND flash memory chip. Backend application-specific circuit 830 accesses non-volatile memory cell array 840 in response to receiving, and as defined by, Parameters A 806 and Parameters C 824.

For example, when a solid-state drive executes a read command 802, backend application-specific circuit 830 reads at least a portion of user data 844 and corresponding ECC data 846 from stored data block 842. Error correction circuit 832 is used to correct any errors found in the read data. Memory cells of stored data block 842 are accessed by applying voltages to access lines (not shown) of memory cell array 840 using voltage drivers 834. Current sensors 836 are used to sense voltages or currents on at least a portion of the access lines to determine values (e.g., logic 1 or 0) of the stored data.

For example, when a solid-state drive executes a write command 802, backend application-specific circuit 830 programs memory cells of memory cell array 840 to store user data 814 transferred from memory 812 (e.g., DRAM) of a host system. Error correction circuit 832 generates ECC data 846 for the user data 844 to be written. Voltage drivers 834 apply voltages to access lines (not shown) of memory cell array 840 to program memory cells of stored data block 842. The memory cells are programmed so that states of the memory cells correspond to the user data 844 and ECC data 846 to be stored as part of executing write command 802.

In response to a read command 802, backend application-specific circuit 830 reads user data 844 using operations defined by Parameters A 806 and Parameters C 824. For example, these parameters identify an LBA address of a logical block from which data is to be read. A flash translation layer converts the LBA address into a physical address in non-volatile memory cell array 840. The corrected user data 844 is transferred to memory 812 using direct memory access engine (DMA) 816. For example, user data 814 is transferred to a memory address of memory 812 provided by data pointer field 616 of a read command 602.

In response to a write command 802, backend application-specific circuit 830 writes user data 844 using operations defined by Parameters A 806 and Parameters C 824. For example, these parameters identify an LBA address of a logical block in which data is to be written. A flash translation layer converts LBA address into a physical address in non-volatile memory cell array 840. The user data 844 to be written is transferred from memory 812 using direct memory access engine (DMA) 816. For example, user data 814 is transferred from a memory address of memory 812 provided by data pointer field 716 of a write command 702.

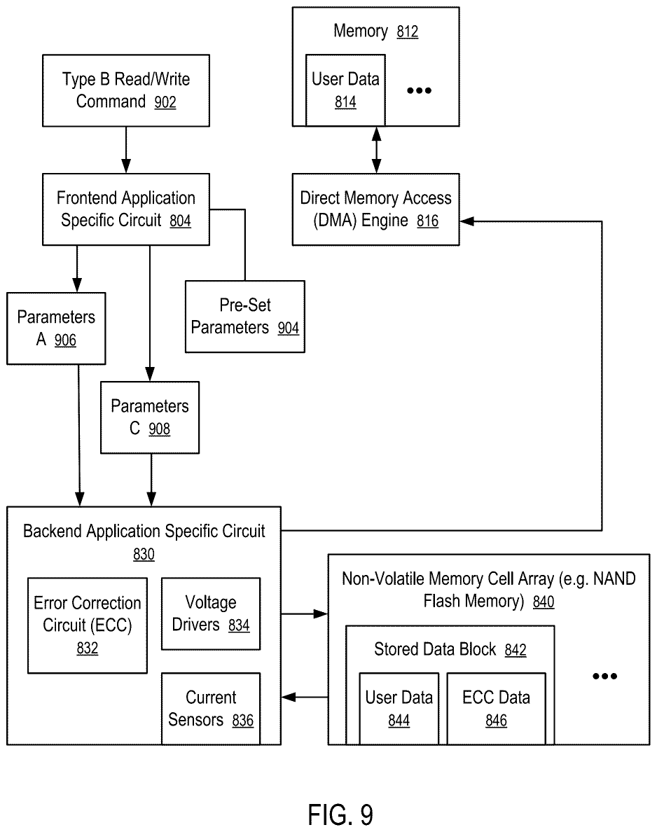

FIG. 9 shows a processing path for Type B read or write commands 902 according to one embodiment. For example, the commands can be Type B read command 603 and Type B write command 703. For example, the read or write commands can be retrieved from submission queue 270 by controller 294. In one example, the read or write commands are fast commands 284.

Various parameters of each retrieved read/write command 902 are extracted and/or processed by frontend application specific circuit 804 in view of pre-set parameters 904. In one example, frontend application specific circuit 804 is configured in hardware circuitry 292 of solid-state drive 260. The use of the pre-set parameters 904 allows the skipping of the firmware processing 818 that is to be performed in FIG. 8 during the execution of the Type A read/write command 802. Frontend application specific circuit 804 can generate Parameters A 906 and Parameters C 908 with the firmware processing 818 of FIG. 8.

Parameters C 908 are generated in part based on pre-set parameters 904. Pre-set parameters 904 are stored from prior processing of one or more retrieved commands. For example, pre-set parameters 904 are results stored from prior firmware processing 818 of parameters in prior commands.

This prior processing may be performed during execution of a prior read/write command (e.g., 602 or 702 modified to include a flag to save its parameters as default values for future processing of Type B read/write commands 603 and 703). In one example, the prior processing generates these results (that are stored as pre-set parameters 904) using one or more parameters carried by read command 602 or write command 702 in control parameters field 724, dataset management field 726, and/or end-to-end protection parameters field 728. In some examples, pre-set parameters 904 includes one or more of these parameters previously stored as namespace attributes (e.g., during the execution of a command to set or change one or more attributes of a namespace) prior to retrieving read/write command 902. The namespace attributes can be selected by a controller according to the namespace identifier field 713 of a write command 703 or namespace identifier field 613 of a read command 603.

Backend application-specific circuit 830 receives Parameters A 906 and Parameters C 908 as inputs. In response, backend application-specific circuit 830 accesses stored data block 842 similarly as discussed above.

In one example, backend application-specific circuit 830 performs the same operations in accessing non-volatile memory cell array 840 for each of a retrieved read/write command 802 and a retrieved read/write command 902. However, processing of command 902 uses pre-set parameters 904 and is accelerated relative to processing of command 802, which uses firmware processing 818. Command 902 can be processed in an accelerated way because one or more fields used in command 802 have been eliminated from command 902. In one example, the pre-set parameters 904 are generated from firmware processing 818 of certain parameters carried by command 802 and are stored as namespace attributes. Command 902 includes a namespace identifier used by a controller to select pre-set parameters 904. Each namespace can be associated with different pre-set parameters 904.

In one example, backend application-specific circuit 830 performs the operation of reading an entire logical block from an LBA address in stored data block 842. The LBA address is converted to a physical address by a flash translation layer (not shown). The reading of the logical block by backend application-specific circuit 830 is performed in the same way for both Type A read command 802 and Type B read command 902.

In one embodiment, both Type A and Type B read/write commands 802, 902 use a compatible data layout for data stored in a stored data block 842. For example, user data 844 and ECC data 846 written to block 842 with a Type A write command 802 can be read from block 842 using a Type B read command 902. User data 844 and ECC data 846 written to block 842 with a Type B write command 902 can be read from the block 842 using a Type A read command 802.

In one embodiment, at least some of the pre-set parameters 904 are default options used for processing read/write command 902. The default options are applied without regard to a particular namespace identified by the command.

In one embodiment, at least some of pre-set parameters 904 are generated using firmware processing 818 during the execution of one or more commands before the execution of the Type B read/write command 902. When executing read/write command 902, the pre-set parameters 904 can be used as needed during the execution of the command 902. This avoids needing to perform the firmware processing 818 in real-time when executing command 902.

Various embodiments related to commands used to identify values of parameters shared by a set of commands for fast processing are now discussed below. A command can be used by a host system to specify/configure predefined/fixed values that would be provided in fields of normal commands on a per-command basis. The values specified/configured via the command can be shared across multiple read/write commands when a memory sub-system is in a fast mode and/or executing fast commands (e.g., 284). Optionally, a normal command 282 is extended to perform a read or write operation but also specify such predefined values for fields that are shared across multiple subsequent fast commands 284 that are queued after the normal command 282.

For example, such a command to provide the predefined/fixed values can include a namespace identifier in Command Dword 2-3 and the host selected options about limited retry in Command Dword 12 in a normal read/write command, etc. For example, some parameters associated with usage of a namespace (e.g., “Storage Tag Check”, “Protection Information”, and/or metadata type that are used with a namespace) are not needed to be repeated on every command that identifies this same namespace in its namespace identifier field. When such parameters are predefined, the memory sub-system can be configured for faster operations (e.g., via processing using hardware and/or skipping of the operations for parameter parsing/processing) and the parameters can be shared by a set of commands that read/write data in the same namespace.

For example, a read or write command (e.g., normal read/write command 282 or a set command) can be configured with a field to instruct the memory sub-system to take the parameters provided in the command as the predefined/fixed values when subsequent commands queued after such a read or write command are processed in the fast mode (e.g., when any fast command 284 is processed). Alternatively, an additional command can be defined (e.g., with an opcode different from the opcodes for read or write operations) to instruct the memory sub-system to store the values provided in the command and to apply to the values to the execution of fast commands, or commands executed in the fast mode. Alternatively, or in combination, a namespace creation command can be augmented to specify such predefined/fixed values.

For example, read/write commands in accordance with the NVMe standard allows a host to send metadata information that can be chosen using numerous different options. This can cause unnecessary processing of each command. This unnecessary processing can be reduced or avoided by defining values of certain parameters as attributes of the namespace. For example, the metadata information can be defined as pre-set parameters of a namespace. A command that identifies the namespace in its namespace identifier field will be processed using the pre-set parameters.

For example, when a namespace is created, the pre-set parameters can be defined and associated with a namespace identifier. Subsequently, all IOs for that namespace that are performed using a Type B read command 603 or Type B write command 703 will be processed using the pre-set parameters. The “Namespace Management Command” according to the NVMe standard can be used to create/delete a namespace (depending on the “select” option specified in the command). The opcode for “Namespace Management Command” is “0Dh”.

There are various other ways to set parameters as namespace attributes. For example, a new set-namespace-attribute command can be defined and used to change attributes of a namespace. For example, a normal read/write command 282 can be extended to include a flag. The flag indicates to a memory sub-system that a predefined set of parameters are to be saved as pre-set parameters. For example, the flag can be configured in a bit of an NVMe command that is a reserved bit. In one example, the saved pre-set parameters include parameters determined using control parameters field 624, data set management field 626, and/or end-to-end protection parameters field 628.

Optionally, certain parameters used during execution of the most recent Type A read/write command are automatically stored as pre-set parameters. Such parameters are automatically used for processing subsequent Type B read/write commands without the need for any further indication to use such automatically stored parameters. These pre-set parameters are used until the next Type A read/write command is processed, at which time parameters used for this next command are used to update the automatically stored pre-set parameters.

In some cases, certain parameters are predetermined for Type B read/write commands. For example, Type B read/write commands do not use fused operation. Thus, parameters for fused operation are not changeable via a namespace attribute.

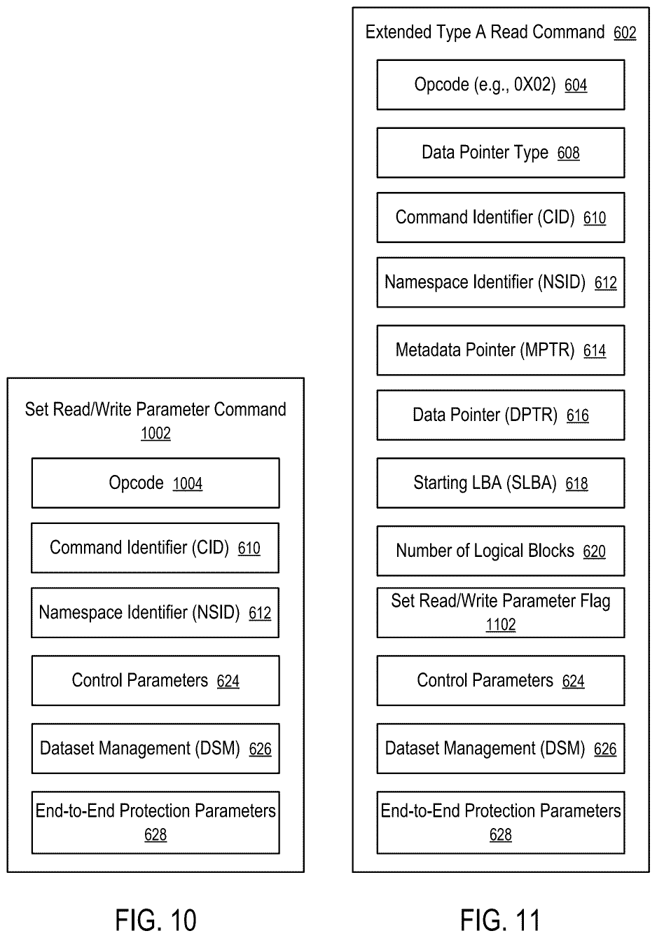

FIG. 10 shows a configuration of a set read/write parameter command 1002 used to set read/write parameters according to one embodiment. In one example, set command 1002 is used to set pre-set parameters 904.

Set command 1002 includes opcode field 1004 that specifies the opcode of the command to be executed. For example, an opcode value can be used in the opcode field to identify the command as a set command. The opcode value is configured in bits 07:00 of command Dword 0.

In one embodiment, a new opcode is defined for set command 1002. For example, the opcode can be a vendor specific opcode for I/O commands (in the range of 80h to FFh). For example, a value can be used to provide a vendor specific set command that is in compliance with the NVMe standard for vendor specific extensions.

Set command 1002 includes command identifier (CID) field 610 and namespace identifier (NSID) field 612. These are configured similarly as for Type A read/write commands. The pre-set parameters that are generated will be stored as namespace attributes for the namespace identified by the namespace identifier field 612.

The pre-set parameters can be based on any one or more values extracted from control parameters field 624, data set management field 626, and/or end-to-end protection parameters field 628. In one example, the values are extracted by front-end application-specific circuit 804. In one example, the values are generated by firmware processing 818.

Set command 1002 has a size of 64 bytes according to the NVMe standard for commands to fit into a slot in a submission queue for NVMe compatibility. For improved NVMe compatibility, the parameters of set command 1002 can be specified in the same location/bit segments as in NVMe read/write commands (e.g., Type A read/write commands). In other words, the fields that are missing/omitted from the normal read/write commands to generate fast commands are present in set command 1002 at the same locations so that the changes to processing this command from the normal read/write commands is minimized.

FIG. 11 shows an extended Type A read command 602 used to set read/write parameters according to one embodiment. Extended command 602 is similar to Type A read command 602 of FIG. 6 except that set read/write parameter flag field 1102 is added to and configured in extended read command 602. For example, flag field 1102 can be configured in a bit corresponding to a reserved bit of a read/write command according to a current version of NVMe standard.

The value of the parameter in flag field 1102 is used to indicate whether certain parameters are to be stored as pre-set parameters when processing the extended read command 602. For example, a value of one in flag field 1102 causes a memory sub-system to store pre-set parameters. A value of zero in flag field 1102 indicates that any pre-set parameters remain unchanged during processing of the extended read command 602.

When using set read/write parameter flag field 1102, is not necessary to use a new opcode field 1004 to cause storing of the pre-set parameters. Instead, opcode field 604 of extended command 602 can be in accordance with a current version of the NVMe standard.

In one embodiment, an extended Type A write command 702 (not shown) can be used to cause storing of pre-set parameters. Extended write command 702 is similar to Type A write command 702 of FIG. 7 except that set read/write parameter flag field 1102 is added to and configured in extended write command 702. For example, flag field 1102 can be configured in a reserved bit of the command.

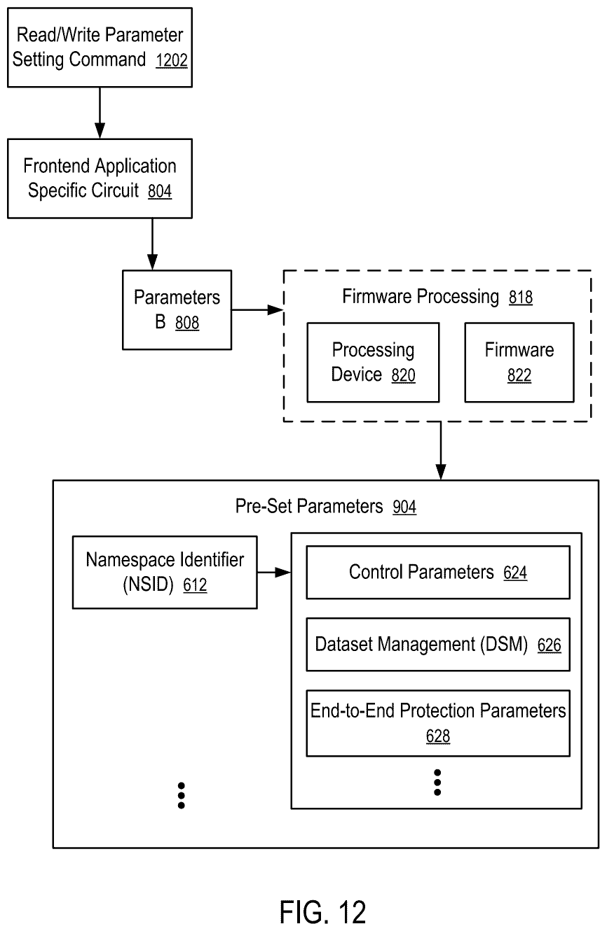

FIG. 12 shows a processing path for a read/write parameter setting command 1202 according to one embodiment. Setting command 1202 is a command that causes a memory sub-system to store pre-set parameters 904. In one example, set read/write parameter command 1002 causes solid-state drive 260 to store pre-set parameters 904. In one example, extended Type A read command 602 causes solid-state drive 260 to store pre-set parameters 904.

When read/write parameter setting command 1202 is retrieved, front-end application-specific circuit 804 extracts and/or generates Parameters B 808 from setting command 202. Parameters B 808 are provided as inputs to firmware processing 818. Outputs from firmware processing 818 are stored as pre-set parameters 904.

Pre-set parameters 904 are stored as attributes of a namespace that has previously been created on the memory sub-system. In the case of set command 1002 or extended read command 602, the namespace is identified by the namespace identifier field 612 included in read/write parameter setting command 1202. In the case of an extended write command 702, the namespace is identified by the namespace identifier field 712 (not shown) included in the extended write command 702. Pre-set parameters 904 can be stored for various namespaces as identified in different setting commands 1202 that may be retrieved. In one example, pre-set parameters 904 are stored in memory 280.

When receiving subsequent Type B read/write commands, the pre-set parameters 904 allow skipping of firmware processing 818. In one embodiment, at least some of the pre-set parameters 904 are default options used for processing Type B read/write command 902. The default options are applied without regard to a particular namespace identified by the command. In one embodiment, at least some of pre-set parameters 904 are generated using firmware processing 818 during the execution of one or more commands before the execution of the Type B read/write command 902. When executing read/write command 902, the pre-set parameters 904 can be used as needed during the execution of the command 902.

In one embodiment, no namespace attributes exist for a namespace identified by a Type B read/write command. In such case, the Type B read/write command is limited to use with namespaces that do not require end-to-end protection.

In one embodiment, a namespace can be configured to have a namespace attribute that causes processing in a fast mode. If a read/write command is configured to access such namespace, a memory sub-system automatically processes the command as a Type B read/write command. This avoids the need to introduce a read/write opcode that is incompatible with the NVMe standard.

In one example, control parameters field 624 corresponds to the parameters for “Limited Retry (LR)”, “Force Unit Access (FUA)”, “Protection Information Field (PRINFO)”, and “Storage Tag Check (STC)” defined in command Dword 12. “Protection Information Field (PRINFO)” is configured in bits 29:26 and specifies the protection information action and check field. “Storage Tag Check (STC)” is configured in bit 24 and specifies the Storage Tag field is to be checked as part of end-to-end data protection processing. Any one or more of the values for these control parameters can be used to generate pre-set parameters 904.

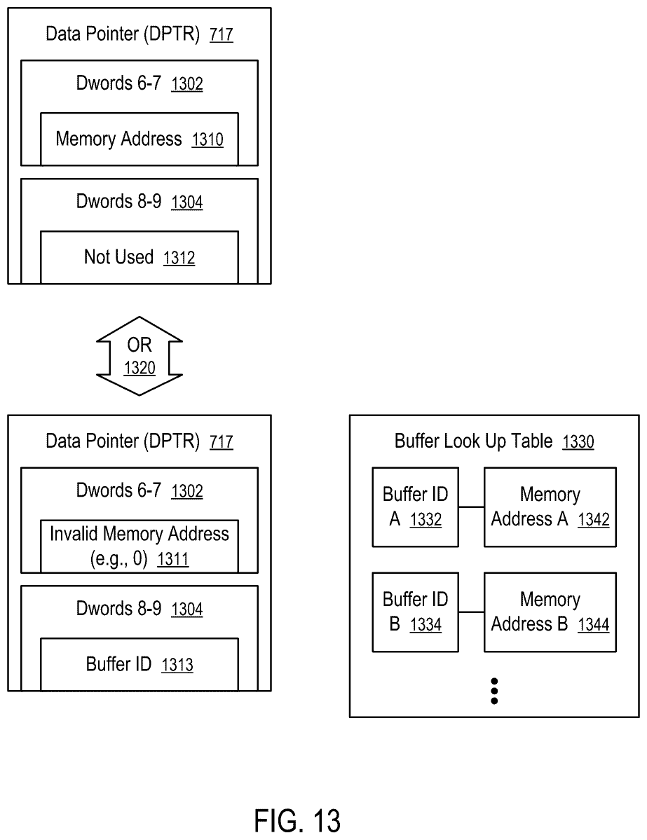

FIG. 13 shows alternative configurations for data pointer 717 according to one embodiment. Data pointer 717 is used in Type B write command 703. Content of data pointer 717 can be configured by a host system to specify either a memory address 1310 or (indicated as 1320 in FIG. 13) a buffer identifier (ID) 1313 for use in identifying the data to be transferred in executing a read or write command. Although only data pointer 717 is shown in FIG. 13, a data pointer 617 of Type B read command 603 can be configured and used to identify a location for data transfer similarly as described for data pointer 717.

In one example, a read/write command has a size of 512 bits (Dwords 0-15). Data pointer 717 is specified in Dwords 6-9 of the command. If a value provided in Dwords 6-7 1302 of the command is a valid memory address 1310, then a memory sub-system uses the value as a single memory address for data transfer. In this case, Dwords 8-9 1304 of the command are not used (1312) and any value provided is ignored.

If the value provided in Dwords 6-7 1302 of the command is an invalid memory address 1311, then the memory sub-system does not use the value as a memory address. For example, the invalid memory address can be 0x0. Instead of using the value as a memory address, the memory sub-system interprets the invalid value for memory address 1311 as indicating that a buffer identifier 1313 is provided in Dwords 8-9 1304 of the command for use in identifying the data to be transferred.

In alternative approaches, the data pointer 717 can be specified in a location of the command other than Dwords 6-9. Memory address 1310 is specified in a first portion of data pointer 717, and buffer identifier 1313 is specified in a second portion of data pointer 717. If a value provided in the first portion is valid, then the value is used as memory address 1310. If a value provided in the first portion is not a valid memory address, then the value is used as buffer identifier 1313.

Buffer identifier 1313 points to a memory address in buffer lookup table 1330. The memory address is used for the data transfer when executing the read/write command. For example, Buffer ID A 1332 points to Memory Address A 1342. Buffer ID B 1334 points to Memory Address B 1344. In one example, buffer lookup table 1330 is stored in memory 280 of solid-state drive 260.

In one example, a Type B write command having data pointer 717 is retrieved by solid-state drive 260. The data pointer 717 includes a valid memory address 1310. The memory address 1310 specifies a single physical memory address. In one example, memory address 1310 specifies a virtual machine physical address.

In one example, a Type B write command has a size of 512 bits and specifies data pointer 717 at Dwords 6-9. The command further includes a value specified at bits 15:14 in Dword 0 of the command. This location corresponds to a PDST value in an NVMe command according to a current version of NVMe. In an NVMe command, the PDST value specifies whether PRPs or SGLs are used for data transfer associated with the command. PRPs or SGLs are not used for the Type B write command. If the value specified at bits 15:14 in Dword 0 of the Type B command is 11b, then the value indicates that data pointer 717 is used to specify either a memory address 1310 or a buffer ID 1313, as described above. In contrast, in an NVMe command a value of 11b specified at bits 15:14 in Dword 0 is reserved.

In one example, a Type B write command having data pointer 717 is retrieved by solid-state drive 260. The SSD 260 determines that the data pointer 717 includes an invalid memory address 1311. In response to this determination, SSD 260 uses buffer ID 1313 to identify the location for data transfer. Buffer ID 1313 specifies one of many buffers with predefined memory addresses. The buffers are identified by the one of memory addresses 1342, 1344 in buffer lookup table 1330 that corresponds to buffer ID 1313. In one example, the buffers can be used to create large buffers (e.g., 64 KB or larger) of sequential memory addresses.

In one embodiment, a Type B write command 703 includes data pointer type field 709. Data pointer type field 709 has a predetermined value that indicates the use of a buffer identifier. In such case, the memory sub-system uses buffer identifier 1313 without regard for any value of memory address 1310, 1311. For example, even if data pointer 717 includes a valid memory address 1310, buffer identifier 1313 is used to identify the location for data transfer. In one example, Dwords 6-7 1302 are skipped or ignored if data pointer type field 709 indicates the use of a buffer identifier.

In one embodiment, a host system creates buffers and provides addresses of the buffers to a memory sub-system to configure the memory sub-system. In one example, the buffers are allocated with a predetermined size at boot time for the host system.

In one example, the addresses are preloaded in random access memory of the memory sub-system. In one example, the addresses are preloaded in buffer lookup table 1330. Each preloaded address corresponds to a buffer identified by a buffer identifier (e.g., 1332, 1334).

In one embodiment, memory addresses provided to the memory sub-system (e.g., in data pointer 717) can be virtualized (e.g., in the form of virtual memory addresses and thus require translation before being used for data transfer). When addresses for buffers are configured for storing in the look up table 1330, virtual-physical translation and any validity checks for the memory addresses can be done in advance of executing read/write commands. The results from such translation and validity checks can be stored in association with a buffer identifier 1332 in buffer lookup table 1330. When a read/write command specifying a buffer ID 1313 is being executed, the data transfer can be performed (e.g., by DMA engine 816) using the stored translation that has passed the validity checks.

Various embodiments related to configurations for read or write commands are now discussed below. In one example, the read or write commands are similar to Type B read or write commands 603, 703. In one example, the configurations can be used by fast commands 284. In some cases, the configurations can be indicated by use of a new opcode in a way similar to the use of opcodes 605, 705. In some cases, the configurations for the read or write commands can coexist with read or write commands 603, 703 (e.g., where different opcodes are used to indicate the use of different command formats) and be selectively used by a host system when generating new commands for entry into a submission queue.

In some embodiments, the commands have a reduced size as compared to a size of a command according to a current version of the NVMe standard (e.g., 64 bytes). In one example, the size of a command is 32 bytes. As such, two commands can fit into a 64-byte slot of the submission queue according to the NVMe standard. Thus, the number of commands retrieved by a controller from each slot of the submission queue can be doubled.

In some embodiments, the commands have a size of 64 bytes and a format is incompatible with a current version of the NVMe standard. In one example, each command is configured to specify multiple, non-contiguous data locations (e.g., via multiple sets of data offsets and data lengths) for the controller to read or write during executing the command. In one example, each command specifies a data pointer using only two Dwords of the command. In contrast, a command according to a current version of NVMe standard specifies the data pointer using four Dwords (Dwords 6-9). In one example, each read/write command specifies a parameter at a bit segment location that is different from the bit segment location for the parameter in a read/write command according to the current version of NVMe standard.

In one embodiment, results from processing parameters in prior commands are saved as pre-set parameters (e.g., 904) for use in processing subsequent read or write commands, as discussed in connection with FIGS. 10-12.

In one embodiment, a configuration for a read or write command (e.g., fast command 284) eliminates use of various fields defined by a current version of the NVMe standard (e.g., fused operation field 622, control parameters field 624, data set management field 626, and/or end-to-end protection parameters field 628). The configuration specifies parameters for the command using 8 Dwords. As a result, two commands can be generated and entered into a single slot of a submission queue, which supports compatibility with the submission model and infrastructure used for the NVMe standard. The two commands can be transferred using a single PCIe transaction layer packet. Packing two commands into a size of 16 Dwords reduces the overhead required for PCIe transfers.

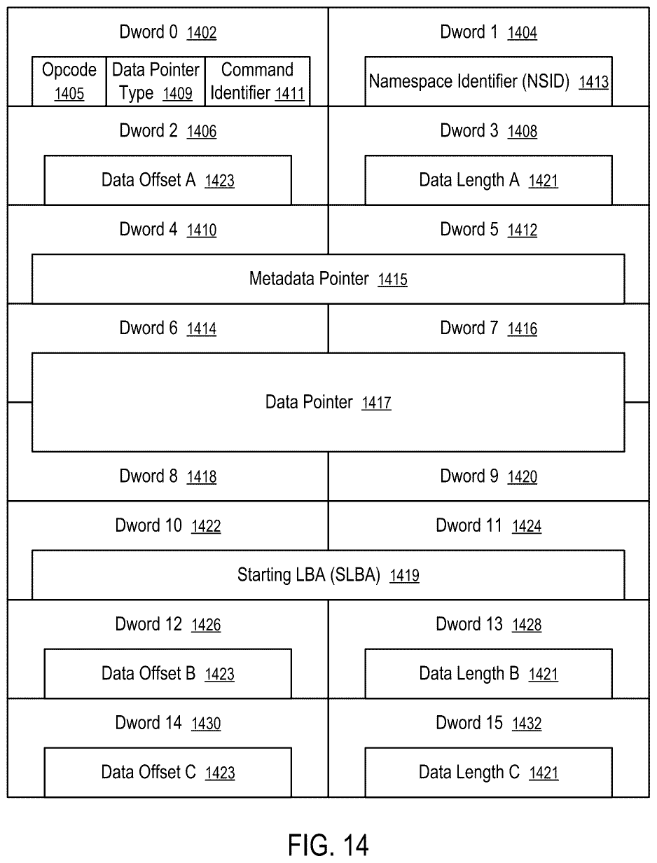

FIG. 14 shows a configuration or format of a read or write command that allows a host system to specify multiple data offsets and data lengths within the 64 bytes of the command according to one embodiment. The command has a size of 64 bytes; and various parameters are configured at pre-defined locations in Dwords 0-15 1402-1432 for use during the execution of the command.

Opcode 1405, data pointer type 1409, and command identifier 1411 are configured in Dword 0 1402. Opcode 1405 indicates the type of command to be executed. In one example, a pre-defined value can be specified in the command of FIG. 14 as the opcode 1405 to instruct a memory sub-system 101 to perform a read operation (or a write operation) and to interpret the content in the command in a way as specified in FIG. 14. Different pre-defined values are configured for using the command format of FIG. 14 to read and write respectively; and the opcode values can be different from the opcode values for Type A read or write command (e.g., 602 and 702), in a way similar to the configuring of the opcode values for a Type B read or write command (e.g., 603, 703) discussed above in connection with FIG. 6 and FIG. 7. In one example, opcode 1405 is specified by opcode field 605 or 705.

Data pointer type 1409 indicates a type of data pointer 1417 to be used in executing the command. In one example, data pointer type 1409 indicates whether data pointer 1417 is a memory address (e.g., 1310) or a buffer identifier (e.g., 1313), as in FIG. 13, or a type of data pointer as specified in a current version of NVMe standard. In one example, data pointer type 1409 can be a single bit. In one example, data pointer type 1409 is specified in a way as discussed above in connection with data pointer type field 609 or 709 in FIG. 6 and FIG. 7. In one example, data pointer type 1409 is eliminated; and the type of data pointer 1417 is indicated by whether an invalid memory address (e.g., 1311) is specified in Dwords 6-7 1414-1416 in a way as in FIG. 13.

Command identifier 1411 specifies a unique identifier for identifying the command when combined with the submission queue identifier. In one example, command identifier 1411 is specified in a way as discussed above in connection with by command identifier field 611 or 711 in FIG. 6 and FIG. 7.

Namespace identifier 1413 is configured in Dword 1 1404 and specifies the namespace that the command applies to. In one example, namespace identifier 1413 is specified in a way as discussed above in connection with namespace identifier field 613, 713 in FIG. 6 and FIG. 7.

Data offset A 1423 is configured in Dword 2 1406 and specifies where a data transfer begins inside the first LBA to read or write. Data length A 1421 is configured in Dword 3 1408 and specifies a number of consecutive units of data to be written. In one example, data offset A 1423 is specified by data offset field 623, 723. In one example, data length A 1421 is specified in a way as discussed above in connection with data length field 621, 721 in FIG. 6 and FIG. 7.

Metadata pointer 1415 is configured in Dwords 4-5 1410-1412 and specifies a memory address of metadata. In one example, metadata pointer 1415 is specified in a way as discussed above in connection with metadata pointer field 615, 715 in FIG. 6 and FIG. 7.

Data pointer 1417 is configured in Dwords 6-9 1414-1420 and specifies a location for data transfer when executing the command. In one example, data pointer 1417 is specified in a way as discussed above in connection with data pointer field 617, 717 in FIG. 6 and FIG. 7.

Starting LBA 1419 is configured in Dwords 10-11 1422-1424 and specifies the first LBA to read or write. In one example, starting LBA 1419 is specified in a way as discussed above in connection with starting LBA field 619, 719 in FIG. 6 and FIG. 7.

Additional pairs of data offsets and data lengths can be specified in the command in addition to data offset A 1423 and data length A 1421. The data offsets and data lengths specified by the command indicate segments of data to be transferred in executing the command. For example, data offset B 1423 is configured in Dword 12 1426, and corresponding data length B 1421 is configured in Dword 13 1428. For example, data offset C 1423 is configured in Dword 14 1430, and corresponding data length C 1421 is configured in Dword 15 1432.

In one embodiment, a host system determines that two or more commands share a same namespace identifier, metadata pointer (if used in the commands), data pointer, and starting LBA address. The host system combines the commands to generate a single command that includes multiple pairs of data offsets and data lengths corresponding to the data offset and data length in each of the commands that are combined. For a read operation, a memory sub-system concatenates the data read from the locations identified by the offset/length pairs and transfers the concatenated data to the location identified by the data pointer. For a write operation, the host system concatenates data of multiple sub blocks and writes the concatenated data to the location identified by the data pointer. The memory sub-system handles writing the data (e.g., using read-modify-write) based on the locations identified by the offset/length pairs.

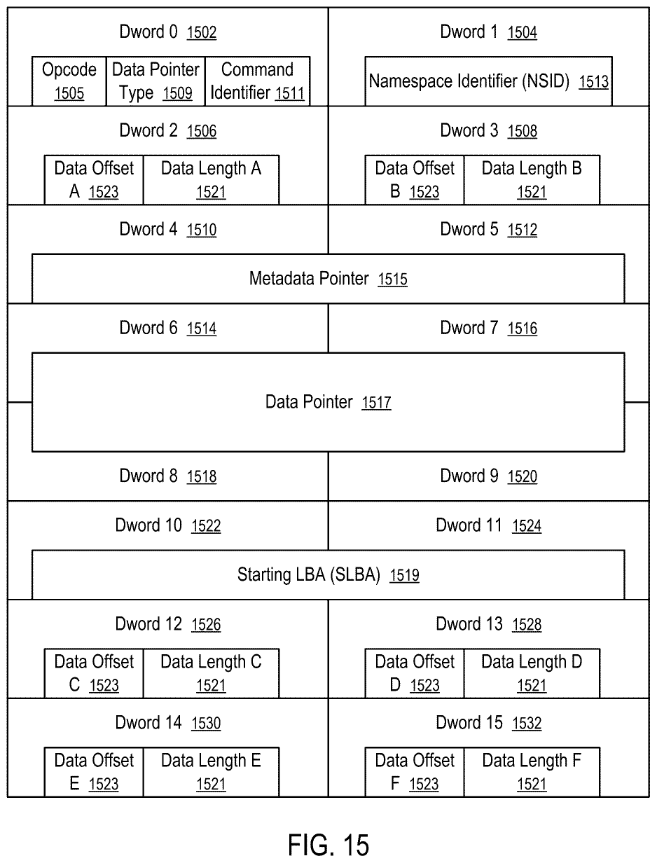

FIG. 15 shows a configuration for a read or write command that specifies pairs of data offsets and lengths with each pair specified in a respective single Dword of the command according to one embodiment. In comparison with the command format in FIG. 14, the command format of FIG. 15 allows more data segments, in a same namespace to be accessed based on offsets from a starting LBA address, to be accessed using one command. Specifically, the command format of FIG. 14 allows a command to access three segments (identified via offsets A, B, C and lengths A, B, C); and the command format of FIG. 15 allows a command to access six segments (identified via offsets A, B, C, D, E, F and lengths A, B, C, D, E, F). The performance can be improved over using multiple commands to access one data segment per command. However, reducing the sizes of offset and data length can reduce the range of offset and size of the data segments that can be accessed via one command.

The command of FIG. 15 is similar to the command of FIG. 14 and has a size of 64 bytes. Each command is configured to specify multiple, non-contiguous data locations (e.g., via multiple sets of data offsets and data lengths) for the controller to read or write during executing the command.

The multiple sets of data offsets (A-F 1523) and data lengths (A-F 1521) are specified in Dwords 2, 3, 12-15 1506, 1508, 1526-1532. Each set or pair of data offset and data length is specified in a single Dword. As a result, the command in FIG. 15 can specify more data segments than the command in FIG. 14.

Opcode 1505, data pointer type 1509, and command identifier 1511 are configured in Dword 0 1502. Namespace identifier 1513 is configured in Dword 1 1504.

Metadata pointer 1515 is configured in Dwords 4-5 1510-1512. Starting LBA 1519 is configured in Dwords 10-11 1522-1524.

Data pointer 1517 is configured in Dwords 6-9 1514-1520. Data pointer 1517 occupies four Dwords (e.g., as for data pointer 717 in FIG. 13).

In an alternative embodiment, data pointer 1517 can be reduced in size to occupy two Dwords. In one example, the type of data pointer 1517 can be indicated via the use of data pointer type 1509. In one example, the type of data pointer 1517 can be a fixed type for the command.

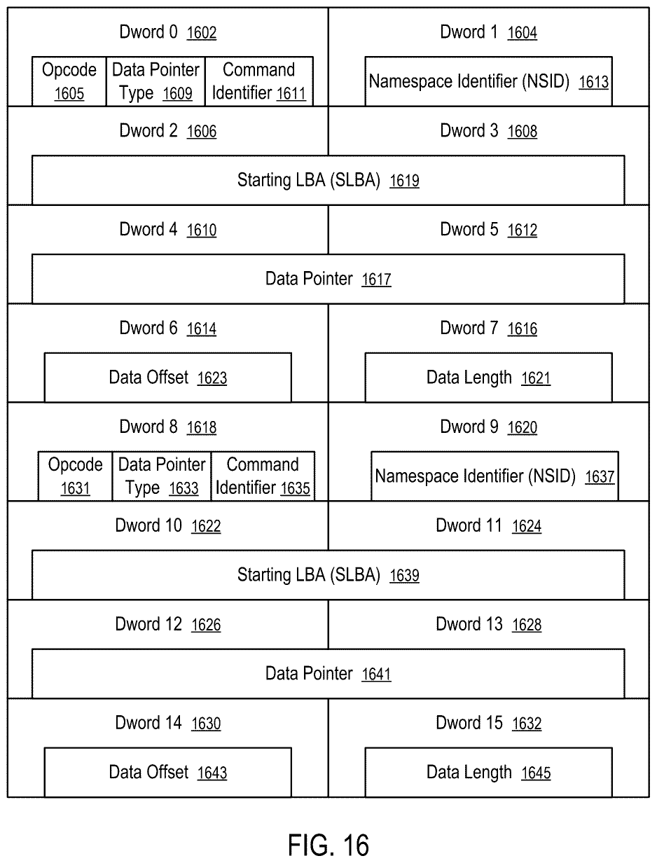

FIG. 16 shows a configuration for a read or write command of a reduced size that specifies a command identifier and data pointer according to one embodiment. FIG. 16 shows two commands, each having a size of 32 bytes. Thus, the two commands can be concatenated for entering in a single slot in a submission queue for transmission of storage access commands from the host system 102 to the memory sub-system 101. A first command is configured in Dwords 0-7 1602-1616 in the slot for a normal read/write command and has opcode 1605. A second command is configured in Dwords 8-15 1618-1632 in the slot for a normal read/write command and has opcode 1631. Each opcode 1605 or 1631 can be used to indicate the type of the respective command (in Dwords 0-7, or in Dwords 8-15). The type of command can be either a read or write command. The two commands can have different types (e.g., one command for read, and the other for write in one example; or both for read or write in another example). In one example, opcode 1605 and/or 1631 indicates a Type B read or write command 603, 703. Since the opcode 1605 is different from the opcode for a normal read/write command, the memory sub-system 101 can recognize the content in Dwords 0-15 as two commands and execute the commands separately, even though the content in Dwords 0-15 is retrieved from a submission queue as if the content were a single command in accordance with a current version of NVMe standard.

For the first command, opcode 1605, data pointer type 1609, and command identifier 1611 are configured in Dword 0 1602. Data pointer 1617 is of reduced size and configured in Dwords 4-5 1610-1612. The type of data pointer 1617 can be indicated by data pointer type 1609. The metadata pointer is eliminated from the command to reduce the size of the command such that two commands of a reduced size can be entered into a same slot in a submission queue for holding Dwords 0-15 of a normal read/write command.

Namespace identifier 1613 is configured in Dword 1 1604. Starting LBA 1619 is configured in Dwords 2-3 1606-1608.

Data offset 1623 is configured in Dword 6 1614. Data length 1621 is configured in Dword 7 1616.

The second command is configured similarly to the first command. Opcode 1631, data pointer type 1633, and command identifier 1635 are configured in Dword 8 1618.

Namespace identifier 1637 is configured in Dword 9 1620. Starting LBA 1639 is configured in Dwords 10-11 1622-1624.

Data pointer 1641 is configured in Dwords 12-13 1626-1628. The size of the data pointers 1617 and 1641 is reduced two Dwords such that two commands of a reduced size can be entered into a same slot in a submission queue for holding Dwords 0-15 of a normal read/write command. The type of data pointers 1617 and 1641 can be specified by data pointer type 1633. For example, the data pointer type 1633 can indicate that the type of the data pointers 1617 and 1641 is memory address; and memory addresses can be extracted from the data pointers 1617 and 1641. For example, the data pointer type 1633 can indicate that the type of the data pointers 1617 and 1641 is buffer ID; and memory addresses of the buffer IDs can be looked up from the lookup table 1330 in FIG. 13 using the buffer IDs extracted from data pointers 1617 and 1641. The type of data pointer 1641 can be indicated by data pointer type 1633.

Data offset 1643 is configured in Dword 14 1630. Data length 1645 is configured in Dword 15 1632. Alternatively, the sizes of data offsets and data lengths can be reduced in a way as in FIG. 15 to allow each of the two commands to access two separate data segments relative to their SLBAs 1619 and 1639. For example, one pair of offset and length can be specified in Dword 6 1614 and another pair of offset and length can be specified in Dword 7 1616 for the command specified in Dwords 0-7; and one pair of offset and length can be specified in Dword 14 1630 and another pair of offset and length can be specified in Dword 15 1632 for the command specified in Dwords 8-15.

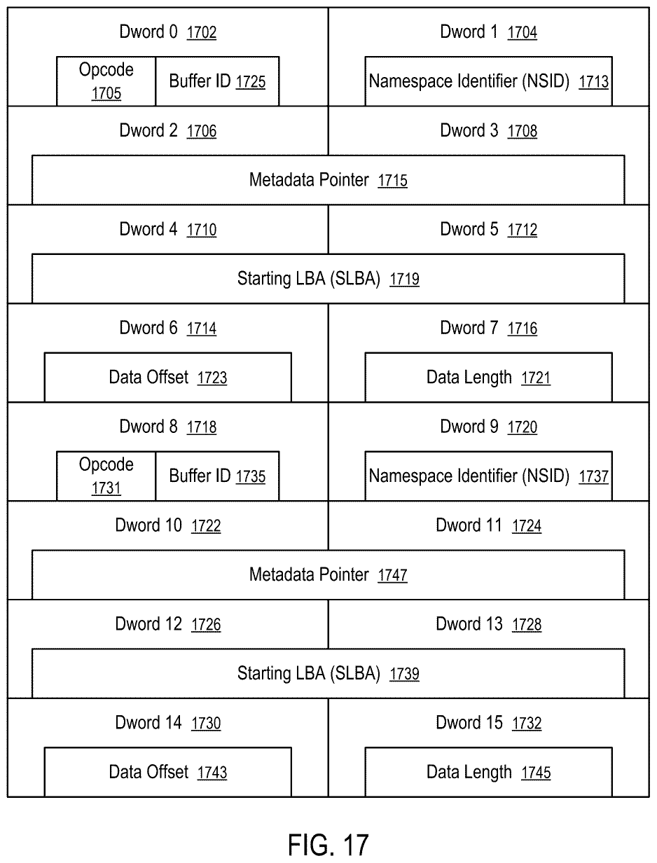

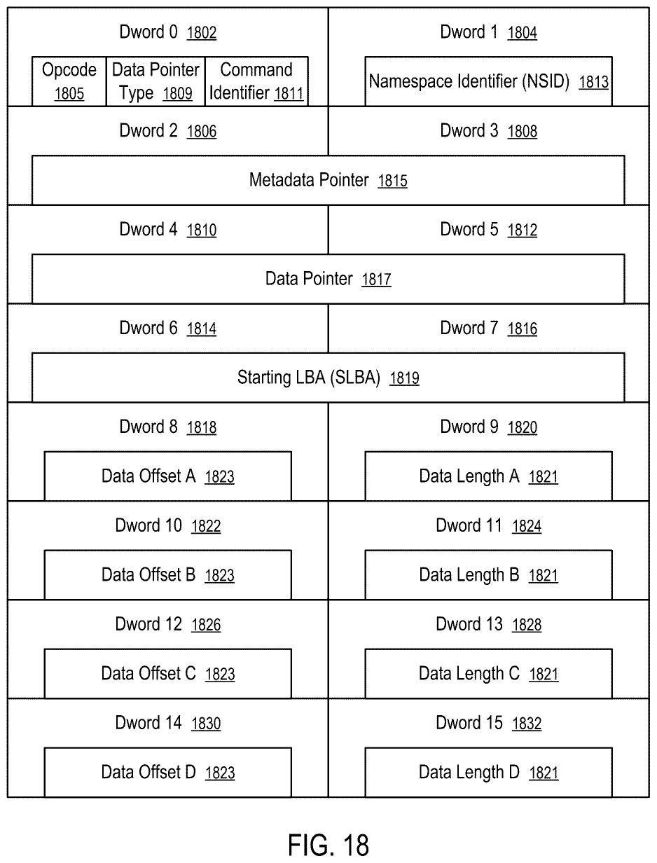

FIG. 17 shows a configuration for a read or write command of a reduced size that specifies a buffer identifier and metadata pointer according to one embodiment. Similarly to FIG. 16, FIG. 17 shows two commands, each having a size of 32 bytes. Thus, the two commands can be concatenated for entering in a single slot in a submission queue for transmission of storage access commands from the host system 102 to the memory sub-system 101. A first command is configured in Dwords 0-7 1702-1716 in the slot for a normal read/write command and has opcode 1705. A second command is configured in Dwords 8-15 1718-1732 in the slot for a normal read/write command and has opcode 1731. Each opcode 1705 or 1731 can be used to indicate the type of the respective command (in Dwords 0-7, or in Dwords 8-15). The type of command can be either a read or write command. The two commands can have different types (e.g., one command for read, and the other for write in one example; or both for read or write in another example). In one example, opcode 1705 and/or 1731 indicates a Type B read or write command 603, 703. Since the opcode 1705 is different from the opcode for a normal read/write command, the memory sub-system 101 can recognize the content in Dwords 0-15 as two commands and execute the commands separately, even though the content in Dwords 0-15 is retrieved from a submission queue as if the content were a single command in accordance with a current version of NVMe standard.

The first and second commands each include a buffer identifier 1725, 1735 that can also service as the command identifiers of the commands. Since the technique of buffer ID is used to identify data pointers, it's not necessary to use any of the Dwords to separately specify data pointers. As a result, the size of the commands is reduced for presenting two commands in a same slot in a submission queue, while each of the commands still has a metadata pointer 1715, 1747.

The first and second commands each include a metadata pointer 1715, 1747. Metadata pointer 1715 is configured in Dwords 2-3 1706-1708. Metadata pointer 1747 is configured in Dwords 10-11 1722-1724.

For the first command, namespace identifier 1713 is configured in Dword 1 1704. Starting LBA 1719 is configured in Dwords 4-5 1710-1712. Data offset 1723 is configured in Dword 6 1714. Data length 1721 is configured in Dword 7 1716.

For the second command, namespace identifier 1737 is configured in Dword 9 1720. Starting LBA 1739 is configured in Dwords 12-13 1726-1728. Data offset 1743 is configured in Dword 14 1730. Data length 1745 is configured in Dword 15 1732. Alternatively, the sizes of data offsets and data lengths can be reduced in a way as in FIG. 15 to allow each of the two commands to access two separate data segments relative to their SLBAs 1719 and 1739. For example, one pair of offset and length can be specified in Dword 6 1714 and another pair of offset and length can be specified in Dword 7 1716 for the command specified in Dwords 0-7; and one pair of offset and length can be specified in Dword 14 1730 and another pair of offset and length can be specified in Dword 15 1732 for the command specified in Dwords 8-15. Alternatively, or in combination, the metadata pointer 1745 and 1747 can be limited to provide room for specifying data segments to be accessed (with or without reducing the sizes of offset and length).

FIG. 18 shows a configuration for a read or write command that specifies a data pointer of a reduced size, and further specifies multiple data offsets and data lengths according to one embodiment. FIG. 18 shows a single command having a size of 64 bytes and including parameters similarly as in FIG. 14 except data pointer 1817 is of reduced size and some of the parameters are specified in different locations of the command. The size reductions allow a command according to the format of FIG. 18 to access a large number of data segments with the transmission of the content of a single slot in a submission queue.

Opcode 1805, data pointer type 1809, and command identifier 1811 are configured in Dword 0 1802. Namespace identifier 1813 is configured in Dword 1 1804. Metadata pointer 1850 is configured in Dwords 2-3 1806-1808.

Data pointer 1817 is configured in Dwords 4-5 1810-1812. The type of data pointer 1817 can be indicated by data pointer type 1809. Starting LBA 1819 is configured in Dwords 6-7 1814-1816.

One or more data segments can be specified in Dwords 8-15 1818-1832. Data offsets A-D 1823 are configured in Dwords 8, 10, 12, 14 (1818, 1822, 1826, 1830). Data lengths A-D 1821 are configured in Dwords 9, 11, 13, 15 (1820, 1824, 1828, 1832).

In one embodiment, each pair of data offsets and data lengths in the command can be made smaller to fit within a single Dword as in FIG. 15. This permits specifying an increased number of data segments.

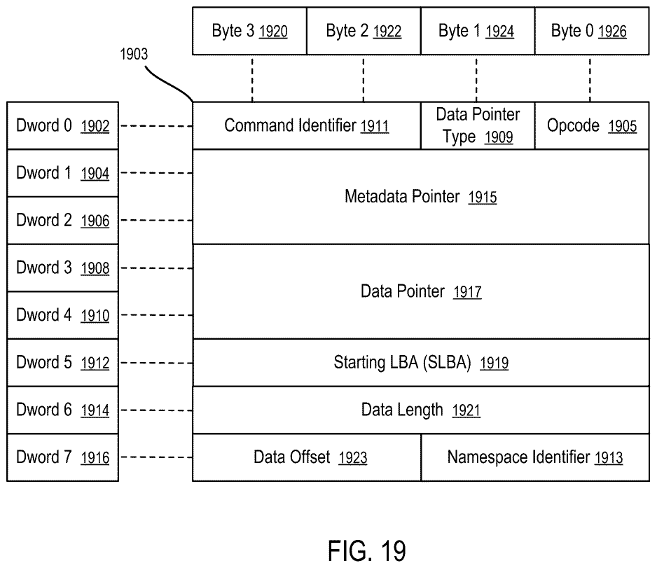

FIG. 19 shows a configuration for a read or write command 1903 of a reduced size that specifies a command identifier 1911 and metadata pointer 1915 according to one embodiment. Command 1903 has a size of 32 bytes. Command 1903 specifies a value for opcode 1905 that can be used to indicate the type of command. The type of command can be either a read or write command. Two of commands 1903 have a combined size of 64 bytes and can fit into a 64-byte slot of a submission queue according to the NVMe standard. In one example, the value of opcode 1905 indicates a Type B read or write command 603, 703.

Command identifier 1911, data pointer type 1909, and opcode 1905 are configured in Dword 0 1902. Command identifier 1911 is configured in bytes 3:2 1920-1922. Data pointer type 1909 can configured in byte 1 1924. Data pointer type 1909 can have a size less than eight bits. In some cases, data pointer type 1909 is not used in command 1903.

Metadata pointer 1915 is configured in Dwords 1-2 1904-1906.

Data pointer 1917 is of reduced size and configured in Dwords 3-4 1908-1910. In one embodiment, data pointer 1917 is a memory address.

In one embodiment, data pointer 1917 is pre-configured to specify a memory address for data transfer. For example, a buffer address can be specified as in the bit segment in the command allocated for the data pointer 1917. For example, the buffer address can be a memory address of a pre-allocated buffer (e.g., allocated during a boot time of the computing system 100 as discussed in connection with FIG. 13). Since the memory address is provided directly in the command, it is not necessary for the memory sub-system 101 to convert a buffer identifier to the memory address using a look up table 1330). Optionally, the host system can specify the memory address of a temporary buffer as the data pointer 1917, or the memory address of a memory region allocated specific for the data transfer of the particular instance of the command. When the data pointer 1917 is limited to the type of memory address, the data pointer type 1909 can be eliminated from the command 1903 (e.g., byte 1 1924 in Dword 0 1902 can be reserved or repurposed for another parameter, such as an indication of a unit of the offset 1923 and/or the length 1921). Alternatively, the data pointer 1917 can be one of multiple types (e.g., a type in a group containing memory address, buffer ID, PRP, and/or SGL); and the data pointer type 1909 can be used to indicate the type and a format to extract relevant parameters from and/or according to the content specified in the data pointer 1917.

In one embodiment, data pointer type 1909 can indicate a type of data pointer 1917 to be used in executing the command. In one example, data pointer type 1909 indicates whether data pointer 1917 is a memory address (e.g., 1310) or a buffer identifier (e.g., 1313), or a type of data pointer as specified in a current version of NVMe standard. In one example, data pointer type 1909 can be a single bit. In one example, data pointer type 1909 is specified in a way as discussed above in connection with data pointer type field 609 or 709 in FIG. 6 and FIG. 7.

Starting LBA 1919 is configured in Dword 5 1912. This is reduced in size as compared to a size of two Dwords for a starting LBA according to a current version of NVMe standard.

Data length 1921 is configured in Dword 6 1914. Data offset 1923 is configured in bytes 3:2 1920-1922 of Dword 7 1916. Namespace identifier 1913 is configured in bytes 1:0 1924-1926 of Dword 7 1916.

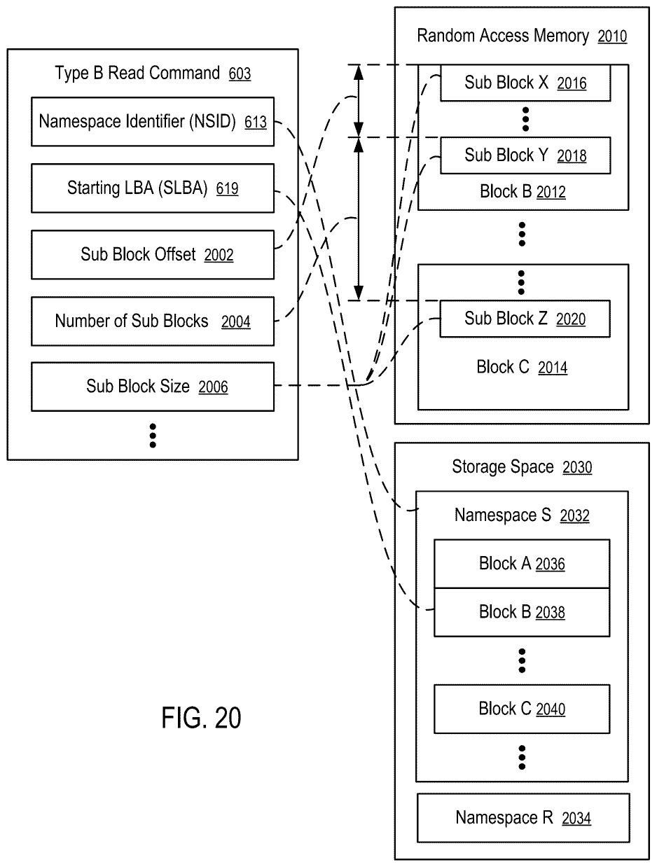

FIG. 20 shows a technique to specify a destination of data retrieved via execution of a read command 603 according to one embodiment. The read command 603 specifies an offset and a data length via sub block size 2006, a sub block offset 2002, and number of sub blocks 2004 for reading one or more sub blocks from a storage space 2030 during execution of the read command 603 according to one embodiment. For example, the data offset 623 and data length 621 in the read command 603 in FIG. 6 can be implemented using the technique of FIG. 20. For example, the data offset and data length in the commands shown in FIG. 14 to FIG. 19 can be implemented using the technique of FIG. 20. Storage space 2030 is partitioned into namespaces such as Namespace S 2032 and Namespace R 2034. Each namespace stores data in logical blocks using LBA addressing. Storage space 2030 is an example of storage space 261 of FIG. 2.

Namespace S 2032 is partitioned into blocks of a same size (e.g., LBA Size), such as blocks A 2036, B 2038, . . . , C 2040. Read command 603 can be configured to specify one or more sub blocks to be read from the logical blocks of Namespace S 2032. Read command 603 includes namespace identifier (NSID) 613 to identify the namespace (e.g., Namespace S 2032) from which the sub blocks are read.

Read command 603 includes starting LBA (SLBA) 619 to identify the first logical block in the namespace identified by namespace identifier 613 from which data will be read. For example, starting LBA 619 identifies that block B 2038 is the first logical block from which one or more sub blocks are read. Block B 2038 can be mapped by a flash translation layer of the memory sub-system 101 to a block of non-volatile memory cells of the memory sub-system 101, such as memory cells storing a data block 842 as illustrated in FIG. 9.

Read command 603 identifies the sub blocks to be read from the namespace identified in the command by specifying sub block offset 2002, number of sub blocks 2004, and sub block size 2006. Sub block offset 2002 specifies where the data transfer begins inside the block 2038 identified by the starting LBA 619 during the execution of the read command 603 of FIG. 20. During the execution of the read command 603, the memory sub-system 101 retrieves the entire data from the block 2038 in the namespace 2032. The retrieved data from the block 2038 can have sub blocks 2016, . . . , 2018, etc. The memory sub-system 101 can discard the sub blocks before the sub block 2018 as identified by the sub block offset 2002, and only send one or more sub blocks starting with sub block 2018 to the random access memory 2010. The sub block 2018 is stored into the random access memory 2010 at a location identified via a data pointer specified in the read command 603. For example, the data pointer can be configured in a way as illustrated in FIG. 13 to FIG. 19, and/or as the data pointer 617 discussed in connection with FIG. 6. The memory sub-system 101 is configured to skip the transferring of data in the offset region, positioned before the sub block 2018 as identified by the sub block offset 2002, such as the sub block 2016. The sub block 2016 in FIG. 20 is illustrated to show the offset 2002, not as an indication of the sub block 2016 being sent from the memory sub-system 101 to the random access memory 2010 as a result of the execution of the read command 603.

For example, data offset 623 of FIG. 6 can be configured in a way as represented by sub block offset 2002 illustrated in FIG. 20. Data length 621 of FIG. 6 can be configured in a way as represented by number of sub blocks 2004 illustrated in FIG. 20.

Although a read command 603 is illustrated and described above, a write command 703 can be similarly configured to include namespace identifier 713, starting LBA 719, sub block offset 2002, number of sub blocks 2004, and sub block size 2006. For example, write command 703 can be executed to write one or more sub blocks provided by the host system 102 (e.g., sub block Y 2018, sub block Z 2020) to Namespace S 2032 in one or more blocks identified by write command 703. When the write command 703 is configured to provide a portion of a block (e.g., 2038 without the data before the sub block 2018), the memory sub-system 101 is configured to read the block 2038 to obtain the existing data in the offset region as identified by the sub block offset 2002 and then combine the data from the namespace 2032 and the data from the random access memory 2010 (e.g., the sub block 2018 and a remaining portion that follows the sub block 2018 in the block 2012 to form a complete data block for writing back to the namespace 2032 at the starting LBA 619).

The combination of number of sub blocks 2004 and sub block size 2006 specifies a data length (e.g., the total size of the data to be read from the storage space 2030 during execution of the read command 603, or written to the storage space 2030 during execution of a similarly configured write command 703). Read command 603 defines the data length as a number of consecutive units of data to be read. Sub block size 2006 specifies the size of each unit of data. In one example, the unit of data can be a byte, word, double word, or cacheline (e.g., 128 bytes), or a number of bytes as identified by the sub block size 2006.

In one example, the data length can extend over multiple logical blocks. Also, the range of data represented by the data length is not necessarily aligned with a logical block boundary; and sub block offset 2002 specifies an offset from the logical block boundary corresponding to a starting LBA address specified in starting LBA field 619. The ending portion of the range is not necessarily aligned with the end of the last block (e.g., 2030 in the namespace 2032 and block 2014 in the random access memory 2010). During the execution of the read command 603, the entire block 2040 is read in the memory sub-system 101. However, the memory sub-system 101 skips sending the data following the last sub block 2020 as identified via the data length (via number of sub blocks 2004). During the execution of a similarly configured write command 703, the memory sub-system 101 is configured to read the block 2040 in the namespace 2032 to obtain the remaining data that is to follow the sub block 2020, and generate the complete data for the block 2040 for writing back to the namespace 2032.

In one example, sub block size 2006 specifies a value that identifies a size of the unit of data. The size of the unit is computed from the value (e.g., as 2 to the power of the value).

After the execution of the read command 603, random access memory 2010 stores data read from storage space 2030. The data includes the number of sub blocks 2004 (e.g., 2018, . . . , 2020) as specified in the read command 603, which corresponds to data retrieved from logical blocks identified via the namespace identifier 613 and the starting LBA 619 specified in the read command 603. For example, random access memory 2010 includes block B 2012 and block C 2014, which correspond to data read from block B 2038 and block C 2040 of storage space 2030. For example, the random access memory 2010 can be configured in memory 106 of the host system 102 as in FIG. 1, or memory 264 outside of the memory sub-system 101 as in FIG. 2.

In the example illustrated in FIG. 20, the combination of starting LBA 619 and the namespace identifier 613 identifies block B 2038. Sub block offset 2002 and number of sub blocks 2004 identify a range of consecutive blocks 2038 to 2040 to be read from Namespace S 2032. A memory sub-system (e.g., solid-state drive 260) reads data from the logical blocks 2038 to 2040 to retrieve the sub blocks 2018 to 2020. The memory sub-system extracts and transfers the identified sub blocks 2018 to 2020 to a location in random access memory 2010 as identified by a data pointer specified in the read command 603, which can be in a host system 102 as in FIG. 1.

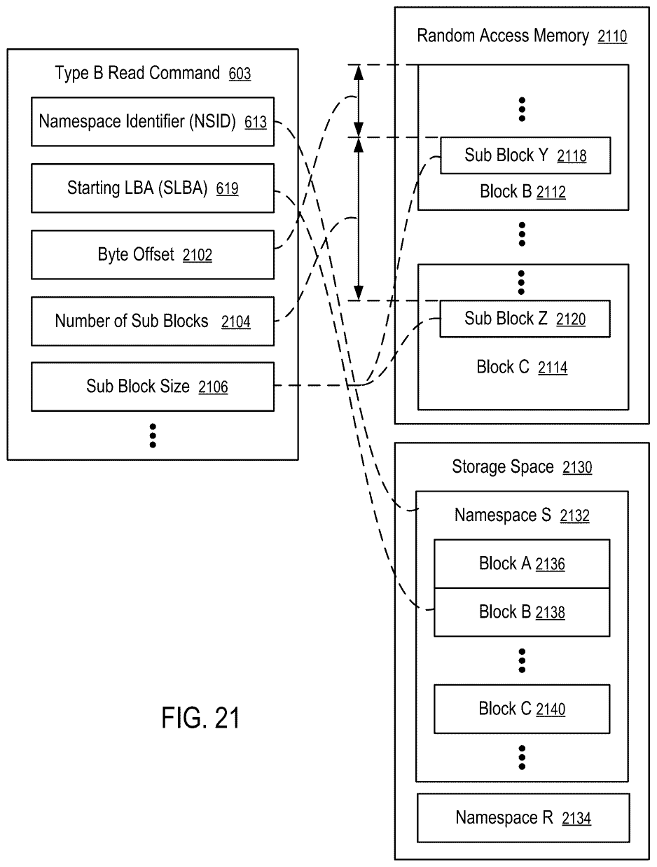

FIG. 20 shows a technique in which both data offset (e.g., sub block offset 2002) and data length (e.g., number of sub blocks 2004) are specified in the unit of the sub block size 2006. Alternatively, the data offset can be specified in the unit of byte, as in FIG. 21. FIG. 21 shows a technique to specify a destination of data retrieved via execution of a read command 603 according to one embodiment. The read command 603 specifies a byte offset 2102, a sub block size 2106, and number of sub blocks 2104 for reading one or more sub blocks from a storage space 2130 during execution of the read command 603 according to one embodiment. The combination of the sub block size 2106, and number of sub blocks 2104 identifies a data length, which can be used in the commands in FIG. 6, and FIG. 14 to FIG. 19. The use of byte offset 2102 allows the identification of a data offset more precisely at the increment of byte, instead of sub block. The read command 603 illustrated in FIG. 21 can be configured similarly as the read command 603 illustrated in and discussed in connection with FIG. 20 except that a byte offset 2102 is specified instead of sub block offset 2002.

Storage space 2130 is partitioned into namespaces such as Namespace S 2132 and Namespace R 2134. Storage space 2130 is an example of storage space 261 of FIG. 2.

Namespace S 2132 is partitioned into blocks of a same size (e.g., LBA Size), such as blocks A 2136, B 2138, . . . , C 2140. Read command 603 can be configured to specify one or more sub blocks to be read from the logical blocks of Namespace S 2132. Read command 603 includes namespace identifier (NSID) 613 to identify the namespace (e.g., Namespace S 2132) from which the sub blocks are read.

Read command 603 includes starting LBA (SLBA) 619 to identify the first logical block in the namespace identified by namespace identifier 613 from which data will be read. Read command 603 identifies the sub blocks to be read from the namespace identified in the command by specifying byte offset 2102, number of sub blocks 2104, and sub block size 2106. Byte offset 2102 specifies where the data transfer begins inside the block 2138 identified by the starting LBA 619 during the execution of the read command 603 of FIG. 21. In one example, the execution of the read command 603 of FIG. 21 can be performed in a way as discussed for read command 603 in connection with FIG. 20. During execution of read command 603, sub block 2118 is stored into the random access memory 2110 at a location identified via a data pointer specified in the read command 603.

In one example, data offset 623 of FIG. 6 can be configured in a way as represented by byte offset 2102 illustrated in FIG. 21. Data length 621 of FIG. 6 can be configured in a way as represented by number of sub blocks 2104 illustrated in FIG. 21.

Although a read command 603 is illustrated in FIG. 21 and described above, a write command 703 can be similarly configured to include namespace identifier 713, starting LBA 719, byte offset 2102, number of sub blocks 2104, and sub block size 2106. The combination of number of sub blocks 2104 and sub block size 2106 specifies a data length (e.g., the total size of the data to be read from the storage space 2130 during execution of the read command 603, or written to the storage space 2130 during execution of a similarly configured write command 703).

After the execution of the read command 603, random access memory 2110 stores data read from storage space 2130. The data includes the number of sub blocks 2104 (e.g., 2118, . . . , 2120) as specified in the read command 603, which corresponds to data retrieved from logical blocks identified via the namespace identifier 613 and the starting LBA 619 specified in the read command 603. For example, random access memory 2110 includes block B 2112 and block C 2114, which correspond to data read from block B 2138 and block C 2140 of storage space 2130. For example, the random access memory 2110 can be configured in memory 106 of the host system 102 as in FIG. 1, or memory 264 outside of the memory sub-system 101 as in FIG. 2.

In the example illustrated in FIG. 21, the combination of starting LBA 619 and the namespace identifier 613 identifies block B 2138. Byte offset 2102 and number of sub blocks 2104 identify a range of consecutive blocks 2138 to 2140 to be read from Namespace S 2132. A memory sub-system reads data from the logical blocks 2138 to 2140 to retrieve the sub blocks 2118 to 2120. The memory sub-system extracts and transfers the identified sub blocks 2118 to 2120 to a location in random access memory 2110 as identified by a data pointer specified in the read command 603.

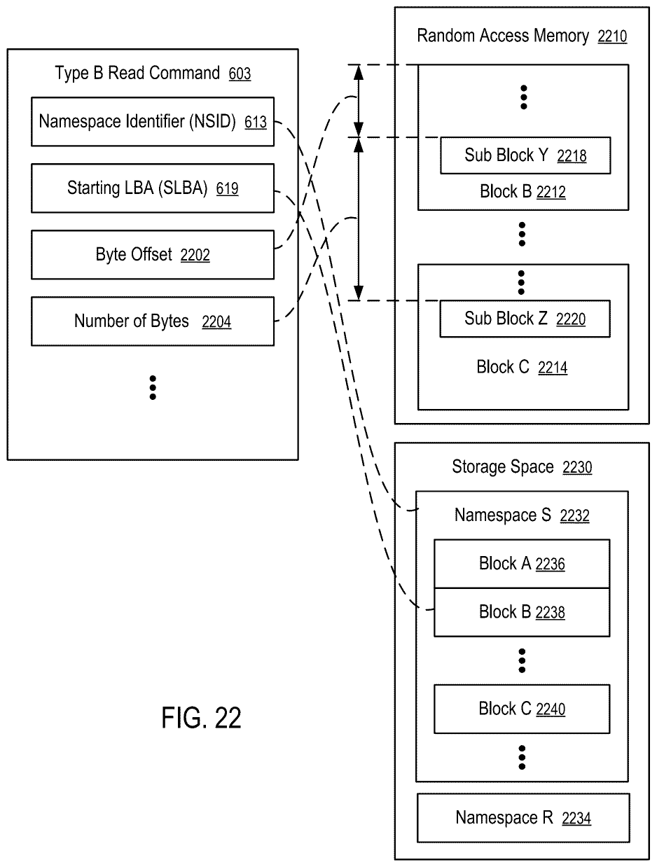

FIG. 20 and FIG. 21 show a technique in which data length (e.g., number of sub blocks 2004) is specified in the unit of the sub block size 2006. Alternatively, the data length can be specified in the unit of byte, as in FIG. 22. FIG. 22 shows a read command 603 that specifies a byte offset 2202 as data offset and number of bytes 2204 as a data length for reading one or more sub blocks from a storage space 2230 during execution of the read command 603 according to one embodiment. Since neither the data offset nor the data length is specified in the unit of sub block size, it is not necessary to configure the read command 603 to identify sub block size (e.g., 2006, 2106 as in FIG. 20 and FIG. 21). The use of number of bytes 2204 allows the identification of a data length more precisely at the increment of byte, instead of sub block. For example, the data offset and data length in the commands shown in FIG. 6, FIG. 14 to FIG. 19 can be identified using the technique of FIG. 21. The read command 603 illustrated in FIG. 22 can be configured similarly as the read command 603 illustrated in and discussed in connection with FIG. 20 except that byte offset 2202 is specified instead of sub block offset 2002, and number of bytes 2204 is specified instead of number of sub blocks 2004. Also, sub block size 2006 is not used and each sub block has a fixed size of one byte.

Storage space 2230 is partitioned into namespaces such as Namespace S 2232 and Namespace R 2234. In one example, storage space 2230 can be configured and used by a memory sub-system when executing read command 603 in a similar way as discussed in connection with FIG. 20. Namespace S 2232 is partitioned into blocks of a same size (e.g., LBA Size), such as blocks A 2236, B 2238, . . . , C 2240.

Read command 603 identifies the sub blocks (each one byte in size) to be read from the namespace identified in the command by specifying byte offset 2202 and number of bytes 2204. Byte offset 2202 specifies where the data transfer begins inside the block 2238 identified by the starting LBA 619 during the execution of the read command 603 of FIG. 22. In one example, the execution of the read command 603 of FIG. 22 can be performed similarly in a way as discussed for read command 603 in connection with FIG. 20. During execution of read command 603, sub block 2218 is stored into the random access memory 2210 at a location identified via a data pointer specified in the read command 603.

Although a read command 603 is illustrated in FIG. 22 and described above, a write command 703 can be similarly configured to include namespace identifier 713, starting LBA 719, byte offset 2202, and number of bytes 2204. The byte offset 2202 specifies an offset as a number of bytes. The number of bytes 2204 specifies a data length for the data transfer.

After the execution of the read command 603, random access memory 2210 stores data read from storage space 2230. The data includes the number of bytes 2204 (e.g., 2218, . . . , 2220) as specified in the read command 603.

In the example illustrated in FIG. 22, the combination of starting LBA 619 and the namespace identifier 613 identifies block B 2238. Byte offset 2202 and number of bytes 2204 identify a range of consecutive blocks 2238 to 2240 to be read from Namespace S 2232. A memory sub-system reads data from the logical blocks 2238 to 2240 to retrieve the sub blocks 2218 to 2220. The memory sub-system extracts and transfers the identified sub blocks 2218 to 2220 to a location in random access memory 2210 as identified by a data pointer specified in the read command 603.

In at least some embodiments, command identifiers in storage commands (e.g., discussed above) are based on global resource identifiers of submitters of the commands, as further described below. For example, multiple threads executing on a host system can share a submission queue allocated by the host system in host memory. A unique global resource identifier is associated with each thread by the host system. Each of the multiple threads can submit a read or write command to the submission queue. Each thread generates a command specifying a command identifier based on the global resource identifier of the thread. Command identifiers generated based on different global resource identifiers are different from each other.

In one example, the global resource identifier used to generate a command identifier of a storage command is based on or corresponds to a memory address assigned to a submitter for exclusive use by the submitter among a plurality of submitters; and optionally, the memory address can be specified in the command as a data pointer provided in the command (e.g., in FIG. 13). Alternatively, the global resource identifier can correspond to or be based on a buffer identifier assigned to the submitter and specified in the command as a data pointer (e.g., in FIG. 13). The memory address and the buffer identifier each represent a unique global address. In some cases, the global resource identifier can be based on and/or include one or more of the following: memory address included in a command, buffer identifier, thread identifier, node identifier, and/or other numbers associated with a thread and/or generation of a new command by the thread where the numbers are different/unique among the submitters sharing the same submission queue.

In one embodiment, a node is a physical server or machine, and each node has a different node identifier. In one example, a node is a server including one or more GPUs, a CPU, memory (RAM), storage, and a network interface to communicate with other nodes.

A thread can generate a command having a command identifier that is a number uniquely associated with a global address in that different global addresses can result in different numbers generated as command identifiers. In one example, the number is computed based on a hash value of the memory address or buffer identifier.

In some cases, a submitter obtains a command identifier by locking the submission queue. The submitter determines the command identifier of the last command in the queue and increases that value by one. If the result exceeds the largest permitted command identifier, the value of the command identifier is rolled back to zero. The new command is entered into the submission queue, and the queue is unlocked for other submitters to determine available command identifiers for use. However, by using different identifiers assigned to different submitters that can result in different command identifiers, the submitters sharing a same submission queue do not need to check command identifiers of commands pending in the submission queue and/or lock the submission queue when needing to select a command identifier for a new command being entered into the submission queue.

In many cases, GPU threads running on an SSD need to share a common queue pair (QP). Each command generated by a thread and submitted to the submission queue of the QP needs to have a command identifier, which is a unique number used to uniquely identify the command among the commands pending in the submission queue. When multiple submitters in a host system share a submission queue, the coordination among the submitters is needed to ensure that each command pending in the submission queue has a unique command identifier. The identifier enables the host system to differentiate each command from one another for determining completion of execution of the command when a completion record, configured to identify the command having been executed by referring to the command identifier, is received from the SSD in the completion queue of the QP. Command identifiers can be reused, as long as no two commands in the submission queue use the same identifier. For example, when the host system determines from a completion record that a command has completed execution, the host system can enter another command into the submission queue with the same identifier that was used in the completed command.

In one embodiment, a command submitter specifies a command identifier for a command based on a global resource identifier assigned to the submitter. Different global resource identifiers are assigned to different submitters using the same submission queue such that the command identifiers generated by the submitters are different from each other. For example, a global resource identifier can correspond to and/or identify the memory address of the buffer being used by the command submitter. When two threads are configured to perform read/write operations using different buffers, the command identifiers generated separately by the threads can be different from each other.

In one embodiment, a command uses buffer identifier addressing. The command uses the buffer identifier (e.g., buffer ID 1313) as the command identifier. When different submitters are assigned to use different buffer identifiers, the command identifiers generated by the submitters are different from each other. In one example, a buffer identifier (e.g., buffer ID 1725 in FIG. 17) is provided in a command both as a data pointer and as a command identifier such that a field for data pointer can be eliminated from the command (e.g., as in FIG. 17).

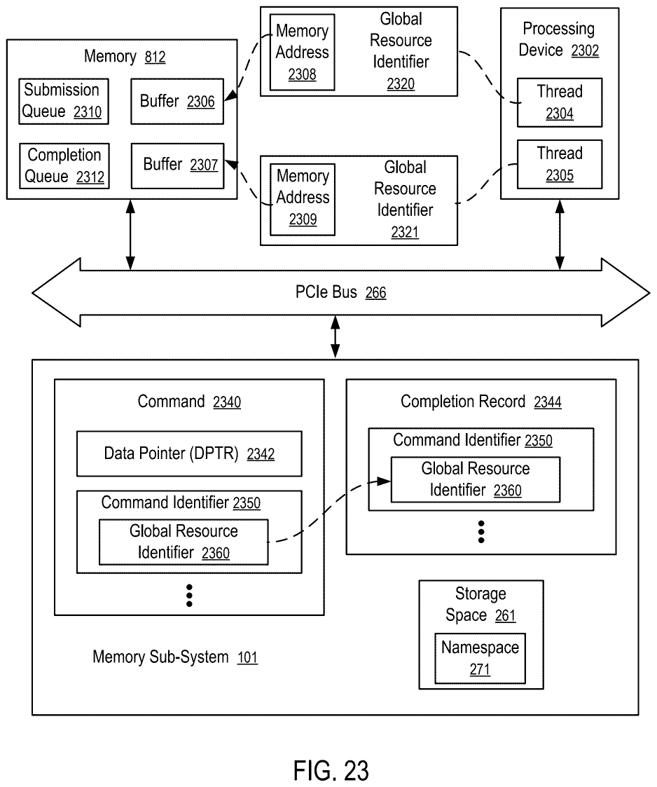

FIG. 23 shows a technique for specifying a command identifier based on a unique global resource identifier according to one embodiment. Processing device 2302 (e.g., CPU/GPU 262) and memory sub-system 101 (e.g., solid state drive 260) communicate with each other using PCIe bus 266. Processing device 2302 and memory 812 can be configured in a host system (e.g., as 102 in FIG. 1).

Memory 812 has a submission queue 2310 for holding commands 2340 (e.g., NVMe read or write commands 282 and fast commands 284) to be retrieved by memory sub-system 101. Threads 2304, 2305 execute on processing device 2302 and generate commands (e.g., 2340 as retrieved by the memory sub-system 101). Each thread 2304, 2305 as a submitter of a command determines a command identifier (e.g., 2350) for each newly-generated command 2340 and enters the command (e.g., 2340) into the submission queue 2310 at one of the slots in the submission queue 2310 (e.g., configured according to a standard of NVMe). Each command identifier (e.g., 2350) is based on a global resource identifier 2360 of a respective submitter (e.g., identifier 2320 of thread 2304, or identifier 2321 of thread 2305). Global resource identifiers 2320 and 2321 of the submitters/threads 2304 and 2305 sharing the same submission queue 2310 are different from each other; and as a result, the command identifiers generated separately by the submitters/threads 2304 and 2305 are also different from each other.

A different global resource identifier 2360 is associated with and/or assigned to each thread 2304, 2305. For example, global resource identifier 2320 is associated with thread 2304. Global resource identifier 2321 is associated with thread 2305.

Memory 812 includes completion queue 2312. After execution of each command 2340, memory sub-system 101 writes a completion record 2344 in completion queue 2312 to report the status of the execution of the command 2340. Completion record 2344 includes the command identifier 2350 of the command 2340 being executed.

In one example, memory sub-system 101 retrieves the command 2340 from the submission queue 2310 via PCIe interface 268. The retrieved command 2340 is buffered in local memory 280 and scheduled for execution. After the execution of the command 2340, the memory sub-system 101 generates and sends the completion record 2344 via PCIe interface 268 into the completion queue 2312.

The global resource identifiers 2320 and 2321 of the threads 2304 and 2305 can be based on and/or generated from memory addresses 2308 and 2309 of pre-defined buffers 2306 and 2307 that are allocated to the threads 2304 and 2305 respectively. For example, as described in connection with FIG. 13, the processing device 2302 can allocate (e.g., during a boot time) portions of memory 812 to fixed buffers 2306, 2307, which are assigned to threads 2304, 2305 during processing. Memory address 2308 identifies a location of buffer 2306 in memory 812. Memory address 2309 identifies a location of buffer 2307 in memory 812. In one example, memory address 2308, 2309 can be similar to memory address 1310 or memory address A 1342 as described in connection with FIG. 13.

Each command identifier 2350 is based on and/or includes global resource identifier 2360 of a submitter of the command 2340. For example, global resource identifier 2320 is based on memory address 2308 of the buffer 2306 assigned to the thread 2304 as a user of the submission queue 2310. Global resource identifier 2321 is based on memory address 2309 of the buffer 2307 assigned to the thread 2305 as another user of the submission queue 2310. In one example, global resource identifier 2320 is a hash of memory address 2308. Global resource identifier 2321 is a hash of memory address 2309.

In one embodiment, if addresses (e.g., 2308, 2309) of buffers 2306 and 2307 as used by the threads 2304 and 2305 (e.g., logical addresses) can be non-unique across from the point of view of the memory sub-system 101, then global resource identifier 2320, 2321 can be configured to further include a unique node identifier (e.g., node ID) such that a combination of the address (e.g., 2308) and the node ID can be unique across the submitters (e.g., threads 2304 and 2305) sharing the submission queue 2310. In one example, the global resource identifier is a combination of the node identifier and a hash of the memory address, or a hash of the combination of the node identifier and the memory address.

In some embodiments, in addition to command identifier 2350, each command 2340 retrieved from submission queue 2310 includes data pointer (DPTR) 2342. Data pointer 2342 points to a location in memory 812 for data transfer when executing command 2340. In other embodiments, the memory sub-system 101 can determine the location in memory 812 for data transfer (e.g., buffer 2306 or 2307) based on the command identifier 2350; and thus, the field for data pointer (e.g., 2342) can be eliminated (e.g., as in FIG. 17).

In one example, thread 2304 generates a read command 2340 that includes global resource identifier 2320 as a command identifier 2350. The read command 2340 includes memory address 2308 as a data pointer 2342. During execution of the read command 2340, data is read from one or more logical blocks in namespace 271 of storage space 261. The namespace 271 is identified by a namespace identifier (not shown) included in command 2340. The read data is written by memory sub-system 101 to buffer 2306 at the location identified by memory address 2308.

As each command 2340 is executed by memory sub-system 101, a corresponding completion record 2344 is generated. Completion record 2344 includes the command identifier 2350 of the executed command 2340. Memory sub-system 101 writes each completion record to completion queue 2312.

In one example, command identifier 2350 has a size of 16 bits and is specified in Dword 0 of command 2340. A memory address specified by data pointer 2342 of the command 2340 has a size of two Dwords. A hash is computed using the memory address and has a size of 16 bits or less. The hash is used as the command identifier 2350. In one example, a predefined buffer identifier is included in the command. The buffer identifier has a size of 16 bits or less and is used as the command identifier 2350.

In one embodiment, global resource identifier 2360 is tied to a buffer assigned to a submitting thread. For example, processing device 2302 can assign buffer 2306 to thread 2304, and buffer 2307 to thread 2305. Each buffer 2306, 2307 is assigned to only a single thread at any given time. The buffer is not reassigned to another submitting thread before completion of execution of a command generated by a thread presently using the buffer. In this manner, a command identifier that is based on the global resource identifier is unique, and there will be no command identifier conflict among different submitting threads. In one example, the global resource identifier is the same as the buffer ID 1313 described in connection with FIG. 13.

When both a command identifier and a data pointer in a command identify the same physical item, memory sub-system 101 can do cross-checking to confirm consistency in the identifications. The physical item can be identified in various different ways. In one example, the command identifier specifies an ID and the data pointer specifies an address. Optionally, both the command identifier and the data pointer can specify the same physical item.

In one embodiment, submission queue 2310 can have two or more commands each having the same command identifier generated by a same submitter and different from command identifiers generated by other submitters using the same submission queue 2310. Memory sub-system 101 is configured to execute the commands having the same command identifier in the order as were entered in the submission queue 2310. Although no out-of-order execution for commands having the same command identifier is permitted, out-of-order execution is allowed for commands having different command identifiers.

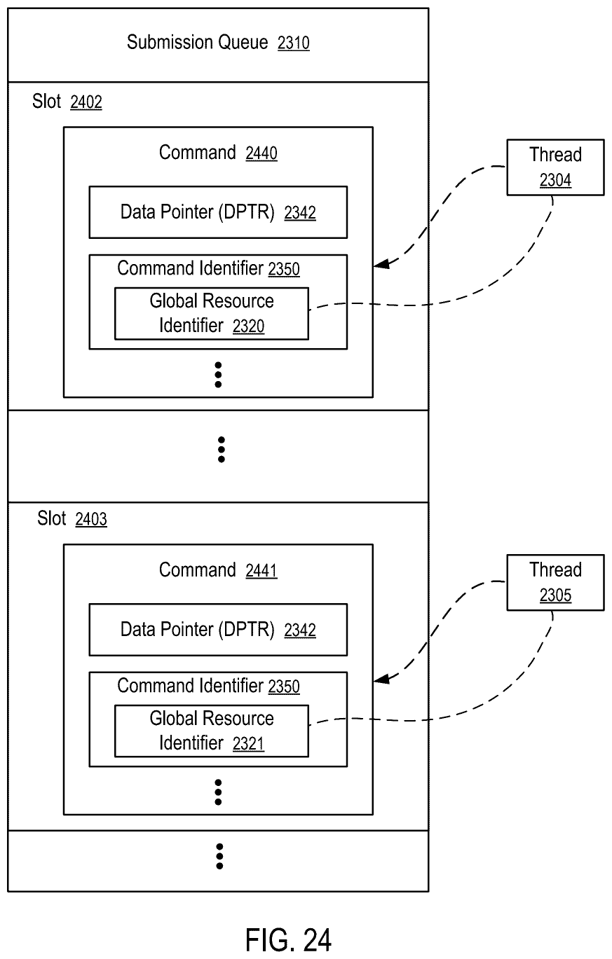

FIG. 24 shows multiple threads each submitting a command to a submission queue 2310 with each command having a different command identifier 2350 based on a unique global resource identifier of the thread according to one embodiment. For example, threads 2304 and 2305 in FIG. 23 can enter commands into a shared submission queue 2310 in a way as illustrated in FIG. 24. For example, thread 2304 submits command 2440 in the submission queue 2310; and thread 2305 submits command 2441 in the submission queue 2310 while the command 2440 is pending in the submission queue 2310. Submission queue 2310 has slots 2402, 2403 in which the commands 2440, 2441 are entered. In one example, slots 2402, 2403 are similar to slots 272, 274 as described in connection with FIG. 2.

Thread 2304 is associated with global resource identifier 2320, and thread 2305 is associated with global resource identifier 2321. When thread 2304 generates command 2440, thread 2304 determines command identifier 2350 based on global resource identifier 2320 (e.g., as described in connection with FIG. 23). When thread 2305 generates command 2441, thread 2305 determines command identifier 2350 based on global resource identifier 2321 (e.g., as described in connection with FIG. 23).

Thread 2304 and thread 2305 are each a submitter of a command to submission queue 2310. Each thread has a different global resource identifier and determines a unique command identifier for the command based on its unique global resource identifier. This avoids the need for the thread to check the contents of and/or lock the submission queue when determining the command identifier. In one example, processing device 2302 assigns global resource identifier 2320 to thread 2304, and global resource identifier 2321 to thread 2305.

In one embodiment, the global resource identifier 2320 can be any unique number. The number does not have to be associated with a resource such as a predefined buffer 2306. In one example, the unique number is a submitter ID.

In one embodiment, a thread uses a series of command identifiers 2350. Each command identifier is determined by appending a serial number with the global resource identifier (GID) of the read. For example, the command identifiers can be GID0, GID1, GID2, etc. In one example, the thread tracks usage of serial numbers using a counter. The thread can recycle the series of command identifiers without needing to enter two pending commands with the same command identifier in the submission queue. Because the global resource identifier is unique, the series of command identifiers of the thread are different from the command identifiers of other threads.

In one embodiment, a memory address used by a submitter in generating a command can be used as the global resource identifier. If the memory address is not globally unique (e.g., a same memory address can be used by two submitters in two different nodes), then a node ID or other unique identifier can be added to the memory address make it globally unique. When the global resource identifier has a size that is too large (e.g., more than 16 bits), a hash of the global resource identifier can be used as at least a portion of a command identifier. Alternatively, a lookup table can be used to associate a submitter ID with the global resource identifier; and the submitter ID can be used as at least a portion of a command identifier.

In at least some embodiments, the host system 102 and the memory sub-system 101 are configured to retrieve data from the memory sub-system 101 not only to a memory location that is accessible to the memory sub-system 101 over a PCIe bus, but also to a cache location that is configured to cache data for the memory location in a processing device connected to the PCIe bus. For example, a mechanism of steering tag in PCIe communications can be used to cause the memory sub-system 101 to send data, during execution of a read command, to a memory address over the PCIe bus to cause the data being read to be sent not only to the memory address, but also to a cache memory configured to cache data for the memory address. Such a technique can avoid the need for a processing device to perform operations to invalidate the content in the cache memory to cause the cache memory to load the data from the memory address for which the cache memory stores data for the processing device. For example, a steering tag value configured to identify the cache memory configured for a region of random access memory can be provided in a read storage command to direct the memory sub-system 101 to generate transaction layer packets in a way to use the mechanism of steering tag to send the data not only to the random access memory but also to the cache memory represented by the steering tag value, as further described below.

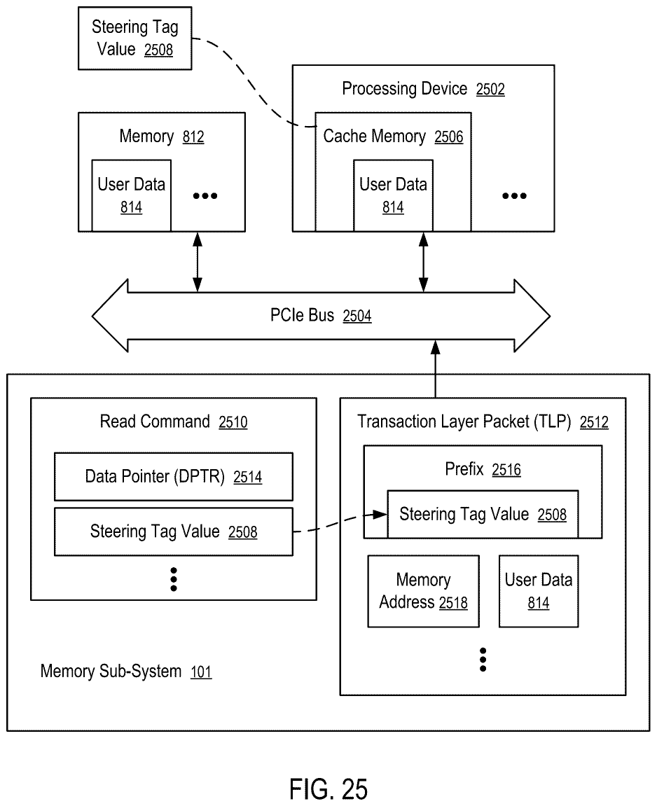

FIG. 25 shows a technique to use a steering tag mechanism to send data to a cache memory 2506 of a processing device 2502 in response to the memory sub-system sending data to a memory address according to one embodiment. Processing device 2502 (e.g., CPU/GPU 262) and memory sub-system 101 (e.g., solid state drive 260) communicate with each other using PCIe bus 2504 (e.g., PCIe bus 266). Processing device 2502 and memory 812 can be configured in a host system (e.g., as 102 in FIG. 1).

In FIG. 25, cache memory 2506 is configured to cache data in memory 812, or a portion of it, for the processing device 2502. The PCIe bus 2504 connects the processing device 2502 and the memory 812 and supports a cache coherent communications protocol. A steering tag value 2508 can be configured to represent, or identify, the cache memory 2506 as being configured to cache the memory 812 (or a portion of it). For example, the processing device 2502 can be a GPU or a processing core among multiple cores in a GPU; and the cache memory 2506 can be an L1 or L2 cache in the GPU.

A read command (e.g., as discussed above) can be used to retrieve data (e.g., user data 814) from a storage space (e.g., storage space 261 as in FIG. 2) of memory sub-system 101. To facilitate the use of a steering tag mechanism of the PCIe bus 2504 to have data delivered to the cache memory, read command 2510 is configured to further include a field to carry a steering tag value, such as the steering tag value 2508 representative of the cache memory 2506. For example, when the command 2510 is generated, the steering tag value 2508 identifying the cache memory 2506 for communications over the PCIe bus 2504 can be inserted into the command 2510 at a predefined location/bit segment in the command 2510.

Read command 2510 also includes data pointer (DPTR) 2514. In one example, data pointer 2514 can be configured as described for data pointer 717 in connection with FIG. 13. In one example, read command 2510 is similar to Type B read command 603 as described in connection with FIG. 6. Memory sub-system 101 retrieves read command 2510 from a submission queue (not shown) configured in a portion of memory 812.

During execution of read command 2510, data retrieved from one or more logical blocks of the storage space in memory sub-system 101 can include user data 814 to be sent via a transaction layer packet 2512 over the PCIe bus 2504. In general, one or more transaction layer packets (e.g., 2512) can be used to transmit the entire set of data requested via the read command 2510. In one example, user data 814 (and other data blocks to be transmitted from the memory sub-system 101) can be retrieved from stored data block 842 during execution of read command 902 as described in connection with FIG. 9.

To send the user data 814 to a location in the memory 812, identified at least in part via the data pointer 2514, during the execution of the read command 2510, memory sub-system 101 creates transaction layer packet (TLP) 2512 and transmits the packet 2512 into the PCIe bus 2504. The memory sub-system 101 can configure the prefix 2516 of TLP 2512 to include the steering tag value 2508 extracted from read command 2510. TLP 2512 can include memory address 2518 determined for the user data 814 based on the memory address provided by data pointer 2514 in read command 2510. According to memory address 2518 and steering tag value 2508 specified in the TLP 2512, the PCIe bus can send user data 814 not only to a location in the memory 812 but also to a corresponding location in cache memory 2506 that caches data for the location in the memory 812.

TLP 2512 includes user data 814 as the payload. The memory sub-system 101 can use one or more TLPs (e.g., 2512) to send the entire set of data being requested via the read command 2510.

In some cases, more than one TLP can be used to write data requested via the read command 2510 to the memory 812 and the cache memory 2506. In one example, multiple TLPs are used to write the data requested via the read command 2510 (e.g., user data 814).

In one example, a host system sets up steering tag value 2508 to identify the cache memory 2506 as an intended destination according to a PCIe protocol. The steering tag value 2508 is provided in the read command 2510 so that the memory sub-system 101 can use it in the steering tag field in a TLP 2512 so that user data 814 as the payload of the TLP 2512 can be delivered to the intended destination in cache memory 2506, in view of the memory address 2518 in the memory 812 and the caching relation between the cache memory 2506 and the memory 812.

The field for holding the steering tag value 2508 can be configured/predefined in any available portion of read command 2510. In one example, the field for steering tag value 2508 can be configured to have a size of eight bits and be located in Dword 14 or 15 of read command 2510.

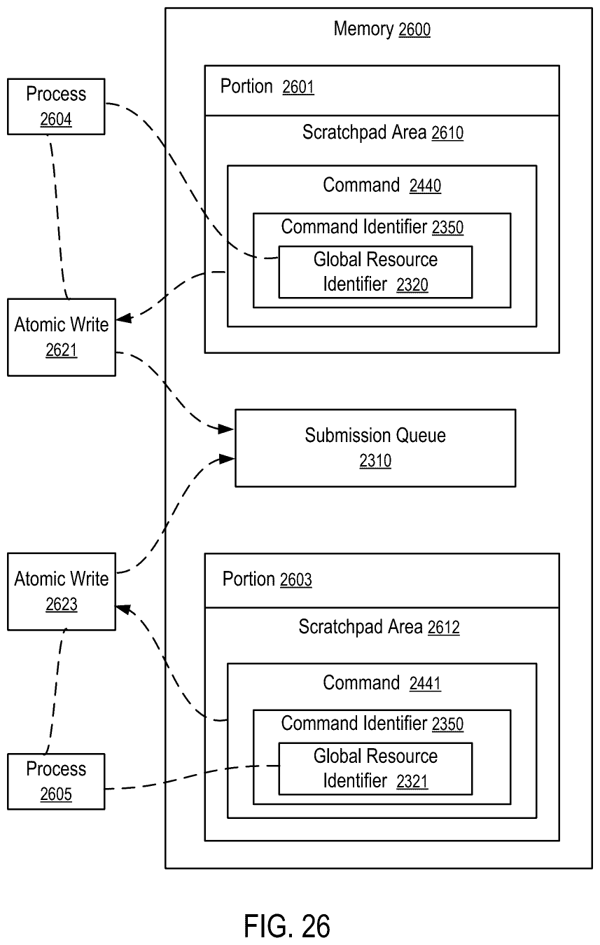

FIG. 26 shows a technique to enter a command into a submission queue 2310 according to one embodiment. Multiple concurrently running processes (e.g., threads in different cores of a CPU, or a GPU, or different GPUs) can each prepare a command in a separate scratchpad area and enter the command to a shared submission queue 2310 via an atomic write. Each command from a respective process is configured to have a different command identifier 2350 based on a unique global resource identifier of the respective process (e.g., as discussed in connection with FIG. 23 and FIG. 24). For example, process 2604 can allocate a scratchpad area 2610 to prepare a command 2440 separately from process 2605 allocating scratchpad area 2612 to prepare command 2441 in parallel without coordination via locking the submission queue 2310.

Portions of memory 2600 are allocated to the processes that share a submission queue 2310 for accessing a memory sub-system 101 via storage access commands (e.g., commands discussed above in connection with FIG. 2 to FIG. 25). For example, portion 2601 is allocated to process 2604, and portion 2603 is allocated to process 2605. Each allocated portion is for the exclusive use of the process to which the portion is allocated and includes a scratchpad area (e.g., 2610, 2612) of memory used by the process in preparing commands for entry to submission queue 2310. In one example, memory 2600 is similar to memory 812 as described in connection with FIG. 23; and each portion allocated for a process can include a buffer (e.g., 2306, 2307) that is assigned to the process. Optionally, separate buffers predefined at the time of boot up (e.g., as discussed in connection with FIG. 13) can be assigned to different processes for their exclusive use, at least during the time of their accessing the memory sub-system 101 using commands entered into the shared submission queue 2310. In one example, memory 2600 is dynamic random access memory (DRAM). In one example, memory 2600 is main memory of a computing device.

Each process (e.g., 2604) can independently prepare a command (e.g., in a scratchpad area of the portion of memory allocated to the process) before the command is entered into submission queue 2310. For example, process 2604 prepares command 2440 in scratchpad area 2610. Process 2605 prepares command 2441 in scratchpad area 2612.

After a command (e.g., 2440) is prepared by a process (e.g., 2604), the process (e.g., 2604) can use an atomic write to copy the command (e.g., 2440) from the area 2610 into the submission queue 2310. For example, process 2604 writes command 2440 to submission queue 2310 using atomic write 2621. The atomic write 2621 ensures that the command 2440 is copied from scratchpad area 2610 to submission queue 2310 without interference from access requests from other concurrently running processes (e.g., 2605). Process 2605 writes command 2441 to submission queue 2310 using atomic write 2623. During the atomic write 2623, command 2441 is copied from scratchpad area 2612 to submission queue 2310. The atomic writes 2621 and 2623 can prevent the copying operations, requested by the concurrently running processes 2604, 2605, from interfering with one another and/or to have a collision, which can cause corruption of the content of commands when writing the commands to submission queue 2310. In one example, each atomic write 2621, 2623 is an x86 atomic write operation. During an atomic write (e.g., 2621 or 2623), the content can be written exclusively to a shared memory (e.g., submission queue) to avoid errors from simultaneous writes. The use of atomic write to copy commands from non-shared memory areas (e.g., 2610 and 2612) can avoid the need to lock the shared submission queue 2310 for entering a command by one of the concurrently running processes (e.g., 2604 and 2605).

In one example, the commands entered by processes 2604 and 2605 in FIG. 26 into a shared submission queue 2310 can be configured to have command identifiers configured for threads 2304 and 2305 as discussed in connection with FIG. 24. For example, process 2604 submits command 2440 in the submission queue 2310; and process 2605 submits command 2441 in the submission queue 2310 while the command 2440 is pending in the submission queue 2310. For example, submission queue 2310 has slots 2402, 2403 in which the commands 2440, 2441 are entered. In one example, slots 2402, 2403 are similar to slots 272, 274 as described in connection with FIG. 2.

Process 2604 is associated with global resource identifier 2320, and process 2605 is associated with global resource identifier 2321. Global resource identifier 2320 identifies a resource to be used during execution of a command submitted by the process 2604, such as buffer 2306 to provide data to be written to the memory sub-system 101 or to receive data retrieved from the memory sub-system 101; and the resource is allocated for exclusive use by the process 2604 at least during the time period between the command being entered into the submission queue 2310 and the completion of the execution of the command in the memory sub-system 101. When process 2604 generates command 2440, process 2604 determines command identifier 2350 based on global resource identifier 2320 (e.g., as described in connection with FIG. 23). When process 2605 generates command 2441, process 2605 determines command identifier 2350 based on global resource identifier 2321 (e.g., as described in connection with FIG. 23). Global resource identifier 2321 identifies a resource to be used during execution of a command submitted by the process 2605, such as buffer 2307 to provide data to be written to the memory sub-system 101 or to receive data retrieved from the memory sub-system 101; and the resource is allocated for exclusive use by the process 2605 at least during the time period between the command being entered into the submission queue 2310 and the completion of the execution of the command in the memory sub-system 101.

Process 2604 and process 2605 are each a submitter of a command to submission queue 2310. Each process has a different global resource identifier and determines a unique command identifier for the command based on its unique global resource identifier. In one example, global resource identifier 2320 is assigned to process 2604, and global resource identifier 2321 to process 2605. By using an atomic write to submit each command to submission queue 2310 in combination with the use of command identifiers based on unique global resource identifiers as described above, multiple processes can share submission queue 2310 and write commands to submission queue 2310 without needing to lock the submission queue (e.g., locking the submission queue to configure a command to have a unique command identifier among commands pending the submission queue and to prevent other processes from accessing the submission queue while the command is being prepared and entered in the submission queue).

In at least some embodiments, the memory sub-system 101 is configured to check consistency between parameters specified by a read or write command retrieved from a submission queue to access a namespace and pre-set parameters associated with the namespace (e.g., set in a way as discussed in connection with FIG. 12). The consistency check can be performed during execution of the read or write command, as further described below. In one example, the retrieved command is a normal command 282 retrieved from submission queue 270. The pre-set parameters are stored from prior processing of one or more commands retrieved from the submission queue. For example, a controller of a memory sub-system can verify whether metadata parameters specified in the read/write command for accessing the namespace are compatible or consistent with attributes currently set for the namespace being accessed by the command. If the parameters are not compatible with the attributes, then the controller can reject the command and report the error in a completion record for the read/write command.

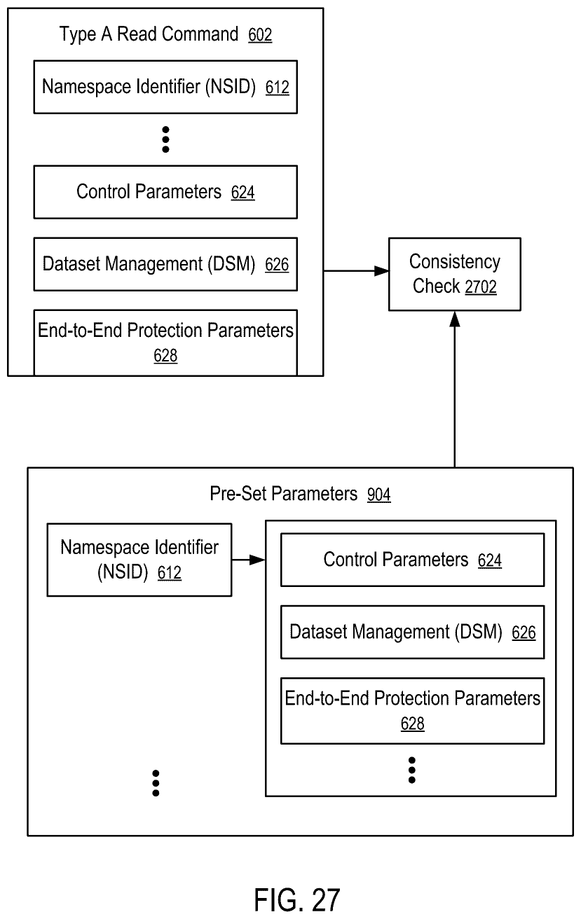

FIG. 27 shows a consistency check 2702 between parameters specified in a read command 602 and pre-set parameters 904 for a namespace identified in the command 602 by namespace identifier (NSID) 612 according to one embodiment. A consistency check 2702 can be similarly performed between parameters specified in a write command (e.g., 702 in FIG. 7) and pre-set parameters 904 for a namespace identified by namespace identifier 712 in the write command (e.g., 702).

In one example, Type A read command 602 includes namespace identifier 612 and various other parameters including control parameters 624, dataset management (DSM) parameters 626, and/or end-to-end protection parameters 628. Pre-set parameters 904 include results from prior firmware processing 818 (e.g., as described in connection with FIG. 12) of control parameters 624, dataset management (DSM) parameters 626, and/or end-to-end protection parameters 628 specified in one or more previously retrieved commands. In one example, the previously retrieved command is a set read/write parameter command 1002 as described in connection with FIG. 10. In one example, the previously retrieved command is an extended Type A read command 602 as described in connection with FIG. 11. The results are stored by a memory sub-system 101 as being associated with namespace identifier 612 such that some commands (e.g., 284, 603, 703, and/or commands having formats illustrated in FIG. 14 to FIG. 19) can be configured with formats that do not have fields for specifying such parameters. When command formats that do not provide fields for specifying such parameters and command formats that do provide fields for such parameters are both supported by the memory sub-system 101, the memory sub-system 101 can be configured to check whether the parameters stored in association with a namespace agree with the parameters specified in commands using formats that include fields for such parameters. Inconsistency typically indicates an error; and in response to an error, the memory sub-system 101 can abort the execution of the command that has fields specifying parameters that are inconsistent with the corresponding parameters set of the namespace being accessed by the command. Optionally, the memory sub-system 101 can include a configuration register to identify a policy for handling inconsistency. For example, the register can be optionally set to have the parameters stored in association with a namespace to take priority over the corresponding parameters specified in a command to access the namespace; and when an inconsistency is detected, the memory sub-system 101 can try to execute the command using the parameters stored in association with the namespace being accessed by the command. Alternatively, the register can be optionally set to have the parameters specified in a command take priority over the corresponding parameters pre-set/stored in association with the namespace being accessed by the command; and when an inconsistency is detected, the memory sub-system 101 can try to execute the command using the parameters provided in the command (and thus ignore the parameters stored in association with the namespace). Optionally, the memory sub-system 101 can report the inconsistency in a completion record for the command. Alternatively, the register can be optionally set to have the parameters specified in a command take priority over the corresponding parameters pre-set/stored in association with the namespace being accessed by the command; and when an inconsistency is detected, the memory sub-system 101 can execute the command using the parameters provided in the command and update the parameters stored in association with the namespace according to the parameters provided in the command, as if the command is an extended type command having its set read/write parameter flag 1102 being set, as in FIG. 11.

In FIG. 27, during execution of the read command 602, memory sub-system 101 performs a consistency check 2702 between parameters specified by read command 602 and corresponding pre-set parameters 904. The memory sub-system 101 uses namespace identifier 612 to identify the pre-set parameters 904 for use in consistency check 2702. For example, consistency is checked between control parameters 624 specified in read command 602 and results from prior processing of control parameters 624 stored as pre-set parameters 904. Consistency can be similarly checked for dataset management parameters 626 and end-to-end protection parameters 628.

If consistency check 2702 determines an incompatibility between one or more parameters of read command 602 and the corresponding pre-set parameters 904, then memory sub-system 101 can reject the read command 602, abort the execution of the read command 602, and generate a completion record for the read command 602 to report the error. Similarly, if consistency check 2702 determines an incompatibility between one or more parameters of a write command 702 and pre-set parameters 904, then memory sub-system 101 can reject the write command 702. Alternatively, based on the setting in a configuration register, the memory sub-system 101 can use the pre-set parameters 904 to replace the corresponding parameters specified in the read command 602 to complete the execution of the command, with a completion record generated to report the use of the pre-set parameters 904. Alternatively, based on the setting in a configuration register, the memory sub-system 101 can use the parameters specified in the read command 602 to update the corresponding parameters 904 pre-set for the namespace and complete the execution of the command, with a completion record generated to report the updating of the parameters 904 pre-set for the namespace. Alternatively, based on the setting in a configuration register, the memory sub-system 101 can complete the execution of the read command 602 using the parameters specified in the read command 602 with a completion record generated to report the inconsistency between the parameters 904 pre-set for the namespace and the corresponding parameters specified in the read command 602.

In one embodiment, setting command 1202 causes a memory sub-system to store pre-set parameters 904 as described in connection with FIG. 12. When receiving subsequent read/write commands, one or more of pre-set parameters 904 can be used in processing the read/write command. In some cases, this allows skipping of firmware processing 818. In one example, the read/write commands include both normal commands 282 and fast commands 284. In one example, the read/write commands include both Type A read/write commands and Type B read/write commands.

In at least some embodiments, read or write commands can have a format that includes a field usable to carry an indication, suggest, or hint usable for the memory sub-system 101 to manage retention of data loaded into the local memory during the execution of the commands, as further described below as data retention indicator field. For example, a value can be specified in the data retention indicator field to indicate that data read from or written to a logical block in a storage space is to be retained in local memory for an extended period of time at least until the execution of a next command configured to access the same logical block. The value indicates that a further command is expected to be issued to access the same logical block; and the data retained in the local memory can be used to accelerate the execution of the further command. Subsequently, when the further command is sent for execution in the memory sub-system to access the same logical block, the memory sub-system 101 can reuse the data retained in the local memory without having to read the same data from the logical block again.

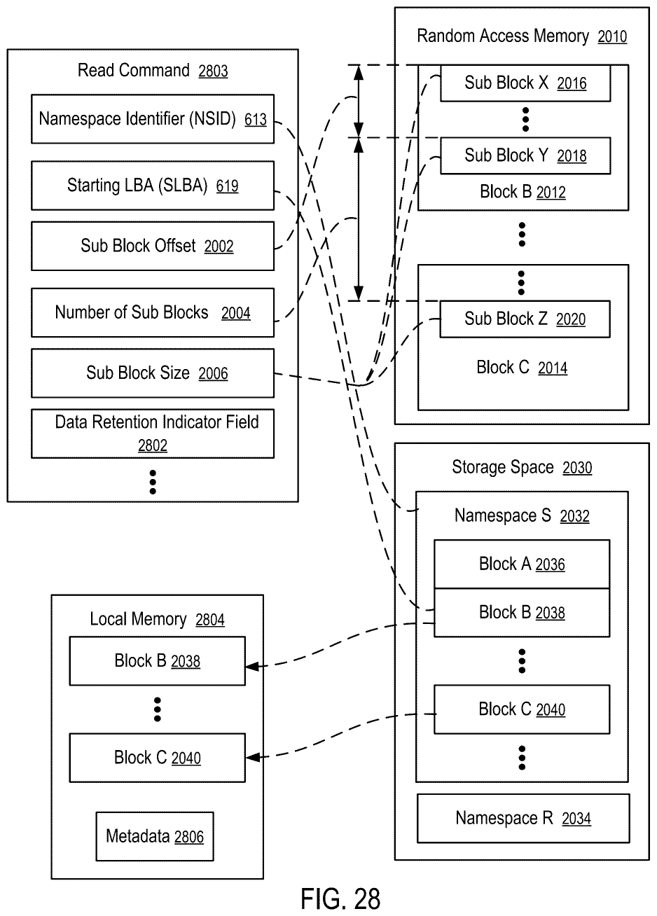

FIG. 28 shows a read command 2803 having a data retention indicator field 2802 that can carry a predetermined value to indicate retention of read data in a local memory 2804 according to one embodiment. In one example, local memory 2804 is memory 280 of solid-state drive 260. Another predetermined value can be specified in the data retention indicator field 2802 to indicate that no retention of data as read into the local memory 2804 during the execution of the read command 2803 is requested. In one example, read command 2803 has a format similar to a Type B read command 603 as described in connection with FIG. 6 except that data retention indicator field 2802 is added to the format (e.g., in an otherwise reserved or unused bit segment of the command 603). In general, any of the commands discussed above can be modified to include a data retention indicator field 2802 as in FIG. 28.

The parameters of read command 2803 can be configured to cause the memory sub-system 101 to retrieve data from one or more logical blocks (e.g., block B 2038 to block C 2040) in storage space 2030 during the execution of the read command 2803. In some instances, only a portion of the retrieved data is sent to a destination location identified in the read command 2803 (e.g., as discussed above in connection with FIG. 20 to FIG. 22). During execution of read command 2803, each of the entire logical blocks is read. The value specified in data retention indicator field 2802 indicates a manner of handling retention of the data read from the entire logical blocks. In one example, one value can indicate that data retention is not necessary. In one example, another value can indicate that data is to be retained after execution of the command 2803 is completed for use by one or more subsequent commands retrieved from a submission queue. In one example, the value provided in the field 2802 can indicate that the data is retained for a specified period of time (e.g., 5 seconds).

When the data read from the indicated logical blocks is indicated to be retained, the read data (e.g., data read from block B 2038 to block C 2040) is not deleted from the local memory 2804, at least until the execution of a further command that is configured to access one of the logical blocks (or the same set of logical blocks) or until the memory sub-system 101 decides to free the portion of the local memory 2804 occupied by the retained data in order to avoid blocking the execution of other commands for the lack of resources in the local memory 2804. The memory sub-system 101 can store metadata 2806 tracking the locations in the local memory 2804 having data stored for logical blocks in the storage space 2030. When the memory sub-system 101 executes a command, the memory sub-system 101 can use the metadata 2806 to determine whether the data needed for execution of the command is already in the local memory 2804. The retained data can be used by one or more subsequent commands (e.g., a subsequent command that accesses at least one same logical block accessed by read command 2803). For example, a subsequent read command can read one or more sub blocks from the retained data instead of accessing the storage media that implements storage space 2030. For example, a subsequent write command can perform a read-modify-write operation to write a sub block without needing to read data from storage space 2030. Instead, the sub block to be written can be combined with existing data retained in local memory 2804.

In one embodiment, the value specified by data retention indicator field 2802 can provide information to memory sub-system 101 regarding an expected future usage of the data being accessed by the current command. For example, the value can indicate an expected time until the data is used again. For example, the value can indicate a processing priority for the data. Such hints provided by the specified value can help the memory sub-system 101 to manage (e.g., optimize) operations and/or resource usage. For example, a solid-state drive can prioritize data retention in local memory 2804 based on hints provided by one or more values specified in data retention indicator field 2802 of one or more prior read/write commands.

The read command 2803 specifies an offset and a data length via sub block size 2006, a sub block offset 2002, and number of sub blocks 2004 for reading one or more sub blocks from a storage space 2030 during execution of the read command 2803. Storage space 2030 is partitioned into namespaces such as Namespace S 2032 and Namespace R 2034. Each namespace stores data in logical blocks using LBA addressing. Storage space 2030 is an example of storage space 261 of FIG. 2.

Namespace S 2032 is partitioned into blocks of a same size (e.g., LBA Size), such as blocks A 2036, B 2038, . . . , C 2040. Read command 2803 can be configured to specify one or more sub blocks to be read from the logical blocks of Namespace S 2032. Read command 2803 includes namespace identifier (NSID) 613 to identify the namespace (e.g., Namespace S 2032) from which the sub blocks are read.

Read command 2803 includes starting LBA (SLBA) 619 to identify the first logical block in the namespace identified by namespace identifier 613 from which data will be read. For example, starting LBA 619 identifies that block B 2038 is the first logical block from which one or more sub blocks are read. Block B 2038 can be mapped by a flash translation layer of the memory sub-system 101 to a block of non-volatile memory cells of the memory sub-system 101, such as memory cells storing a data block 842 as illustrated in FIG. 9.

Read command 2803 identifies the sub blocks to be read from the namespace identified in the command by specifying sub block offset 2002, number of sub blocks 2004, and sub block size 2006. Sub block offset 2002 specifies where the data transfer begins inside the block 2038 identified by the starting LBA 619 during the execution of the read command 2803 of FIG. 28. During the execution of the read command 2803, the memory sub-system 101 retrieves the entire data from the block 2038 in the namespace 2032. The retrieved data from the block 2038 can have sub blocks 2016, . . . , 2018, etc. The memory sub-system 101 can discard the sub blocks before the sub block 2018 as identified by the sub block offset 2002, and only send one or more sub blocks starting with sub block 2018 to the random access memory 2010. The sub block 2018 is stored into the random access memory 2010 at a location identified via a data pointer specified in the read command 2803.

The combination of number of sub blocks 2004 and sub block size 2006 specifies a data length. In one example, the data length can extend over multiple logical blocks. Also, the range of data represented by the data length is not necessarily aligned with a logical block boundary; and sub block offset 2002 specifies an offset from the logical block boundary corresponding to a starting LBA address specified in starting LBA field 619. The ending portion of the range is not necessarily aligned with the end of the last block (e.g., 2030 in the namespace 2032 and block 2014 in the random access memory 2010). During the execution of the read command 2803, the entire block 2040 is read in the memory sub-system 101. However, the memory sub-system 101 skips sending the data following the last sub block 2020 as identified via the data length (via number of sub blocks 2004).

In the example illustrated in FIG. 20, the combination of starting LBA 619 and the namespace identifier 613 identifies block B 2038. Sub block offset 2002 and number of sub blocks 2004 identify a range of consecutive blocks 2038 to 2040 to be read from Namespace S 2032. A memory sub-system (e.g., solid-state drive 260) reads data from the logical blocks 2038 to 2040 to retrieve the sub blocks 2018 to 2020. The memory sub-system extracts and transfers the identified sub blocks 2018 to 2020 to a location in random access memory 2010 as identified by a data pointer specified in the read command 2803, which can be in a host system 102 as in FIG. 1.

If the value specified by data retention indicator field 2802 indicates that read data is to be retained, then the entire data read from logical blocks 2038 to 2040 is retained in local memory 2804 for use by one or more subsequent read or write commands.

After the execution of the read command 2803, random access memory 2010 stores data read from storage space 2030. The data includes the number of sub blocks 2004 (e.g., 2018, . . . , 2020) as specified in the read command 2803, which corresponds to data retrieved from logical blocks identified via the namespace identifier 613 and the starting LBA 619 specified in the read command 2803. For example, random access memory 2010 includes block B 2012 and block C 2014, which correspond to data read from block B 2038 and block C 2040 of storage space 2030. For example, the random access memory 2010 can be configured in memory 106 of the host system 102 as in FIG. 1, or memory 264 outside of the memory sub-system 101 as in FIG. 2.

Various other types of commands or command formats can be configured to cause retention of logical block data in local memory 2804. For example, a normal read command 282 can use a reserved field to indicate the request to retain data. For example, a new command can use an opcode that represents operations of read/write and retain data. A data retention option can be indicated by a newly configured option field (e.g., as an attribute of a namespace). Optionally, a command can be used to cause a data retention mode of memory sub-system 101 to persist over more than one read/write command (e.g., multiple subsequent read/write commands will use logical block data stored in local memory 2804); and another command can be used to turn off the data retention mode.

In some cases, a write command can be configured to cause retention, in local memory 2804, of data being written to logical blocks in the storage space 2030. Optionally, a write command can have an option to instruct the memory sub-system 101 to write only to the retained version of data stored in local memory 2804 (e.g., this can delay writing the data to NAND storage media; and the memory sub-system 101 can store data indicating the data in the logical blocks in the storage space 2030 resides in the local memory 2804, instead of in the Non-Volatile Memory Cell Array 840).

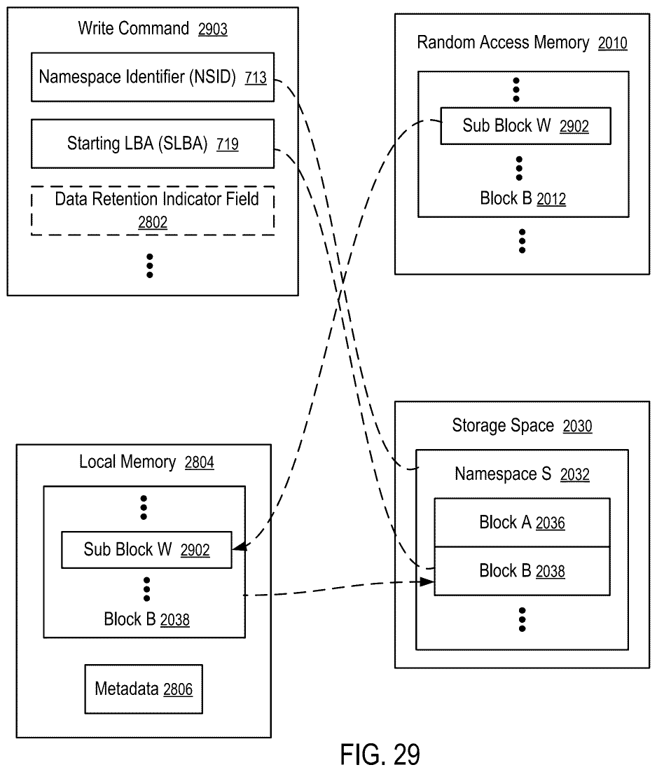

FIG. 29 shows a write command 2903 used to write a sub block in a logical block of a storage space using data previously read from the logical block and retained in local memory 2804 during execution of a prior read command according to one embodiment. In one example, write command 2903 has a format similar to Type B write command 703 as described in connection with FIG. 7. Optionally, write command 2903 is configured according to a command format that includes data retention indicator field 2802 (e.g., via augmenting any of the write commands discussed above to include the data retention indicator field 2802).

When executing write command 2903, memory sub-system 101 determines (e.g., from the metadata 2806 discussed above in connection with FIG. 28) that the logical block specified by write command 2903 into which a sub block will be written has been previously retained in local memory 2804 from execution of a prior read or write command. For example, write command 2903 specifies that sub block W 2902 be written in logical block B 2038 in the storage space 2030. Memory sub-system 101 determines that the data of the block B 2038 is still in local memory 2804 (e.g., as a result of execution of read command 2803 as described in connection with FIG. 28). In response to such a determination, the memory sub-system 101 can combine the sub block W 2902 retrieved from the random access memory 2010 with the existing data for block B 2038 in local memory 2804 to generate the complete data for block 2038 in the storage space 2030 and write the complete data to the storage space 2030. In contrast, when the data of the block B 2038 is not already in the local memory 2804, the memory sub-system 101 is to read the data of the block B 2038 from the storage space 2030 into the local memory 2804 in order to generate the complete data for the block 2038 for writing the sub block 2902 provided in the random access memory 2010.

In one embodiment, memory sub-system 101 maintains a mapping/metadata (e.g., use of metadata 2806 as described in connection with FIG. 28) in the local memory 2804 that identifies LBA addresses for logical blocks in storage space 2030 that have had data retained in local memory 2804 (e.g., when executing a prior command indicating that data is to be retained based on the value specified by data retention indicator field 2802). When a further command is executed (e.g., write command 2903), the memory sub-system 101 can determine, from the mapping/metadata, if the further command is accessing one or more logical blocks that have been retained in local memory 2804.

In one example, write command 2903 includes namespace identifier 713, starting LBA 719, sub block offset 2002, number of sub blocks 2004, and sub block size 2006. Write command 2903 can be executed to write one or more sub blocks provided by the host system 102 (e.g., sub block W 2902) to Namespace S 2032 in one or more blocks identified by write command 2903. When the write command 2903 is configured to provide a portion of a block (e.g., 2038 without the data before or after the sub block 2902), the memory sub-system 101 is configured to use the data retained in local memory 2804 for the block 2038 to obtain the existing data in regions of block 2038 other than sub block W 2902 and then combine the data retained in local memory 2004 and the data from the random access memory 2010 (e.g., the sub block 2902 and the remaining portions that precede and follow the sub block 2902 in the block 2038 to form a complete data block for writing back to the namespace 2032 at the starting LBA 619).

In one embodiment, write command 2903 includes data retention indicator field 2802. The value specified by data retention indicator field 2802 can indicate that data being written to block B 2038 is to be retained. In this case, block B 2038 including sub block W 2902 is retained in local memory 2804 for use by a subsequent read or write command following completion of execution of write command 2903.

In one example, a first command causes retention of data for a logical block in local memory 2804 based on a value specified in a data retention indicator field 2802 of the first command. The second command that follows the first command accesses the same logical block, but does not include data retention indicator field 2802. In one example, the second command is a normal command 282. In one example, the second command does not include data retention indicator field 2802 and is configured to have a format as described in connection with FIG. 14 to FIG. 19. Alternatively, the second command can include data retention indicator field 2802 (e.g., configured via adding the field 2802 to the command formats described in connection with FIG. 14 to FIG. 19); and the second command can specify, in the data retention indicator field 2802, a value to request the data be further retained in the local memory 2804, a value not to request the data be further retained, a value to request release of retention of the data, a value indicating a priority for further retaining the data, or a value indicating a time period for further retaining the data, etc.

In one example, the first command that causes retention of data is a normal command 282 that has been augmented to include data retention indicator field 2802. For example, data retention indicator field 2802 can be configured in bit segments of a reserved field in normal command 282.

In one example, space allocated from local memory 2804 to store retained data from execution of a first command can be released automatically after a second command accesses the same LBA block, unless the second command further requests retention. The memory sub-system 101 can implement a best-effort to retain the data in response to a request specified in a Data Retention Indicator 2802 in that when there is sufficient free resources in the local memory 2804, the memory sub-system 101 can keep the data as requested in the local memory 2804; however, when there are not sufficient resources for other operations, the memory sub-system 101 can terminate the effort of retaining the data for a further period of time. Optionally, the memory sub-system 101 can be configured with a threshold, such that after retaining the data in the local memory 2804 for a period longer than the threshold, the memory sub-system 101 can stop retaining the data, and free the memory resources used to retain the data in the local memory 2804.

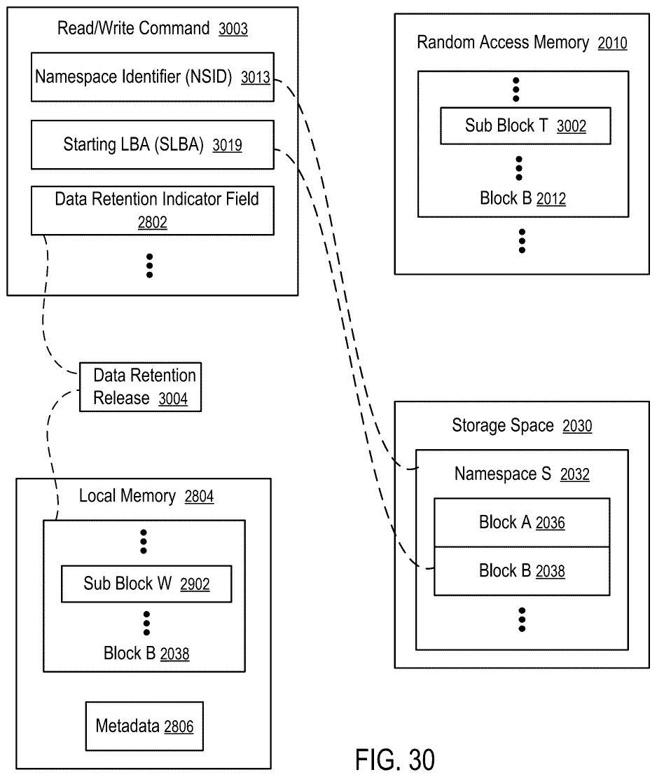

FIG. 30 shows a read/write command 3003 having a data retention indicator field 2802 that can be configured to specify a value to indicate release of data read from or written to a logical block and retained in local memory 2804 during execution of the read or write command (and/or a prior command addressing the same logical block) according to one embodiment. In one example, read/write command 3003 is similar to read command 2803 or write command 2903 as described in connection with FIG. 28 and FIG. 29.

Read/write command 3003 includes namespace identifier 3013 and starting LBA 3019 that specify block B 2038 as the first logical block to be accessed. In one example, read/write command 3003 specifies that only a single logical block is accessed to read sub block T 3002 from, or write sub block T 3002 to, block B 2038.

In one embodiment, the value specified by data retention indicator field 2802 indicates a data retention release 3004 for data previously retained in local memory 2804 for the logical block (e.g., block B 2038) specified by read/write command 3003. As a result, memory sub-system 101 no longer retains data stored in local memory 2804 for block B 2038 from execution of the command 3003 (and/or prior execution of read command 2803 or write command 2903 that causes the data retention for the logical block).

In one embodiment, the value specified by data retention indicator field 2802 can indicate that all data retained in local memory 2804 for any logical blocks from execution of any prior read or write commands can be released and no longer needs to be retained.

In various cases, memory sub-system 101 can release logical block data retained in local memory 2804 without requiring that a data retention release 3004 be indicated by the value specified in data retention indicator field 2802. For example, release of retained data may occur automatically upon expiration of a time limit. Retained data can be released when available space in local memory falls below a threshold.

In one embodiment, each command that requests retention of data has a priority. For example, a priority for retaining the data used during execution of a command can be based on a priority level identified in the data retention indicator field 2802 and/or based on lapsed time since the execution of the command. Increased lapsed time can decrease the priority of retaining the data. Retained data from execution of a command having a lower priority can be released prior to releasing data retained from execution of a command having a higher priority.

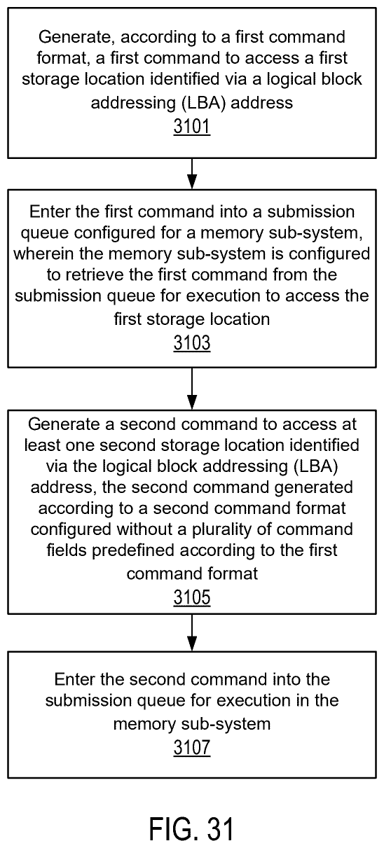

Various methods are shown by FIG. 31 to FIG. 45 and described below. Each method can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, each method is performed at least in part by the processing device 118 of the host system 102, the controller 115 of the memory sub-system 101, and/or the local media controller 105 of the memory sub-system 101 in FIG. 1. In one example, each method can be implemented using the firmware 113 of FIG. 1 to perform the operations illustrated in FIGS. 2-45.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

FIG. 31 shows a method for generating commands according to different command formats, according to one embodiment. At block 3101, a first command is generated, according to a first command format, to access a first storage location identified via a logical block addressing (LBA) address.

At block 3103, the first command is entered into a submission queue configured for a memory sub-system, wherein the memory sub-system is configured to retrieve the first command from the submission queue for execution to access the first storage location.

At block 3105, a second command is generated to access at least one second storage location identified via the logical block addressing (LBA) address, the second command generated according to a second command format configured without a plurality of command fields predefined according to the first command format.

At block 3107, the second command is entered into the submission queue for execution in the memory sub-system.

In some aspects, the techniques described herein relate to a computing device, including: a memory, wherein a submission queue is configured in the memory for a memory sub-system operable to execute a first command retrieved from the submission queue and generated according to a first command format; and at least one processing device coupled to the memory and configured to: generate a second command according to a second command format configured without a plurality of command fields predefined according to the first command format; and enter the second command into the submission queue for execution in the memory sub-system.

In some aspects, the techniques described herein relate to a computing device, further including: the memory sub-system; and a peripheral bus coupled between the memory sub-system and the memory.

In some aspects, the techniques described herein relate to a computing device, wherein the at least one processing device is further configured to, prior to the second command being entered into the submission queue: generate a third command specifying, in association with an identifier of a namespace, parameters configured to be specified in the plurality of command fields in the first command format; wherein the memory sub-system is configured to execute the third command to store the parameters in association with the namespace and execute the second command using the parameters stored in associating with the namespace based on the second command including the identifier of the namespace.

In some aspects, the techniques described herein relate to a computing device, wherein the submission queue and the first command format are according to a standard for non-volatile memory express (NVMe); wherein both the first command and the second command are configured for a same type of operations; and wherein the type is read or write.

In some aspects, the techniques described herein relate to a computing device, wherein the plurality of command fields include fused operation, dataset management, or end-to-end protection parameters, or any combination thereof.

In some aspects, the techniques described herein relate to a computing device, wherein the second command is configured to access a first portion of a logical block identified in the second command but not a second portion of the logical block.

In some aspects, the techniques described herein relate to a computing device, wherein the second command is configured to access plurality of non-contiguous portions of a namespace identified via in the second command.

In some aspects, the techniques described herein relate to a computing device, wherein the memory sub-system is configured to execute the second command faster than execution of the first command.

In some aspects, the techniques described herein relate to a method, including: generating, in a computing device and according to a first command format, a first command to access a first storage location identified via a logical block addressing (LBA) address; entering, by the computing device, the first command into a submission queue configured for a memory sub-system, wherein the memory sub-system is configured to retrieve the first command from the submission queue for execution to access the first storage location; generating, in the computing device, a second command to access at least one second storage location identified via the logical block addressing (LBA) address, the second command generated according to a second command format configured without a plurality of command fields predefined according to the first command format; and entering, by the computing device, the second command into the submission queue for execution in the memory sub-system.

In some aspects, the techniques described herein relate to a method, wherein the submission queue and the first command format are according to a standard for non-volatile memory express (NVMe).

In some aspects, the techniques described herein relate to a method, wherein both the first command and the second command are configured to read from, or write to, the memory sub-system; and the second command is incompatible with the standard for non-volatile memory express (NVMe) in at least one aspect.

In some aspects, the techniques described herein relate to a method, wherein the at least one aspect includes opcode and elimination of the plurality of command fields.

In some aspects, the techniques described herein relate to a method, wherein the plurality of command fields include fused operation, dataset management, or end-to-end protection parameters, or any combination thereof.

In some aspects, the techniques described herein relate to a method, wherein the first storage location includes a logical block represented by the logical block addressing (LBA) address; and the at least one second storage location includes a first portion of the logical block but not a second portion of the logical block.

In some aspects, the techniques described herein relate to a method, wherein the at least one second storage location includes a plurality of non-contiguous portions of a namespace containing the logical block.

In some aspects, the techniques described herein relate to a method, further including, prior to the second command being entered into the submission queue: generating a third command specifying, in association with an identifier of the namespace, parameters configured to be specified in the plurality of command fields in the first command format; wherein the memory sub-system is configured to execute the third command to store the parameters in association with the namespace and execute the second command using the parameters stored in associating with the namespace based on the second command including the identifier of the namespace.

In some aspects, the techniques described herein relate to a method, wherein the first storage location is same as the at least one second storage location; and the memory sub-system is configured to execute the second command faster than execution of the first command.

In some aspects, the techniques described herein relate to a non-transitory computer storage medium storing instructions which, when executed by a computing device, cause the computing device to perform a method, including: configuring, in a memory, a submission queue for a memory sub-system operable to execute a first command retrieved from the submission queue and generated according to a first command format; generating a second command to access according to a second command format configured without a plurality of command fields predefined according to the first command format; and entering, by the computing device, the second command into the submission queue for execution in the memory sub-system.

In some aspects, the techniques described herein relate to a non-transitory computer storage medium, wherein the method further includes, prior to the second command being entered into the submission queue: generating a third command specifying, in association with an identifier of a namespace, parameters configured to be specified in the plurality of command fields in the first command format; wherein the memory sub-system is configured to execute the third command to store the parameters in association with the namespace and execute the second command using the parameters stored in associating with the namespace based on the second command including the identifier of the namespace.

In some aspects, the techniques described herein relate to a non-transitory computer storage medium, wherein the memory sub-system is configured to execute the second command faster than execution of the first command.

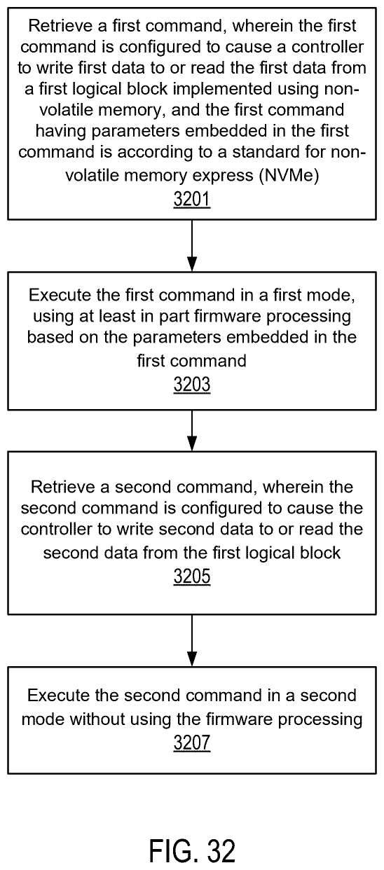

FIG. 32 shows a method for executing a first read or write command using firmware processing and executing a second read or write command without using the firmware processing according to one embodiment. At block 3201, a first command is retrieved, wherein the first command is configured to cause a controller to write first data to or read the first data from a first logical block implemented using non-volatile memory, and the first command having parameters embedded in the first command is according to a standard for non-volatile memory express (NVMe).

At block 3203, the first command is executed in a first mode, using at least in part firmware processing based on the parameters embedded in the first command.

At block 3205, a second command is retrieved, wherein the second command is configured to cause the controller to write second data to or read the second data from the first logical block.

At block 3207, the second command is executed in a second mode without using the firmware processing.

In one embodiment, the first and second command can be generated as described in connection with the process of FIG. 31.

In some aspects, the techniques described herein relate to a memory sub-system including: non-volatile memory; and at least one controller configured to: retrieve a first command, wherein the first command is configured to cause the controller to write first data to or read the first data from a first logical block implemented using the non-volatile memory, and the first command having parameters embedded in the first command is according to a standard for non-volatile memory express (NVMe); execute the first command in a first mode, using at least in part firmware processing based on the parameters embedded in the first command; retrieve a second command, wherein the second command is configured to cause the controller to write second data to or read the second data from the first logical block; and execute the second command in a second mode without using the firmware processing.

In some aspects, the techniques described herein relate to a memory sub-system, wherein the first command includes a first field configured at a predetermined location in the first command according to the standard for NVMe, a parameter provided in the first field is processed when executing the first command to write the first data, a field definition pre-specified for the second command does not include the first field being configured at the same predetermined location in the second command, and a content provided at the same predetermined location in the second command is ignored when executing the second command.

In some aspects, the techniques described herein relate to a memory sub-system, wherein the first field is a fused operation field.

In some aspects, the techniques described herein relate to a memory sub-system, wherein the first field is a control parameters field.

In some aspects, the techniques described herein relate to a memory sub-system, wherein the first field is a dataset management field.

In some aspects, the techniques described herein relate to a memory sub-system, wherein the first field is an end-to-end protection parameters field.

In some aspects, the techniques described herein relate to a memory sub-system, wherein the first data is transferred between the memory location identified via the first command and a first storage location in a storage space identified via a logical block addressing (LBA) address provided in the first command.

In some aspects, the techniques described herein relate to a memory sub-system, wherein the storage location is further identified via a namespace identifier provided in the first command.

In some aspects, the techniques described herein relate to a memory sub-system, wherein the namespace identifier is specified in the first command in byte segment 7:4.

In some aspects, the techniques described herein relate to a memory sub-system, wherein the namespace identifier is specified in each of the first and second commands in accordance with an NVMe standard.

In some aspects, the techniques described herein relate to a memory sub-system, wherein each of the first and second commands has a predetermined length of 512 bits.

In some aspects, the techniques described herein relate to a memory sub-system, wherein a value of the first opcode is 0x01 or 0x02.

In some aspects, the techniques described herein relate to a memory sub-system, including: non-volatile memory; and a controller configured to: retrieve a first read command from a submission queue, the command including: a first opcode configured to cause the controller to read data from the non-volatile memory; a logical block addressing (LBA) address identifying a block in a logical storage space partitioned into a plurality of logical blocks of a common size; and a memory address in random access memory; and execute the first read command to transfer the data from the block to the random access memory according to the memory address; wherein the first opcode is different from a second opcode according to a standard for non-volatile memory express (NVMe); wherein when the first opcode in the first read command is replaced with the second opcode to generate a second read command, the second read command includes a plurality of bit segments configured to provide parameters according to the standard for non-volatile memory express (NVMe) to read the data from the logical block address; and wherein the controller is configured to, in response to the first opcode being specified in the first read command, skip processing of the plurality of bit segments in execution of the first read command.

In some aspects, the techniques described herein relate to a memory sub-system, wherein a value of the second opcode is 0x02.

In some aspects, the techniques described herein relate to a memory sub-system, wherein the parameters according to the standard include a fused operation parameter.

In some aspects, the techniques described herein relate to a memory sub-system, wherein the parameters according to the standard relate to end-to-end protection.

In some aspects, the techniques described herein relate to a memory sub-system, wherein each of the first and second read commands has a predetermined length of 512 bits.

In some aspects, the techniques described herein relate to a memory sub-system, including: non-volatile memory; and a controller configured to: retrieve a first write command from a submission queue, the command including: a first opcode configured to cause the controller to write data to the non-volatile memory; a logical block addressing (LBA) address identifying a block in a logical storage space partitioned into a plurality of logical blocks of a common size; and a memory address in random access memory; and execute the first write command to transfer the data to the block from the random access memory according to the memory address; wherein the first opcode is different from a second opcode according to a standard for non-volatile memory express (NVMe); wherein when the first opcode in the first write command is replaced with the second opcode to generate a second write command, the second write command includes a plurality of bit segments configured to provide parameters according to the standard for non-volatile memory express (NVMe) to write the data to the logical block address; and wherein the controller is configured to, in response to the first opcode being specified in the first write command, skip processing of the plurality of bit segments in execution of the first write command.

In some aspects, the techniques described herein relate to a memory sub-system, wherein a value of the second opcode is 0x01.

In some aspects, the techniques described herein relate to a memory sub-system, wherein the parameters according to the standard are control parameters.

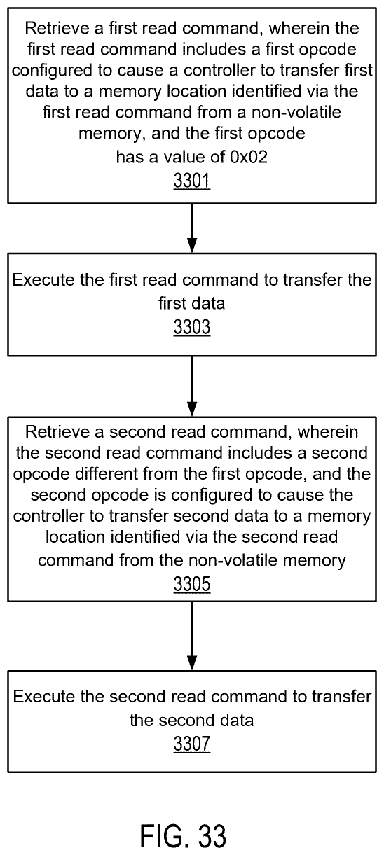

FIG. 33 shows a method for retrieving and executing read commands having different opcodes according to one embodiment. At block 3301, a first read command is retrieved, wherein the first read command includes a first opcode configured to cause the controller to transfer first data to a memory location identified via the first read command from the non-volatile memory, and the first opcode has a value of 0x02.

At block 3303, the first read command is executed to transfer the first data.

At block 3305, a second read command is retrieved, wherein the second read command includes a second opcode different from the first opcode, and the second opcode is configured to cause the controller to transfer second data to a memory location identified via the second read command from the non-volatile memory.

At block 3307, the second read command is executed to transfer the second data.

In one embodiment, the read commands can be generated as described in connection with the process of FIG. 31, and/or the first read command can be executed using firmware processing and the second read command can be executed without using the firmware processing as described in connection with the process of FIG. 32.

In some aspects, the techniques described herein relate to a memory sub-system including: non-volatile memory; and at least one controller configured to: retrieve a first read command, wherein the first read command includes a first opcode configured to cause the controller to transfer first data to a memory location identified via the first read command from the non-volatile memory, and the first opcode has a value of 0x02; execute the first read command to transfer the first data; retrieve a second read command, wherein the second read command includes a second opcode different from the first opcode, and the second opcode is configured to cause the controller to transfer second data to a memory location identified via the second read command from the non-volatile memory; and execute the second read command to transfer the second data.

In some aspects, the techniques described herein relate to a memory sub-system, wherein the first read command includes a first field configured at a predetermined location in the first read command according to the standard for NVMe, a parameter provided in the first field is processed when executing the first read command to write the first data, a field definition pre-specified for the second command does not include the first field being configured at the same predetermined location in the second read command, and a content provided at the same predetermined location in the second read command is ignored when executing the second read command.

In some aspects, the techniques described herein relate to a memory sub-system, wherein the first field is a fused operation field.

In some aspects, the techniques described herein relate to a memory sub-system, wherein the first field is a control parameters field.

In some aspects, the techniques described herein relate to a memory sub-system, wherein the first field is a dataset management field.

In some aspects, the techniques described herein relate to a memory sub-system, wherein the parameter provided in the first field relates to end-to-end protection.

In some aspects, the techniques described herein relate to a memory sub-system, wherein the first data is transferred to the memory location identified via the first read command from a first storage location in a storage space identified via a logical block addressing (LBA) address provided in the first read command.

In some aspects, the techniques described herein relate to a memory sub-system, wherein the storage location is further identified via a namespace identifier provided in the first read command.

In some aspects, the techniques described herein relate to a memory sub-system, wherein the namespace identifier is specified in the first read command in byte segment 7:4.

In some aspects, the techniques described herein relate to a memory sub-system, wherein the namespace identifier is specified in each of the first and second read commands in accordance with an NVMe standard.

In some aspects, the techniques described herein relate to a memory sub-system, wherein each of the first and second read commands has a predetermined length of 512 bits.

In some aspects, the techniques described herein relate to a memory sub-system, wherein the first opcode is according to a standard for non-volatile memory express (NVMe) of August 2024.

In some aspects, the techniques described herein relate to a memory sub-system, including: non-volatile memory; and a controller configured to: retrieve a first command, the command including: a first opcode configured to cause the controller to read data from the non-volatile memory; a logical block addressing (LBA) address identifying a block in a logical storage space partitioned into a plurality of logical blocks of a common size; and a memory address in random access memory; and execute the first command to transfer the data from the block to the random access memory according to the memory address; wherein the first opcode is different from a second opcode according to a standard for non-volatile memory express (NVMe); wherein when the first opcode in the first command is replaced with the second opcode to generate a second command, the second command includes a plurality of bit segments configured to provide parameters according to the standard for non-volatile memory express (NVMe) to read the data from the logical block address; and wherein the controller is configured to, in response to the first opcode being specified in the first command, skip processing of the plurality of bit segments in execution of the first command.

In some aspects, the techniques described herein relate to a memory sub-system, wherein a value of the second opcode is 0x02.

In some aspects, the techniques described herein relate to a memory sub-system, wherein the parameters according to the standard include a fused operation parameter.

In some aspects, the techniques described herein relate to a memory sub-system, wherein the parameters according to the standard relate to end-to-end protection.

In some aspects, the techniques described herein relate to a memory sub-system, wherein each of the first and second commands has a predetermined length of 512 bits.

In some aspects, the techniques described herein relate to a memory sub-system, including: non-volatile memory; and a controller configured to: retrieve a first command from a submission queue, the command including: a first opcode configured to cause the controller to read data from the non-volatile memory; a logical block addressing (LBA) address identifying a block in a logical storage space partitioned into a plurality of logical blocks of a common size; and a memory address in random access memory; and execute the first command to retrieve the data from a portion of the non-volatile memory allocated to implement the block represented by the logical block addressing (LBA) address, and store the data to the random access memory according to the memory address; wherein the first opcode is different from a second opcode according to a standard for non-volatile memory express (NVMe); wherein when the first opcode in the first command is replaced with the second opcode to generate a second command, the second command includes a plurality of bit segments configured to provide parameters according to the standard for non-volatile memory express (NVMe) to read the data from the logical block address; and wherein the controller is configured to, in response to the first opcode being specified in the first command, skip processing of the plurality of bit segments in execution of the first command.

In some aspects, the techniques described herein relate to a memory sub-system, wherein the parameters according to the standard include control parameters.

In some aspects, the techniques described herein relate to a memory sub-system, wherein the parameters according to the standard relate to dataset management.

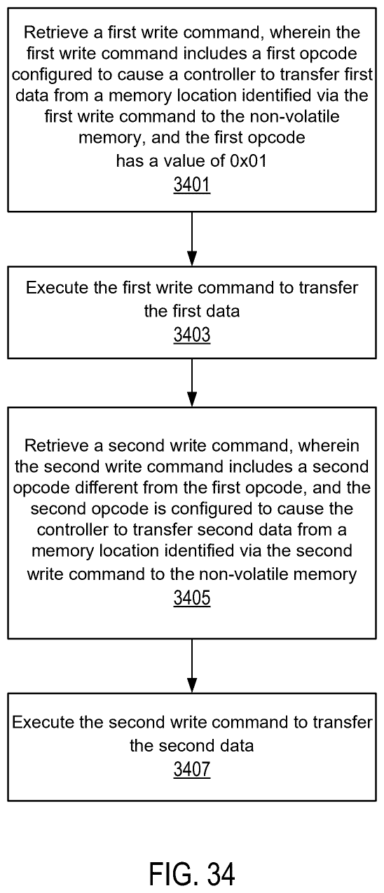

FIG. 34 shows a method for retrieving and executing write commands having different opcodes according to one embodiment. At block 3401, a first write command is retrieved, wherein the first write command includes a first opcode configured to cause the controller to transfer first data from a memory location identified via the first write command to the non-volatile memory, and the first opcode has a value of 0x01.

At block 3403, the first write command is executed to transfer the first data.

At block 3405, a second write command is retrieved, wherein the second write command includes a second opcode different from the first opcode, and the second opcode is configured to cause the controller to transfer second data from a memory location identified via the second write command to the non-volatile memory.

At block 3407, the second write command is executed to transfer the second data.

In one embodiment, the write commands can be generated as described in connection with the process of FIG. 31, and/or the first write command can be executed using firmware processing and the second write command can be executed without using the firmware processing as described in connection with the process of FIG. 32.

In some aspects, the techniques described herein relate to a memory sub-system including: non-volatile memory; and at least one controller configured to: retrieve a first write command, wherein the first write command includes a first opcode configured to cause the controller to transfer first data from a memory location identified via the first write command to the non-volatile memory, and the first opcode has a value of 0x01; execute the first write command to transfer the first data; retrieve a second write command, wherein the second write command includes a second opcode different from the first opcode, and the second opcode is configured to cause the controller to transfer second data from a memory location identified via the second write command to the non-volatile memory; and execute the second write command to transfer the second data.

In some aspects, the techniques described herein relate to a memory sub-system, wherein the first write command includes a first field configured at a predetermined location in the first write command according to the standard for NVMe, a parameter provided in the first field is processed when executing the first write command to write the first data, a field definition pre-specified for the second command does not include the first field being configured at the same predetermined location in the second write command, and a content provided at the same predetermined location in the second write command is ignored when executing the second write command.

In some aspects, the techniques described herein relate to a memory sub-system, wherein the first field is a fused operation field.

In some aspects, the techniques described herein relate to a memory sub-system, wherein the first field is a control parameters field.

In some aspects, the techniques described herein relate to a memory sub-system, wherein the first field is a dataset management field.

In some aspects, the techniques described herein relate to a memory sub-system, wherein the parameter provided in the first field relates to end-to-end protection.

In some aspects, the techniques described herein relate to a memory sub-system, wherein the first data is transferred from the memory location identified via the first write command to a first storage location in a storage space identified via a logical block addressing (LBA) address provided in the first write command.

In some aspects, the techniques described herein relate to a memory sub-system, wherein the storage location is further identified via a namespace identifier provided in the first write command.

In some aspects, the techniques described herein relate to a memory sub-system, wherein the namespace identifier is specified in the first write command in byte segment 7:4.

In some aspects, the techniques described herein relate to a memory sub-system, wherein the namespace identifier is specified in each of the first and second write commands in accordance with an NVMe standard.

In some aspects, the techniques described herein relate to a memory sub-system, wherein each of the first and second write commands has a predetermined length of 512 bits.

In some aspects, the techniques described herein relate to a memory sub-system, wherein the first opcode is according to a standard for non-volatile memory express (NVMe) of August 2024.

In some aspects, the techniques described herein relate to a memory sub-system, including: non-volatile memory; and a controller configured to: retrieve a first command, the command including: a first opcode configured to cause the controller to write data to the non-volatile memory; a logical block addressing (LBA) address identifying a block in a logical storage space partitioned into a plurality of logical blocks of a common size; and a memory address in random access memory; and execute the first command to retrieve the data from the random access memory according to the memory address, allocate a portion of the non-volatile memory to implement the block represented by the logical block addressing (LBA) address, and program the portion of the non-volatile memory to have states representative of the data; wherein the first opcode is different from a second opcode according to a standard for non-volatile memory express (NVMe); wherein when the first opcode in the first command is replaced with the second opcode to generate a second command, the second command includes a plurality of bit segments configured to provide parameters according to the standard for non-volatile memory express (NVMe) to write the data to the logical block address; and wherein the controller is configured to, in response to the first opcode being specified in the first command, skip processing of the plurality of bit segments in execution of the first command.

In some aspects, the techniques described herein relate to a memory sub-system, wherein a value of the second opcode is 0x01.

In some aspects, the techniques described herein relate to a memory sub-system, wherein the parameters according to the standard are control parameters.

In some aspects, the techniques described herein relate to a memory sub-system, wherein the parameters according to the standard relate to end-to-end protection.

In some aspects, the techniques described herein relate to a memory sub-system, including: non-volatile memory; and a controller configured to: retrieve a first command from a submission queue, the command including: a first opcode configured to cause the controller to write data to the non-volatile memory; a logical block addressing (LBA) address identifying a block in a logical storage space partitioned into a plurality of logical blocks of a common size; and a memory address in random access memory; and execute the first command to retrieve the data from the random access memory according to the memory address, allocate a portion of the non-volatile memory to implement the block represented by the logical block addressing (LBA) address, and program the portion of the non-volatile memory to have states representative of the data; wherein the first opcode is different from a second opcode according to a standard for non-volatile memory express (NVMe); wherein when the first opcode in the first command is replaced with the second opcode to generate a second command, the second command includes a plurality of bit segments configured to provide parameters according to the standard for non-volatile memory express (NVMe) to write the data to the logical block address; and wherein the controller is configured to, in response to the first opcode being specified in the first command, skip processing of the plurality of bit segments in execution of the first command.

In some aspects, the techniques described herein relate to a memory sub-system, wherein a namespace identifier is specified in each of the first and second commands in accordance with an NVMe standard.

In some aspects, the techniques described herein relate to a memory sub-system, wherein each of the first and second commands has a predetermined length of 512 bits.

In some aspects, the techniques described herein relate to a memory sub-system, wherein the second opcode is according to a standard for non-volatile memory express (NVMe) of August 2024.

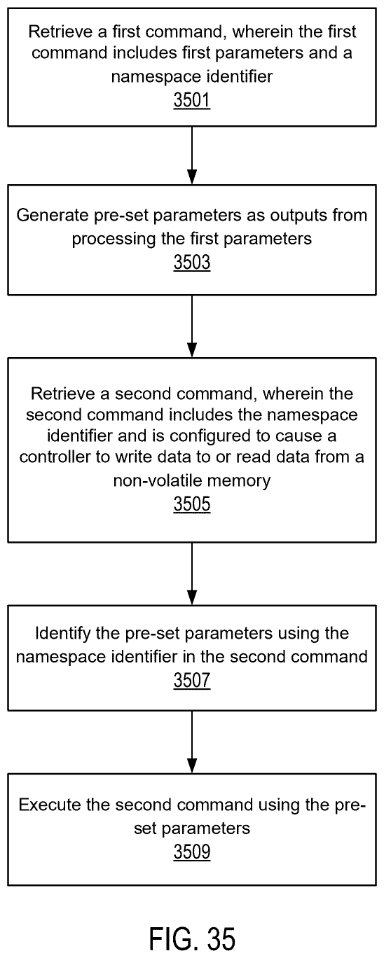

FIG. 35 shows a method for using pre-set parameters to execute a read or write command where the pre-set parameters are identified by a namespace identifier specified in the command according to one embodiment. At block 3501, a first command is retrieved, wherein the first command includes first parameters and a namespace identifier.

At block 3503, pre-set parameters are generated as outputs from processing the first parameters.

At block 3505, a second command is retrieved, wherein the second command includes the namespace identifier and is configured to cause a controller to write data to or read data from a non-volatile memory.

At block 3507, the pre-set parameters are identified using the namespace identifier in the second command.

At block 3509, the second command is executed using the pre-set parameters.

In one embodiment, the access commands described in connection with the processes of FIG. 31 to FIG. 34 can be executed using pre-set parameters identified using a namespace identifier specified in the command.

In some aspects, the techniques described herein relate to a memory sub-system including: non-volatile memory; and at least one controller configured to: retrieve a first command, wherein the first command includes first parameters; execute the first command to generate pre-set parameters based on processing the first parameters; retrieve a second command, wherein the second command is configured to cause the controller to write data to or read data from the non-volatile memory; and execute the second command using the pre-set parameters.

In some aspects, the techniques described herein relate to a memory sub-system, wherein the data is first data, and the first command is configured to cause the controller to write second data to or read second data from the non-volatile memory.

In some aspects, the techniques described herein relate to a memory sub-system, wherein: the first command includes a first opcode configured to cause the controller to write or read the second data; and the second command includes a second opcode different from the first opcode, and the second opcode is configured to cause the controller to write or read the first data.

In some aspects, the techniques described herein relate to a memory sub-system, wherein the first command includes an opcode, or a flag provided in command Dword 2, 3, 12 or 13, configured to cause the controller to store the pre-set parameters.

In some aspects, the techniques described herein relate to a memory sub-system, wherein the first and second commands are retrieved from a submission queue, and the second command follows the first command in the queue.

In some aspects, the techniques described herein relate to a memory sub-system, wherein the first parameters are configured to provide control parameters in a read or write command according to a standard for non-volatile memory express (NVMe) to cause the memory sub-system to write the data to or read the data from the non-volatile memory as in execution of the second command.

In some aspects, the techniques described herein relate to a memory sub-system, wherein the first parameters are configured in a dataset management field.

In some aspects, the techniques described herein relate to a memory sub-system, wherein the first parameters are configured in an end-to-end protection parameters field.

In some aspects, the techniques described herein relate to a memory sub-system, wherein the first command further includes a namespace identifier, and the memory sub-system is configured to store the pre-set parameters as attributes of a namespace identified by the namespace identifier during execution of the first command.

In some aspects, the techniques described herein relate to a memory sub-system, wherein the namespace identifier is specified in the first command in byte segment 7:4.

In some aspects, the techniques described herein relate to a memory sub-system, wherein the second command includes a namespace identifier, and the controller is further configured to store the pre-set parameters in association with the namespace identifier.

In some aspects, the techniques described herein relate to a memory sub-system, wherein the namespace identifier is specified in the second command in accordance with the standard for NVMe.

In some aspects, the techniques described herein relate to a memory sub-system, wherein each of the first and second commands has a predetermined length of 512 bits.

In some aspects, the techniques described herein relate to a memory sub-system, wherein the first command is a read or write command and includes an indication that the pre-set parameters are to be stored for use in executing subsequent read or write commands.

In some aspects, the techniques described herein relate to a memory sub-system, wherein the first parameters are specified at locations in the first command at corresponding locations to specify the first parameters in a read or write command according to a standard for NVMe.

In some aspects, the techniques described herein relate to a memory sub-system, wherein the first parameters specified in the first command includes at least one second parameter configured at a location same as for specifying the second parameter in a read or write command according to a standard for NVMe.

In some aspects, the techniques described herein relate to a memory sub-system including: non-volatile memory; and at least one controller configured to: retrieve a first command, wherein the first command includes first parameters and a namespace identifier; generate pre-set parameters as outputs from processing the first parameters; retrieve a second command, wherein the second command includes the namespace identifier and is configured to cause the controller to write data to or read data from the non-volatile memory; identify the pre-set parameters using the namespace identifier in the second command; and execute the second command using the pre-set parameters.

In some aspects, the techniques described herein relate to a memory sub-system, further including a frontend application specific circuit configured to extract or process the first parameters from the first command for use as inputs to firmware processing used to generate the pre-set parameters.

In some aspects, the techniques described herein relate to a method including: retrieving a setting command from a submission queue, the setting command configured to cause a memory sub-system to store pre-set parameters, wherein the setting command includes first parameters used to generate the pre-set parameters; in response receiving the setting command, storing the pre-set parameters in random access memory; retrieving a first read or write command from the submission queue, wherein the first read or write command follows the setting command in the submission queue, and the first read or write command includes a namespace identifier; selecting the pre-set parameters using the namespace identifier; and executing the first read or write command using the pre-set parameters.

In some aspects, the techniques described herein relate to a method, wherein the first read or write command is configured to cause a controller to write first data or to read first data from a first logical block implemented using non-volatile memory, and the setting command is a second read or write command configured to cause the controller to write second data or to read second data from the first logical block.

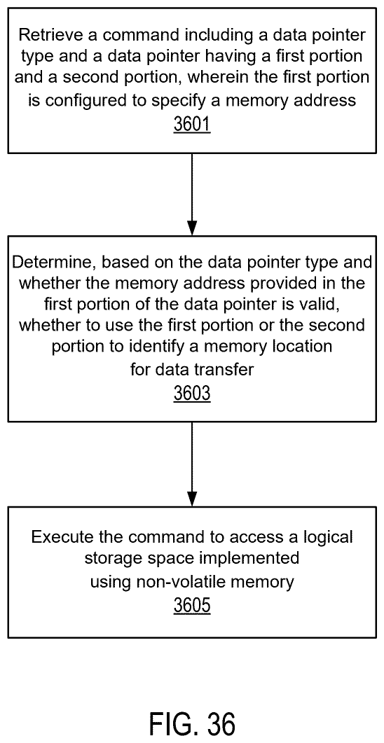

FIG. 36 shows a method for determining a portion of a data pointer to use in identifying a memory location for data transfer according to one embodiment. At block 3601, a command is retrieved that includes a data pointer type and a data pointer having a first portion and a second portion, wherein the first portion is configured to specify a memory address.

At block 3603, a controller determines, based on the data pointer type and whether the memory address provided in the first portion of the data pointer is valid, whether to use the first portion or the second portion to identify a memory location for data transfer.

At block 3605, the command is executed to access a logical storage space implemented using non-volatile memory.

In one embodiment, a controller can determine a portion of a data pointer to use when executing a command as described in connection with the process of FIG. 36 for any of the access commands described in connection with the processes of FIG. 31 to FIG. 35.

In some aspects, the techniques described herein relate to a memory sub-system including: non-volatile memory; and at least one controller configured to: retrieve a command including a data pointer having a first portion and a second portion, wherein the first portion is configured to specify a memory address and the second portion is separate from the first portion; and determine, based on whether the memory address provided in the first portion of the data pointer is valid, whether to use the first portion or the second portion to identify a memory location in a random access memory for data transfer during execution of the command to access a logical storage space implemented using the non-volatile memory.

In some aspects, the techniques described herein relate to a memory sub-system, wherein the controller is further configured to: in response to a determination that the memory address provided in the first portion of the data pointer is valid, executing the command without using the second portion of the data pointer.

In some aspects, the techniques described herein relate to a memory sub-system, wherein the random access memory is memory of a host system.

In some aspects, the techniques described herein relate to a memory sub-system, wherein the memory location is a physical memory address.

In some aspects, the techniques described herein relate to a memory sub-system, wherein the command is a read or write command having a size of 512 bits.

In some aspects, the techniques described herein relate to a memory sub-system, wherein the first portion specifies a memory address of host memory.

In some aspects, the techniques described herein relate to a memory sub-system, wherein the first portion specifies a virtual machine physical address.

In some aspects, the techniques described herein relate to a memory sub-system, wherein the first portion specifies a single memory address.

In some aspects, the techniques described herein relate to a memory sub-system, wherein the first portion is configured in Dwords 6-7 of the command.

In some aspects, the techniques described herein relate to a memory sub-system, wherein the second portion is configured in Dwords 8-9 of the command.

In some aspects, the techniques described herein relate to a method including: retrieving a command including a data pointer type and a data pointer having a first portion and a second portion, wherein the first portion is configured to specify a memory address; determining, based on the data pointer type and whether the memory address provided in the first portion of the data pointer is valid, whether to use the first portion or the second portion to identify a memory location for data transfer; and executing the command to access a logical storage space implemented using non-volatile memory.

In some aspects, the techniques described herein relate to a method, wherein: the memory address is valid; and based on the data pointer type, the second portion of the data pointer is used to identify the memory location.

In some aspects, the techniques described herein relate to a method, wherein the data pointer type is provided in the command in Dword 0.

In some aspects, the techniques described herein relate to a memory sub-system including: non-volatile memory; and at least one controller configured to: retrieve a command including a data pointer; and select, based on a value in the data pointer, a portion of the data pointer to use for identifying a memory location for data transfer.

In some aspects, the techniques described herein relate to a memory sub-system, wherein the memory location is in a random access memory.

In some aspects, the techniques described herein relate to a memory sub-system, wherein the data transfer is performed during execution of the command to access a logical storage space implemented using the non-volatile memory.

In some aspects, the techniques described herein relate to a memory sub-system, wherein the controller is further configured to determine that the value is a predetermined memory address, or a memory address in a predetermined range.

In some aspects, the techniques described herein relate to a memory sub-system, wherein the command further includes an opcode having a value other than a value selected from 0x01 and 0x02.

In some aspects, the techniques described herein relate to a memory sub-system, wherein the data pointer has a size of eight bytes in the command.

In some aspects, the techniques described herein relate to a memory sub-system, wherein the command further includes a data pointer type that indicates a type of the data pointer.

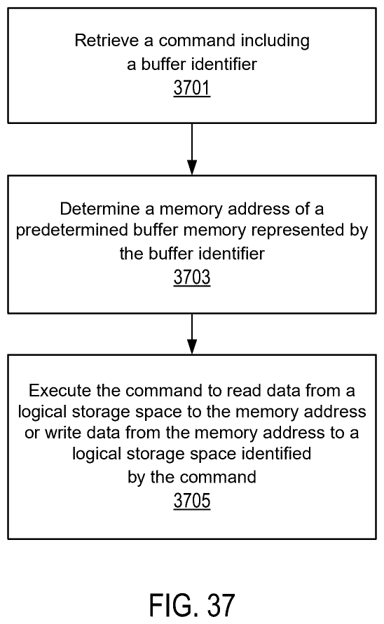

FIG. 37 shows a method for determining a memory address of a buffer memory using a buffer identifier specified in a command according to one embodiment. At block 3701, a command including a buffer identifier is retrieved.

At block 3703, a memory address of a predetermined buffer memory represented by the buffer identifier is determined.

At block 3705, the command is executed to read data from a logical storage space to the memory address or write data from the memory address to a logical storage space identified by the command.

In one embodiment, a buffer identifier as described in connection with the process of FIG. 37 can be used with any of the commands described in connection with the processes of FIG. 31 to FIG. 36.

In some aspects, the techniques described herein relate to a memory sub-system including: non-volatile memory; and at least one controller configured to: retrieve a command including a buffer identifier; and determine, from a lookup table, a memory address associated with the buffer identifier for data transfer during execution of the command to access a logical storage space implemented using the non-volatile memory.

In some aspects, the techniques described herein relate to a memory sub-system, wherein the buffer identifier represents a predetermined buffer memory.

In some aspects, the techniques described herein relate to a memory sub-system, wherein the memory address is one of a plurality of memory addresses stored in the lookup table during a boot up time of the memory sub-system.

In some aspects, the techniques described herein relate to a memory sub-system, wherein the controller is further configured to receive the plurality of memory addresses from a host system, and each address corresponds to a buffer allocated by the host system.

In some aspects, the techniques described herein relate to a memory sub-system, wherein the buffer has a predetermined size.

In some aspects, the techniques described herein relate to a memory sub-system, wherein the buffer memory has a predetermined size.

In some aspects, the techniques described herein relate to a memory sub-system, wherein the controller is further configured to: execute the command to read data from, or write data to, the logical storage space.

In some aspects, the techniques described herein relate to a method including: retrieving a command including a buffer identifier; determining a memory address of a predetermined buffer memory represented by the buffer identifier; and executing the command to read data from a logical storage space to the memory address or write data from the memory address to a logical storage space identified by the command.

In some aspects, the techniques described herein relate to a method, wherein the memory address is pre-associated with the buffer identifier during a boot up time of a computer system in which the method is performed.

In some aspects, the techniques described herein relate to a method, wherein the buffer memory has a predetermined size.

In some aspects, the techniques described herein relate to a method, wherein the determining of the memory address is based on a lookup table configured during a start up time of a memory sub-system in which the method is performed.

In some aspects, the techniques described herein relate to a memory sub-system including: non-volatile memory; and at least one controller configured to: retrieve a command including a buffer identifier; and determine, based on the buffer identifier, a memory location for data transfer.

In some aspects, the techniques described herein relate to a memory sub-system, wherein the buffer identifier is pre-associated with a memory address in a lookup table.

In some aspects, the techniques described herein relate to a memory sub-system, wherein the buffer identifier represents a buffer having a predetermined size.

In some aspects, the techniques described herein relate to a memory sub-system, wherein the controller is further configured to perform a validity check of the memory address prior to storing the memory address in the look up table.

In some aspects, the techniques described herein relate to a memory sub-system, wherein the controller is further configured to perform the data transfer using the memory address.

In some aspects, the techniques described herein relate to a memory sub-system, further including a direct memory access (DMA) engine configured to perform the data transfer.

In some aspects, the techniques described herein relate to a memory sub-system, wherein the command is configured to cause the memory sub-system to read data from a logical storage location implemented using the non-volatile memory to the memory location represented by the memory address.

In some aspects, the techniques described herein relate to a memory sub-system, wherein the command is configured to cause the memory sub-system to write data to a logical storage location implemented using the non-volatile memory by retrieving the data from the memory location represented by the memory address.

In some aspects, the techniques described herein relate to a memory sub-system, wherein the controller is further configured to communicate with a host system to determine the memory address during a boot up time of the host system.

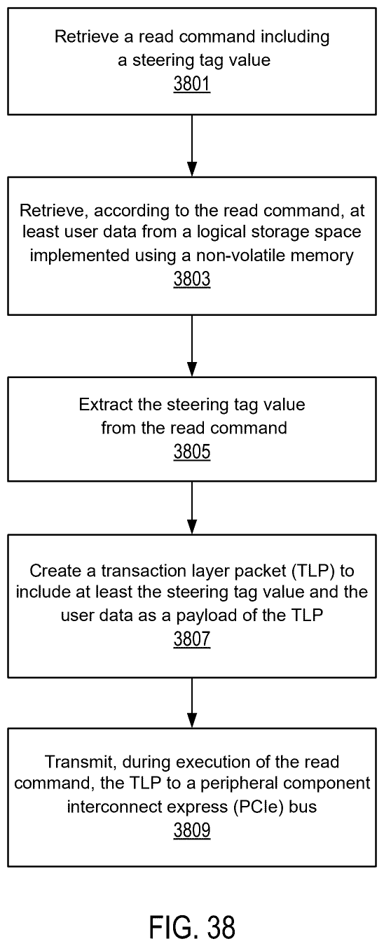

FIG. 38 shows a method for executing a read command that includes a steering tag value according to one embodiment. At block 3801, a read command including a steering tag value is retrieved by a memory sub-system.

At block 3803, the memory sub-system retrieves, according to the read command, at least user data from a logical storage space implemented using non-volatile memory.

At block 3805, the steering tag value is extracted from the read command.

At block 3807, a transaction layer packet (TLP) is created to include at least the steering tag value and the user data as a payload of the TLP.

At block 3809, the memory sub-system transmits, during execution of the read command, the TLP to a peripheral component interconnect express (PCIe) bus.

In one embodiment, a steering tag value as described in connection with the process of FIG. 38 can be used with any of the commands described in connection with the processes of FIG. 31 to FIG. 37.

In some aspects, the techniques described herein relate to a memory sub-system including: non-volatile memory; and at least one controller configured to: retrieve a read command including a steering tag value; retrieve, according to the read command, at least user data from a logical storage space implemented using the non-volatile memory; extract the steering tag value from the read command; create a transaction layer packet (TLP) to include at least the steering tag value and the user data as a payload of the TLP; and transmit, during execution of the read command, the TLP to a peripheral component interconnect express (PCIe) bus.

In some aspects, the techniques described herein relate to a memory sub-system, wherein the read command further identifies a memory address, and the controller is further configured to configure the TLP according to the memory address.

In some aspects, the techniques described herein relate to a memory sub-system, wherein the memory address identifies a location in a host memory, and the steering tag value is configured to identify a cache memory configured to cache data for the location.

In some aspects, the techniques described herein relate to a memory sub-system, wherein the controller is further configured to provide the steering tag value in a predefined field of steering tag in the TLP.

In some aspects, the techniques described herein relate to a memory sub-system, wherein the predefined field of steering tag is in accordance with a standard for peripheral component interconnect express (PCIe).

In some aspects, the techniques described herein relate to a memory sub-system, wherein the controller is configured to retrieve the read command from a submission queue configured in accordance with a standard for non-volatile memory express (NVMe).

In some aspects, the techniques described herein relate to a memory sub-system, wherein the read command identifies a namespace of a storage space implemented using the non-volatile memory.

In some aspects, the techniques described herein relate to a memory sub-system, wherein the namespace is identified in the read command in accordance with a standard for non-volatile memory express (NVMe).

In some aspects, the techniques described herein relate to a host system including: a host memory; and at least one processing device configured with a cache memory configured to cache data for a portion of the host memory; wherein the host system is configured to: determine a steering tag value configured to identify the cache memory over a peripheral component interconnect express (PCIe) bus connecting the host memory, the processing device, and a memory sub-system; and configure a read command, to be executed in the memory sub-system, to include the steering tag value.

In some aspects, the techniques described herein relate to a host system, wherein the host memory includes a portion configured as a submission queue; and the host system is configured to provide the read command to the memory sub-system via the submission queue.

In some aspects, the techniques described herein relate to a host system, wherein the read command is configured to cause the memory sub-system to transmit data retrieved via execution of the read command using at least one transaction layer packet (TLP) each configured with the steering tag value.

In some aspects, the techniques described herein relate to a host system, wherein the memory sub-system is configured to provide the steering tag value in each of the at least one transaction layer packet in a field of steering tag.

In some aspects, the techniques described herein relate to a host system, wherein the steering tag has a size of eight bits.

In some aspects, the techniques described herein relate to a host system, wherein the steering tag value, when provided in a transaction layer packet (TLP) having a memory address in the portion of the host memory, is configured to cause the PCIe bus to deliver a payload of the TLP to the cache memory.

In some aspects, the techniques described herein relate to a host system, wherein the TLP is in accordance with a standard for PCIe.

In some aspects, the techniques described herein relate to a host system, wherein the PCIe bus is further configured to, in response to receiving the transaction layer packet, store the payload of the TLP in the cache memory.

In some aspects, the techniques described herein relate to a host system, wherein the host system is configured to insert the steering tag value into the read command at a predefined location in the read command.

In some aspects, the techniques described herein relate to a method including: implementing a cache coherency protocol on a bus connecting a cache memory and a random access memory in which the cache memory is configured to cache data for the random access memory; configuring a read command to retrieve data from a storage space of a memory sub-system, including providing in the read command a steering tag value configured to represent the cache memory on the bus; receiving, in the bus, a transaction layer packet (TLP) generated from execution of the read command, the TLP including the steering tag value and a memory address in the random access memory; and in response to receiving the TLP, delivering a payload of the TLP to the cache memory and the random access memory.

In some aspects, the techniques described herein relate to a method, wherein the bus is configured according to a standard for peripheral component interconnect express (PCIe).

In some aspects, the techniques described herein relate to a method, wherein the read command is configured to include a namespace specified in the read command according to a standard for non-volatile memory express (NVMe).

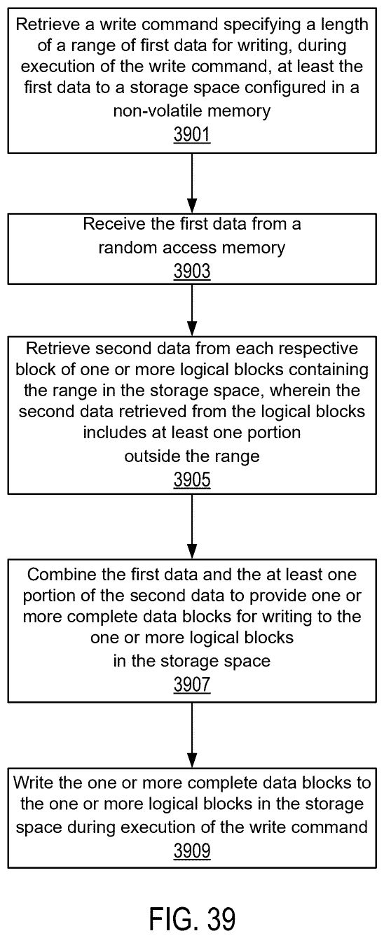

FIG. 39 shows a method for executing a write command that specifies a length of a range of data for writing to a storage space according to one embodiment. At block 3901, a write command is retrieved that specifies a length of a range of first data for writing, during execution of the write command, at least the first data to a storage space configured in a non-volatile memory.

At block 3903, the first data is received from a random access memory;

At block 3905, second data is retrieved from each respective block of one or more logical blocks containing the range in the storage space, wherein the second data retrieved from the logical blocks includes at least one portion outside the range.

At block 3907, the first data and the at least one portion of the second data are combined to provide one or more complete data blocks for writing to the one or more logical blocks in the storage space.

At block 3909, the one or more complete data blocks are written to the one or more logical blocks in the storage space during execution of the write command.

In one embodiment, any of the commands described in connection with the processes of FIG. 31 to FIG. 38 can specify and use a length of range of data as described in connection with the process of FIG. 39.

In some aspects, the techniques described herein relate to a memory sub-system including: non-volatile memory; and at least one controller configured to: retrieve a command specifying a data length via a sub block size and a number of sub blocks for reading one or more sub blocks from, or writing one or more sub blocks to, a storage space configured in the non-volatile memory; and execute the command to read the sub blocks from, or write the sub blocks to, the storage space.

In some aspects, the techniques described herein relate to a memory sub-system, wherein the sub block size specifies a number of bytes.

In some aspects, the techniques described herein relate to a memory sub-system, wherein the storage space is partitioned into a plurality of namespaces, and the command includes a namespace identifier that specifies a first namespace of the plurality of namespaces from which the sub blocks are read, or to which the sub blocks are written.

In some aspects, the techniques described herein relate to a memory sub-system, wherein the first namespace is partitioned into logical blocks of a same size and the first namespace stores data in the logical blocks identified using logical block addressing (LBA) addresses.

In some aspects, the techniques described herein relate to a memory sub-system, wherein the data length extends over multiple logical blocks.

In some aspects, the techniques described herein relate to a memory sub-system, wherein the command includes a logical block address that represents a first logical block in the first namespace from which the sub blocks are read, or to which the sub blocks are written; and the memory sub-system further includes a flash translation layer configured to map the logical block address in the first namespace to a physical address in the non-volatile memory.

In some aspects, the techniques described herein relate to a memory sub-system, wherein the sub block size specifies a value that identifies a size of a unit of data configured as a sub block, and the controller is further configured to compute the size of the unit from the value.

In some aspects, the techniques described herein relate to a memory sub-system, wherein the sub block size specifies a size of each unit of data as a sub block, and the unit of data is a byte, word, double word, or cacheline.

In some aspects, the techniques described herein relate to a memory sub-system including: non-volatile memory; and at least one controller configured to: retrieve a read command specifying a length of a range of first data in bytes for reading, during execution of the read command, the first data from a storage space configured in the non-volatile memory; retrieve second data from each respective block of one or more logical blocks containing the range in the storage space; and extract the first data from the second data during the execution of the read command.

In some aspects, the techniques described herein relate to a memory sub-system, wherein the length is specified in the read command via a sub block size of bytes and a number of sub blocks.

In some aspects, the techniques described herein relate to a memory sub-system, wherein the controller is further configured to send the first data to a location in a random access memory during execution of the read command.

In some aspects, the techniques described herein relate to a memory sub-system, wherein the location in the random access memory is specified in the read command.

In some aspects, the techniques described herein relate to a memory sub-system, wherein the controller is further configured to discard one or more portions of the second data that are outside the range.

In some aspects, the techniques described herein relate to a memory sub-system, wherein retrieving the data includes retrieving data from each respective block of the one or more logical blocks in entirety.

In some aspects, the techniques described herein relate to a memory sub-system, wherein the read command identifies a namespace; and at least an end of the range is not aligned with any logical block boundary in the namespace.

In some aspects, the techniques described herein relate to a memory sub-system including: non-volatile memory; and at least one controller configured to: retrieve a write command specifying a length of a range of first data for writing, during execution of the write command, at least the first data to a storage space configured in the non-volatile memory; receive the first data from a random access memory; retrieve second data from each respective block of one or more logical blocks containing the range in the storage space, wherein the second data retrieved from the logical blocks includes at least one portion outside the range; combine the first data and the at least one portion of the second data to provide one or more complete data blocks for writing to the one or more logical blocks in the storage space; and write the one or more complete data blocks to the one or more logical blocks in the storage space during execution of the write command.

In some aspects, the techniques described herein relate to a memory sub-system, wherein the write command includes a logical block address that specifies a starting block in the one or more logical blocks in the storage space.

In some aspects, the techniques described herein relate to a memory sub-system, wherein the write command specifies a location in the random access memory; and the first data is retrieved from the location specified in the write command.

In some aspects, the techniques described herein relate to a memory sub-system, wherein the length is specified in the write command via a combination of a sub block size in bytes and a number of sub blocks each having the sub block size.

In some aspects, the techniques described herein relate to a memory sub-system, wherein the write command identifies a namespace; and at least an end of the range of data is not aligned with a boundary of any of the one or more logical blocks in the namespace.

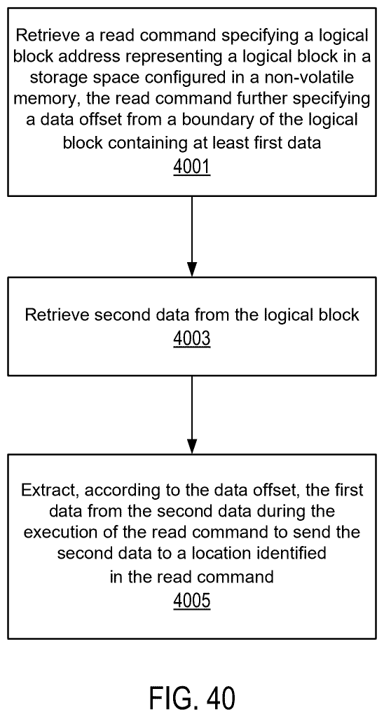

FIG. 40 shows a method for executing a read command that specifies a data offset according to one embodiment. At block 4001, a read command is retrieved that specifies a logical block address representing a logical block in a storage space configured in the non-volatile memory, the read command further specifying a data offset from a boundary of the logical block containing at least first data.

At block 4003, second data is retrieved from the logical block.

At block 4005, the first data is extracted, according to the data offset, from the second data during the execution of the read command to send the second data to a location identified in the read command.

In one embodiment, any of the commands described in connection with the processes of FIG. 31 to FIG. 39 can specify and use a data offset as described in connection with the process of FIG. 39.

In some aspects, the techniques described herein relate to a memory sub-system including: non-volatile memory; and at least one controller configured to: retrieve a command specifying a logical block address representing a logical block in a storage space configured in the non-volatile memory, the command further specifying a data offset from a beginning of the logical block; and execute the command based at least in part on the data offset.

In some aspects, the techniques described herein relate to a memory sub-system, wherein a location offset from the beginning of the logical block according to the data offset is inside the logical block.

In some aspects, the techniques described herein relate to a memory sub-system, wherein the data offset is specified in the command in unit of byte.

In some aspects, the techniques described herein relate to a memory sub-system, wherein the command further specifies a sub block size; and the data offset is specified in the command in unit of the sub block size.

In some aspects, the techniques described herein relate to a memory sub-system, wherein the storage space is partitioned into a plurality of namespaces, the command includes a namespace identifier that specifies a first namespace of the plurality of namespaces, and the logical block address identifies the logical block in the first namespace.

In some aspects, the techniques described herein relate to a memory sub-system, wherein the first namespace is partitioned into logical blocks of a same size and the first namespace stores data in the logical blocks identified using logical block addressing (LBA) addresses.

In some aspects, the techniques described herein relate to a memory sub-system, wherein the command identifies a namespace, and the data offset specifies an offset from a logical block boundary identified by the logical block address defined in the namespace.

In some aspects, the techniques described herein relate to a memory sub-system, wherein the data offset specifies a number of bytes.

In some aspects, the techniques described herein relate to a memory sub-system, wherein the memory sub-system further includes a flash translation layer configured to map the logical block address to a physical address in the non-volatile memory.

In some aspects, the techniques described herein relate to a memory sub-system including: non-volatile memory; and at least one controller configured to: retrieve a read command specifying a logical block address representing a logical block in a storage space configured in the non-volatile memory, the read command further specifying a data offset from a boundary of the logical block containing at least first data; retrieve second data from the logical block; and extract, according to the data offset, the first data from the second data during the execution of the read command to send the second data to a location identified in the read command.

In some aspects, the techniques described herein relate to a memory sub-system, wherein the location is in a random access memory outside of the memory sub-system.

In some aspects, the techniques described herein relate to a memory sub-system, wherein the location in the random access memory is specified in the read command via a memory address.

In some aspects, the techniques described herein relate to a memory sub-system, wherein the controller is further configured to discard a portion of the second data that is before the first data identified via the data offset.

In some aspects, the techniques described herein relate to a memory sub-system, wherein retrieving the second data includes retrieving the second data from the logical block in entirety.

In some aspects, the techniques described herein relate to a memory sub-system, wherein the data offset is inside the logical block.

In some aspects, the techniques described herein relate to a memory sub-system including: non-volatile memory; and at least one controller configured to: retrieve a write command specifying a data offset; receive first data from a location in a random access memory identified by the write command; retrieve second data from a logical block in a storage space configured in the non-volatile memory, the logical block identified by the write command; combine, according to the data offset, the first data and the second data to provide third data; and write the third data to the logical block in the storage space during execution of the write command.

In some aspects, the techniques described herein relate to a memory sub-system, wherein the third data is generated by replacing a portion in the second data following the data offset with the first data.

In some aspects, the techniques described herein relate to a memory sub-system, wherein the write command specifies a sub block size; and the data offset is in unit of the sub block size.

In some aspects, the techniques described herein relate to a memory sub-system, wherein the data offset is specified in the write command in unit of byte.

In some aspects, the techniques described herein relate to a memory sub-system, wherein the write command specifies a namespace identifier representative of a namespace among a plurality of namespaces defined in the memory sub-system; and the write command further specifies a starting logical block address representative of the logical block in the first namespace.

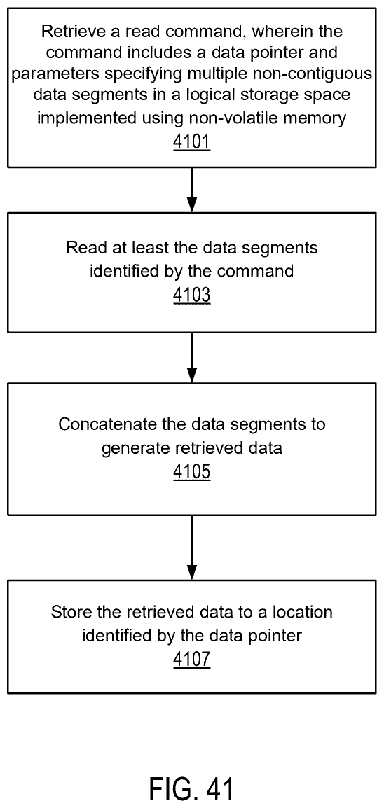

FIG. 41 shows a method for executing a read command that specifies multiple non-contiguous data segments in a logical storage space according to one embodiment. At block 4101, a read command is retrieved, wherein the command includes a data pointer and parameters specifying multiple non-contiguous data segments in a logical storage space implemented using the non-volatile memory.

At block 4103, the command is executed to read at least the data segments identified by the command.

At block 4105, execution of the command concatenates the data segments to generate retrieved data.

At block 4107, execution of the command stores the retrieved data to a location identified by the data pointer.

In one embodiment, any of the commands described in connection with the processes of FIG. 31 to FIG. 40 can specify and use multiple non-contiguous data segments as described in connection with the process of FIG. 41.

In some aspects, the techniques described herein relate to a memory sub-system including: non-volatile memory; and at least one controller configured to: retrieve a command from a slot of a predetermined size in a submission queue configured for the memory sub-system, wherein the command includes parameters specifying multiple non-contiguous data segments in a logical storage space implemented using the non-volatile memory; and execute the command to access at least the data segments identified by the command.

In some aspects, the techniques described herein relate to a memory sub-system, wherein each respective data segment among the multiple data segments is specified in the command via a data offset relative of a logical block address identified in the command and a data length specifying a size of the data segment.

In some aspects, the techniques described herein relate to a memory sub-system, wherein the data offset has a size of four bytes in the command and the data length has a size of four bytes in the command.

In some aspects, the techniques described herein relate to a memory sub-system, wherein the data offset has a size of two bytes in the command and the data length has a size of two bytes in the command.

In some aspects, the techniques described herein relate to a memory sub-system, wherein the data offset and the data length are configured in a same Dword of the command.

In some aspects, the techniques described herein relate to a memory sub-system, wherein the command further includes a data pointer having a size of eight bytes in the command.

In some aspects, the techniques described herein relate to a memory sub-system, wherein the command further includes a data pointer type that indicates a type of the data pointer.

In some aspects, the techniques described herein relate to a memory sub-system, wherein the data pointer type has a size of one bit.

In some aspects, the techniques described herein relate to a memory sub-system, wherein the command has a size of 64 bytes.

In some aspects, the techniques described herein relate to a memory sub-system, wherein the command further includes an opcode having a value other than a value selected from 0x01 and 0x02.

In some aspects, the techniques described herein relate to a memory sub-system, wherein the command further includes an identifier of a predefined buffer.

In some aspects, the techniques described herein relate to a memory sub-system, wherein the command further includes a data pointer, and a type of the data pointer.

In some aspects, the techniques described herein relate to a memory sub-system, wherein the data pointer has a size of sixteen bytes in the command.

In some aspects, the techniques described herein relate to a memory sub-system including: non-volatile memory; and at least one controller configured to: retrieve a read command, wherein the command includes a data pointer and parameters specifying multiple non-contiguous data segments in a logical storage space implemented using the non-volatile memory; and execute the command to read at least the data segments identified by the command, concatenate the data segments to generate retrieved data, and store the retrieved data to a location identified by the data pointer.

In some aspects, the techniques described herein relate to a memory sub-system, wherein each respective data segment among the multiple data segments is specified in the command via a data offset relative of a logical block address identified in the command and a data length specifying a size of the data segment.

In some aspects, the techniques described herein relate to a memory sub-system, wherein the data offset has a size of two bytes in the command and the data length has a size of two bytes in the command.

In some aspects, the techniques described herein relate to a memory sub-system including: non-volatile memory; and at least one controller configured to: retrieve a write command, wherein the command includes a data pointer and parameters specifying multiple non-contiguous data segments in a logical storage space implemented using the non-volatile memory; and execute the command to retrieve first data from a location identified by the data pointer, separate the first data into a plurality of pieces corresponding to the data segments respectively, and write at least the pieces to the data segments in the logical storage space.

In some aspects, the techniques described herein relate to a memory sub-system, wherein the first data is provided at the location identified by the data pointer in a concatenated format for the data segments.

In some aspects, the techniques described herein relate to a memory sub-system, wherein the data segments are specified in the command in reference to a same namespace identifier and a same starting LBA address.

In some aspects, the techniques described herein relate to a memory sub-system, wherein each respective data segment among the multiple data segments is specified in the command via a data offset relative of a logical block address identified in the command and a data length specifying a size of the data segment.

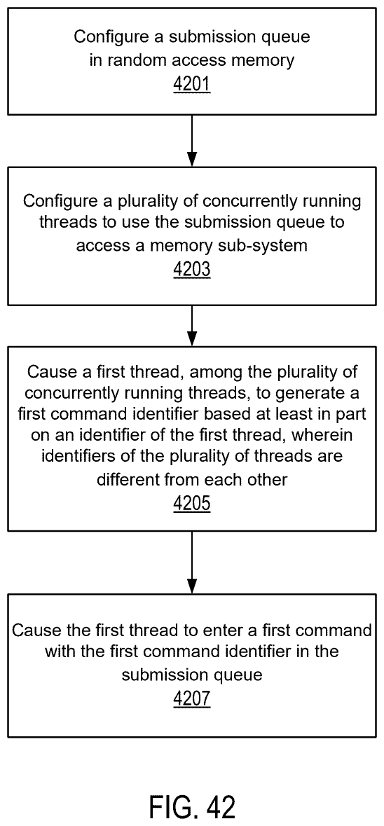

FIG. 42 shows a method for generating a command identifier for a command based on an identifier of a thread according to one embodiment. At block 4201, a submission queue is configured in a random access memory.

At block 4203, a plurality of concurrently running threads is configured to use the submission queue to access a memory sub-system.

At block 4205, a first thread, among the plurality of concurrently running threads, is caused to generate a first command identifier based at least in part on an identifier of the first thread, wherein identifiers of the plurality of threads are different from each other.

At block 4207, the first thread is caused to enter a first command with the first command identifier in the submission queue.

In one embodiment, any of the commands described in connection with the processes of FIG. 31 to FIG. 41 can use command identifiers generated as described in connection with the process of FIG. 42.

In some aspects, the techniques described herein relate to a host system including: random access memory having a submission queue; and at least one processing device configured to: associate a plurality of identifiers respectively with a plurality of threads running concurrently in the host system, the plurality of identifiers being different from each other; configure the plurality of threads to access a memory sub-system using the submission queue; and cause each respective thread in the plurality of threads to identify commands entered in the submission queue by the respective thread using a respective identifier, among the plurality of identifiers, that is associated with the respective thread.

In some aspects, the techniques described herein relate to a host system, wherein the plurality of identifiers are configured to represent a plurality of different resources accessible to the memory sub-system.

In some aspects, the techniques described herein relate to a host system, wherein each respective command among the commands entered in the submission queue by the respective thread is a read or write command having a command identifier generated based at least in part on the respective identifier associated with the respective thread.

In some aspects, the techniques described herein relate to a host system, wherein the respective identifier is based on or corresponds to a memory address of a buffer assigned to the respective thread.

In some aspects, the techniques described herein relate to a host system, wherein the buffer at the memory address is identified in the commands via a data pointer.

In some aspects, the techniques described herein relate to a host system, wherein the memory sub-system is instructed by the commands to use the buffer configured in the random access memory during execution of the commands.

In some aspects, the techniques described herein relate to a host system, wherein the respective identifier is based on or corresponds to a buffer identifier associated with a buffer pre-allocated during a boot time of the host system.

In some aspects, the techniques described herein relate to a host system, wherein the respective identifier is based at least in part on a thread identifier of the respective thread.

In some aspects, the techniques described herein relate to a host system, wherein the respective identifier is based at least in part on a node identifier of a node in which the respective thread is running.

In some aspects, the techniques described herein relate to a host system, wherein the respective identifier includes a memory address assigned to the respective thread; and each respective command among the commands is configured with a command identifier generated from a hash value of the respective identifier.

In some aspects, the techniques described herein relate to a host system, wherein the command further includes a data pointer that points to a location in the random access memory for data transfer when executing the command.

In some aspects, the techniques described herein relate to a host system including: random access memory; and at least one processing device configured to: allocate a buffer from a portion of the random access memory; assign the buffer to a thread; generate, by the thread, a command having a command identifier based on an identifier of the buffer; and enter, by the thread, the command in a submission queue configured in the random access memory.

In some aspects, the techniques described herein relate to a host system, wherein the buffer is allocated during a boot time of the host system.

In some aspects, the techniques described herein relate to a host system, wherein the command identifier has a size of 16 bits and is specified in Dword 0 of the command.

In some aspects, the techniques described herein relate to a host system, wherein the buffer is assigned to the thread exclusively among a plurality of threads running concurrently in the host system and configured to use the submission queue.

In some aspects, the techniques described herein relate to a host system including: random access memory; and at least one processing device configured to: configure a submission queue in the random access memory; configure a plurality of concurrently running threads to use the submission queue to access a memory sub-system; cause a first thread, among the plurality of concurrently running threads, to generate a first command identifier based at least in part on an identifier of the first thread, wherein identifiers of the plurality of threads are different from each other; and cause the first thread to enter a first command with the first command identifier in the submission queue.

In some aspects, the techniques described herein relate to a host system, wherein the identifier of the first thread is configured to identify the first thread as a submitter to the submission queue among a plurality of submitters to the submission queue.

In some aspects, the techniques described herein relate to a host system, wherein the first command identifier includes a first portion generated from the identifier of the first thread, and a second portion having a serial number selected from a predetermined range of serial numbers.

In some aspects, the techniques described herein relate to a host system, wherein the identifier of the first thread is configured to identify a location in the random access memory used during execution of the first command.

In some aspects, the techniques described herein relate to a host system, wherein the first command further specifies a namespace identifier that identifies a namespace in a storage space.

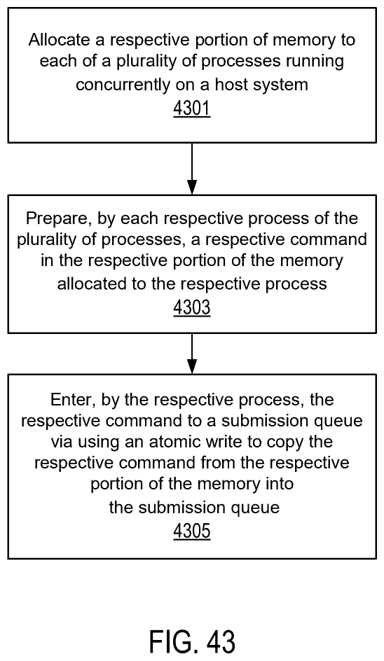

FIG. 43 shows a method for entering commands to a submission queue using an atomic write according to one embodiment. At block 4301, a respective portion of memory is allocated to each of a plurality of processes running concurrently on a host system.

At block 4303, each respective process of the plurality of processes prepares a respective command in the respective portion of the memory allocated to the respective process.

At block 4305, the respective process enters the respective command to a submission queue via using an atomic write to copy the respective command from the respective portion of the memory into the submission queue.

In one embodiment, any of the commands described in connection with the processes of FIG. 31 to FIG. 42 can be entered to a submission queue using an atomic write as described in connection with the process of FIG. 43.

In some aspects, the techniques described herein relate to a system including: a random access memory; and a plurality of processing devices configured to run a plurality of concurrent processes configured to access a logical storage space provided by a memory sub-system using a submission queue; wherein each respective process among the plurality of processes is configured to use a separate portion of the random access memory; wherein the respective process is configured to prepare, independent of the plurality of processes other than the respective process, a first command in the portion of the random access memory configured for the respective process; and wherein the respective process is further configured to use an atomic write, independent of the plurality of processes other than the respective process, to copy the first command from the portion of the random access memory to the submission queue via an atomic write.

In some aspects, the techniques described herein relate to a system, wherein the submission queue is configured in the random access memory.

In some aspects, the techniques described herein relate to a system, wherein the plurality of processes are assigned a plurality of different identifiers; and wherein the respective process is configured to prepare the first command to include a command identifier based on an identifier, among the plurality of different identifiers, assigned to the respective process.

In some aspects, the techniques described herein relate to a system, the identifier assigned to the respective process is configured to identify a resource, among a plurality of resources assigned to the plurality of processes respectively, to be used by the memory sub-system during execution of the first command.

In some aspects, the techniques described herein relate to a system, wherein the resource includes a buffer, among a plurality of buffers assigned to the plurality of processes respectively and configured in the random access memory.

In some aspects, the techniques described herein relate to a system, wherein the first command is configured to cause the memory sub-system to retrieve data from, or store data to, the buffer during execution of the first command.

In some aspects, the techniques described herein relate to a system, wherein the plurality of processing devices includes a plurality of cores of a graphics processing unit (GPU), or a plurality of GPUs.

In some aspects, the techniques described herein relate to a system, wherein the portion of the random access memory is configured for exclusive use by the respective process among the plurality of processes; and the submission queue is shared by the plurality of the processes.

In some aspects, the techniques described herein relate to a system, further including: the memory sub-system; and a peripheral bus coupled between the random access memory and the memory sub-system.

In some aspects, the techniques described herein relate to a system, wherein each of the plurality of processes is a thread configured to run in one of the plurality of processing devices.

In some aspects, the techniques described herein relate to a host system including: random access memory; and at least one processing device configured to run a plurality of threads concurrently to access a memory sub-system using a submission queue configured in the random access memory; wherein each respective thread in the plurality of threads is configured to enter commands in the submission queue using an atomic write to copy a respective command from outside of the submission queue to inside of the submission queue.

In some aspects, the techniques described herein relate to a host system, wherein the plurality of threads are configured to use a plurality of identifiers, the plurality of identifiers being different from each other; and the plurality of processes are configured to generate commands for entering into the submission queue using the plurality of identifiers respectively.

In some aspects, the techniques described herein relate to a host system, wherein the plurality of identifiers are configured to identify a plurality of resources assigned to the plurality of threads respectively.

In some aspects, the techniques described herein relate to a host system, wherein each of the plurality of processes is configured to generate a command having a command identifier that is based on or corresponds to a respective identifier among the plurality of identifiers.

In some aspects, the techniques described herein relate to a host system, wherein the plurality of identifiers are configured during a boot time of the host system, to represent a plurality of buffers configured in the random access memory.

In some aspects, the techniques described herein relate to a host system, wherein first commands entered in the submission queue are configured to retrieve data from a storage space of a memory sub-system into the plurality of buffers.

In some aspects, the techniques described herein relate to a host system, wherein second commands entered in the submission queue are configured to cause a memory sub-system to write data from the plurality of buffers into a storage space of the memory sub-system.

In some aspects, the techniques described herein relate to a method including: allocating a respective portion of memory to each of a plurality of processes running concurrently on a host system; preparing, by each respective process of the plurality of processes, a respective command in the respective portion of the memory allocated to the respective process; and entering, by the respective process, the respective command to a submission queue via using an atomic write to copy the respective command from the respective portion of the memory into the submission queue.

In some aspects, the techniques described herein relate to a method, further including: assigning a respective buffer to each respective process of the plurality of processes; and generating, by the respective process, a command identifier based on an identifier of the respective buffer assigned to the respective process; wherein the respective command entered by the respective process includes the command identifier generated by the respective process.

In some aspects, the techniques described herein relate to a method, wherein the submission queue is configured in the memory.

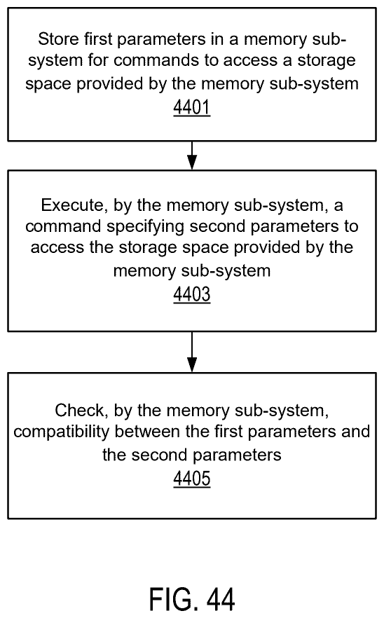

FIG. 44 shows a method for checking compatibility between stored parameters and parameters specified by a command being executed according to one embodiment. At block 4401, first parameters in a memory sub-system are stored for commands to access a storage space provided by the memory sub-system.

At block 4403, the memory sub-system executes a first command specifying second parameters to access the storage space provided by the memory sub-system.

At block 4405, the memory sub-system checks compatibility between the first parameters and the second parameters.

In one embodiment, compatibility can be checked, as described in connection with the process of FIG. 44, between stored parameters (e.g. pre-set parameters 904) and parameters specified by any of the commands described in connection with the processes of FIG. 31 to FIG. 43.

In some aspects, the techniques described herein relate to a memory sub-system including: local memory; non-volatile memory configured to provide a storage space accessible via a storage access protocol; and at least one controller configured to: store, in the local memory, first parameters in association with an identification of the storage space; execute a first command specifying second parameters to access the storage space according to the storage access protocol; and check consistency between the first parameters and the second parameters during execution of the first command.

In some aspects, the techniques described herein relate to a memory sub-system, wherein the first parameters are stored before the command is received in the memory sub-system.

In some aspects, the techniques described herein relate to a memory sub-system, wherein the controller is further configured to store the first parameters during execution of a second command prior to the execution of the first command.

In some aspects, the techniques described herein relate to a memory sub-system, wherein the first parameters include at least one of control parameters, dataset management parameters, or end-to-end protection parameters for commands to access the storage space.

In some aspects, the techniques described herein relate to a memory sub-system, wherein the storage space is a logical storage space identifiable via a namespace identifier provided in the first command; and the identification includes the namespace identifier.

In some aspects, the techniques described herein relate to a memory sub-system, wherein the controller is further configured to, in response to an inconsistency between the first parameters and the second parameters, configure a completion record to report the inconsistency.

In some aspects, the techniques described herein relate to a memory sub-system, wherein the controller is configured to abort the execution of the first command in response to the inconsistency.

In some aspects, the techniques described herein relate to a memory sub-system, further including a configuration register; and wherein the controller is further configured to abort or complete, based on a setting in the configuration register, the execution of the first command in view of the inconsistency.

In some aspects, the techniques described herein relate to a memory sub-system, wherein the controller is configured to, in accordance with the setting in the configuration register, complete execution of the first command using the second parameters when the inconsistency is detected.

In some aspects, the techniques described herein relate to a memory sub-system, wherein the controller is configured to, in accordance with the setting in the configuration register, complete execution of the first command using the first parameters when the inconsistency is detected.

In some aspects, the techniques described herein relate to a memory sub-system including: a configuration register; and at least one controller configured to: store first parameters in association with a namespace identifier for commands to access a namespace represented by the namespace identifier; retrieve a first command providing the namespace identifier and second parameters to access the namespace represented by the namespace identifier; and manage an inconsistency between the first parameters and the second parameters according to a setting provided in the configuration register.

In some aspects, the techniques described herein relate to a memory sub-system, wherein the setting is configurable to cause the controller to use the first parameters to execute the first command when the inconsistency is detected.

In some aspects, the techniques described herein relate to a memory sub-system, wherein the setting is configurable to cause the controller to use the second parameters to execute the first command when the inconsistency is detected.

In some aspects, the techniques described herein relate to a memory sub-system, wherein the setting is configurable to cause the controller to update the first parameters according to the second parameters when the inconsistency is detected.

In some aspects, the techniques described herein relate to a method including: storing first parameters in a memory sub-system for commands to access a storage space provided by the memory sub-system; executing, by the memory sub-system, a first command specifying second parameters to access the storage space provided by the memory sub-system; and checking, by the memory sub-system, compatibility between the first parameters and the second parameters.

In some aspects, the techniques described herein relate to a method, further including: aborting, in response to incompatibility being detected between the first parameters and the second parameters, execution of the first command to report an error in a completion record provided for the first command.

In some aspects, the techniques described herein relate to a method, further including: replacing, in response to incompatibility being detected between the first parameters and the second parameters, the second parameters with the first parameters to complete execution of the first command.

In some aspects, the techniques described herein relate to a method, further including: continuing, in response to incompatibility being detected between the first parameters and the second parameters, execution of the first command using the first parameters to generate a completion record for the first command; and configuring the completion record to indicate the incompatibility.

In some aspects, the techniques described herein relate to a method, further including: updating, in response to incompatibility being detected between the first parameters and the second parameters, the first parameters stored for the storage space using the second parameters provided in the first command.

In some aspects, the techniques described herein relate to a method, further including generating a completion record to report the updating of the first parameters.

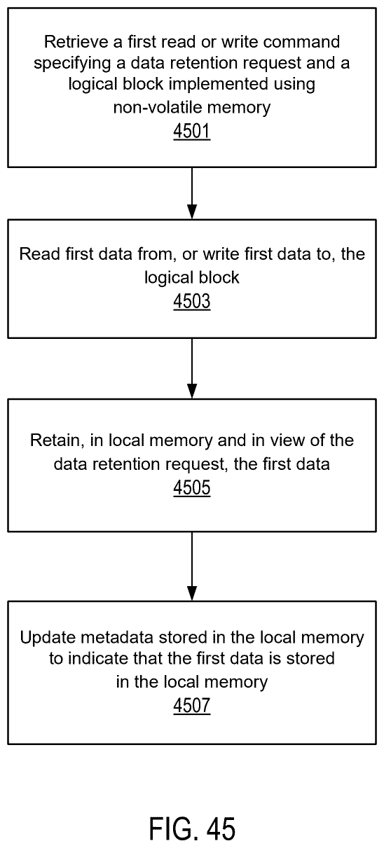

FIG. 45 shows a method for retaining, in local memory, data read from or written to a logical block and updating metadata to indicate that the data is stored in the local memory according to one embodiment. At block 4501, a first read or write command is retrieved that specifies a data retention request and a logical block implemented using the non-volatile memory.

At block 4503, first data is read from, or written to, the logical block.

At block 4505, the first data is retained in the local memory in view of the data retention request.

At block 4507, metadata stored in the local memory is updated to indicate that the first data is stored in the local memory.

In one embodiment, any of the commands described in connection with the processes of FIG. 31 to FIG. 44 can specify a data retention request as described in connection with the process of FIG. 45.

In some aspects, the techniques described herein relate to a memory sub-system including: local memory; non-volatile memory; and at least one controller configured to: retrieve a first command specifying a logical block implemented using the non-volatile memory and specifying in a predefined field in the first command a first value; prepare, in the local memory and during execution of the first command to access the logical block for read or write, first data stored at the logical block after the execution of the first command; and store, based on the first value being specified in the predefined field in the first command, metadata identifying a location of the local memory storing, after the execution of the first command, the first data for the logical block.

In some aspects, the techniques described herein relate to a memory sub-system, wherein the at least one controller is further configured to: retrieve a second command specifying the logical block; determine, during execution of the second command and based on the metadata, that the first data stored at the logical block is available in the local memory; and execute the second command using the first data retained in the local memory at the location identified by the metadata.

In some aspects, the techniques described herein relate to a memory sub-system, wherein the first command is a read command configured to cause the memory sub-system to send a first sub block of the first data to a destination specified in the read command.

In some aspects, the techniques described herein relate to a memory sub-system, wherein the second command is a read command configured to cause the memory sub-system to send a second sub block of the first data to a destination specified in the second command.

In some aspects, the techniques described herein relate to a memory sub-system, wherein the second command is a write command configured to cause the memory sub-system to write a second sub block to the logical block; and the at least one controller is further configured to, during execution of the second command: retrieve the second sub block; overwrite a portion of the first data at the location in the local memory with the second sub block to generate second data; and write the second data to the logical block.

In some aspects, the techniques described herein relate to a memory sub-system, wherein the first command is a write command configured to cause the memory sub-system to write a first sub block to the logical block; and the at least one controller is further configured to, during execution of the first command: retrieve the first sub block; determine second data stored in the logical block; and overwrite, in the local memory, a portion of the second data with the first sub block to generate the first data.

In some aspects, the techniques described herein relate to a memory sub-system, wherein the at least one controller is further configured to, during execution of the first command, write the first data to the logical block.

In some aspects, the techniques described herein relate to a memory sub-system, wherein the first and second commands are retrieved from a submission queue of a host system, and the first sub block is retrieved from random access memory of the host system.

In some aspects, the techniques described herein relate to a memory sub-system, wherein the first command is further configured to cause the at least one controller to postpone, after completing execution of the first command, writing the first data to the logical block.

In some aspects, the techniques described herein relate to a memory sub-system, wherein the second command is configured to cause the at least one controller to write the first data to the logical block during execution of the second command.

In some aspects, the techniques described herein relate to a memory sub-system, wherein the at least one controller is configured, when a second value is specified in the predefined field, to delete the first data from the local memory after execution of the first command without storing the metadata.

In some aspects, the techniques described herein relate to a memory sub-system, wherein the first value is configured to indicate a priority, or a duration, or any combination thereof for retaining the first data in the local memory after the execution of the first command.

In some aspects, the techniques described herein relate to a memory sub-system including: local memory; non-volatile memory; and at least one controller configured to: retrieve a first read or write command specifying a data retention request and a logical block implemented using the non-volatile memory; read first data from, or write first data to, the logical block; retain, in the local memory and in view of the data retention request, the first data; and update metadata stored in the local memory to indicate that the first data is stored in the local memory.

In some aspects, the techniques described herein relate to a memory sub-system, wherein the controller is further configured to: retrieve a second read or write command specifying the logical block; and execute the second command using the first data retained in the local memory in view of the data retention request specified in the first command.

In some aspects, the techniques described herein relate to a memory sub-system, wherein the controller is further configured to retain the first data in the local memory after execution of the first command for a period of time specified by the first command.

In some aspects, the techniques described herein relate to a memory sub-system, wherein the controller is further configured to retain the first data in the local memory until executing a second read or write command specifying the logical block.

In some aspects, the techniques described herein relate to a memory sub-system, wherein the controller is further configured to retain the first data in the local memory based on a predefined value specified in a predefined field in the first command.

In some aspects, the techniques described herein relate to a memory sub-system, wherein the controller is further configured to retrieve a second command and release retention of the first data in the local memory in response to the second command being configured to access the logical block without a data retention request.

In some aspects, the techniques described herein relate to a method including: executing a first command to access a logical block in a storage space of a memory sub-system, the first command configured with a data retention request; and during execution of the first command: storing first data in local memory of the memory sub-system; and storing, responsive to the data retention request, metadata associating an address of the logical block with a location in the local memory storing the first data.

In some aspects, the techniques described herein relate to a method, further including: retrieving a second command specifying the logical block; and executing, based on the stored metadata, the second command using the first data stored in the local memory.

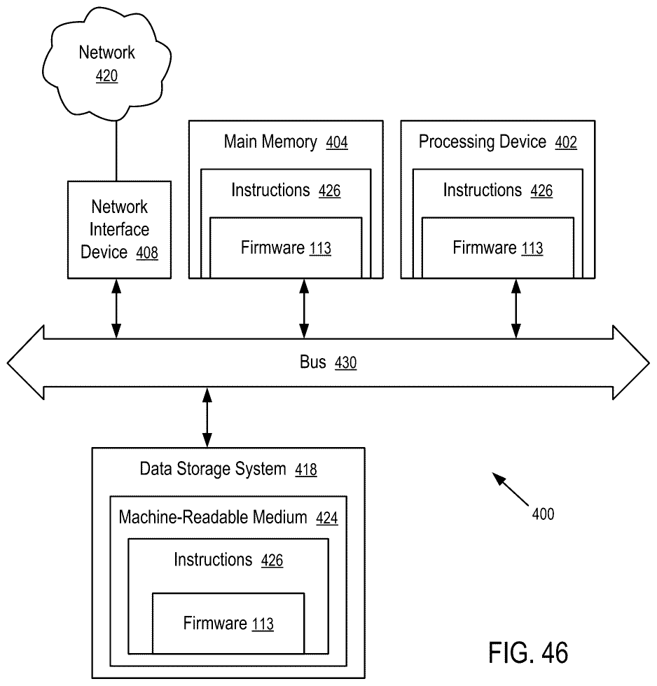

FIG. 46 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of firmware 113 (e.g., to execute instructions to perform operations corresponding to the firmware 113 described with reference to FIGS. 1-45). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

In one example, instructions 426 are executed to configure processing of normal and/or fast commands. In one example, instructions 426 are executed to configure firmware-based resources 290 and/or hardware circuitry 292 based on an opcode in a command.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the firmware 113 described with reference to FIGS. 1-45. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory sub-system comprising:
non-volatile memory; and
at least one controller configured to:
retrieve a command including a data pointer having a first portion and a second portion, wherein the first portion is configured to specify a memory address and the second portion is separate from the first portion; and
determine, based on whether the memory address provided in the first portion of the data pointer is valid, whether to use the first portion or the second portion to identify a memory location in a random access memory for data transfer during execution of the command to access a logical storage space implemented using the non-volatile memory.

2. The memory sub-system of claim 1, wherein the controller is further configured to:
in response to a determination that the memory address provided in the first portion of the data pointer is valid, executing the command without using the second portion of the data pointer.

3. The memory sub-system of claim 1, wherein the random access memory is memory of a host system.

4. The memory sub-system of claim 1, wherein the memory location is a physical memory address.

5. The memory sub-system of claim 1, wherein the command is a read or write command having a size of 512 bits.

6. The memory sub-system of claim 1, wherein the first portion specifies a memory address of host memory.

7. The memory sub-system of claim 1, wherein the first portion specifies a virtual machine physical address.

8. The memory sub-system of claim 1, wherein the first portion specifies a single memory address.

9. The memory sub-system of claim 1, wherein the first portion is configured in Dwords 6-7 of the command.

10. The memory sub-system of claim 1, wherein the second portion is configured in Dwords 8-9 of the command.

11. A method comprising:
retrieving a command including a data pointer type and a data pointer having a first portion and a second portion, wherein the first portion is configured to specify a memory address;
determining, based on the data pointer type and whether the memory address provided in the first portion of the data pointer is valid, whether to use the first portion or the second portion to identify a memory location for data transfer; and
executing the command to access a logical storage space implemented using non-volatile memory.

12. The method of claim 11, wherein:
the memory address is valid; and
based on the data pointer type, the second portion of the data pointer is used to identify the memory location.

13. The method of claim 11, wherein the data pointer type is provided in the command in Dword 0.

14. A memory sub-system comprising:
non-volatile memory; and
at least one controller configured to:
retrieve a command including a data pointer; and
select, based on a value in the data pointer, a portion of the data pointer to use for identifying a memory location for data transfer.

15. The memory sub-system of claim 14, wherein the memory location is in a random access memory.

16. The memory sub-system of claim 14, wherein the data transfer is performed during execution of the command to access a logical storage space implemented using the non-volatile memory.

17. The memory sub-system of claim 14, wherein the controller is further configured to determine that the value is a predetermined memory address, or a memory address in a predetermined range.

18. The memory sub-system of claim 14, wherein the command further includes an opcode having a value other than a value selected from 0x01 and 0x02.

19. The memory sub-system of claim 14, wherein the data pointer has a size of eight bytes in the command.

20. The memory sub-system of claim 14, wherein the command further includes a data pointer type that indicates a type of the data pointer.
